(19) United States
(12) Patent Application Publication
(10) Pub. No.: US 2007/0262863 A1
(43) Pub. Date: Nov. 15, 2007

(54) Sensor network system and sensor network position specifying method

(76) Inventors: Toshiyuki Aritsuka, Tokyo (JP); Norio Ohkubo, Tokyo (JP)

Correspondence Address: REED SMITH LLP, Suite 1400, 3110 Fairview Park Drive, Falls Church, VA, 22042, US

(21) Appl. No.: 11/797,574

(22) Filed: May 4, 2007

(30) Foreign Application Priority Data
May 8, 2006 (JP) 2006-128849

(51) Int. Cl. G08B 1/08; H04L 12/28; H04B 7/00; G08B 21/00

(52) U.S. Cl. 340/539.22; 340/539.26; 370/310; 370/254; 340/870.16

(57) ABSTRACT

A sensor network system with its ability to specify the position of a terminal is disclosed. This system includes a locator node operative to catch a communication of a sensor node. Using this locator node, a present position of the sensor node is specified, thereby permitting services to be done based on the sensor node's position and ID information. A node position specifying method for use in the network system is also disclosed.

### CROSS-REFERENCE TO RELATED APPLICATION

The present invention is related to U.S. patent application No. 11/______ (Hitachi Docket No. 310600322US01) entitled “SENSOR-NET SYSTEMS AND ITS APPLICATION SYSTEMS FOR LOCATIONING” claiming the Convention Priority based on Japanese Patent Application No. 2006-128846 filed on May 8, 2006.

### INCORPORATION BY REFERENCE

The present application claims priority from Japanese application JP2006-128849 filed on May 8, 2006, the content of which is hereby incorporated by reference into this application.

### FIELD OF THE INVENTION

The present invention relates generally to moving body position specifying technologies and, more particularly, to sensor network systems capable of continuously tracking changes in conditions and circumstances, such as states and positions of target objects, e.g., persons or things.

### BACKGROUND OF THE INVENTION

### Description of the Related Art

Traditionally, a moving-object management method has been proposed and reduced to practice in various fields, such as security management for actions of persons in buildings or urban districts or like areas, article management in the process of commercial distribution at warehouses and retail stores or shops, healthcare/safety management of persons at medical treatment facilities and homes, and monitoring of conditions of pets or farm animals. In this method, tags are attached to movable objects, such as persons, things, animals, etc. The tags have means for wirelessly transmitting individual-distinguishable ID codes, thereby enabling management of the moving bodies by externally reading tag information thereof.

One important management information in addition to ID-based discrimination of the individual object in the process of managing the moving objects is the position of a moving object. By combining together the ID and position of such moving object and a measurement time point thereof, useful information is obtainable, including but not limited to a present location of specific moving object, a traveling route, relationship between more than two moving objects, and relationship with an observation field. In the above-noted fields, it is possible from these information items to comprehend some situations, such as for example the invasion of institutional workers into restricted areas, tracing of commercial distribution channels, and ascertainment of present locations of patients.

Currently known moving-object position specifying methodology includes a method for using a wireless access terminal that functions as an ID-sendable tag, such as a mobile cellular phone or else, and a base station communicable with the wireless terminal. For example, this is a method for disposing several radio-communication base stations with their communication ranges which do not overlap each other and for regarding, at a time point that the radio terminal communicates with its nearest base station, a present position of the radio terminal as the position of such base station. JP-A-8-129061 discloses therein a method for providing a means for measuring a time taken for a signal of wireless terminal to reach a base station, for permitting at least more than three base stations to simultaneously receive electrical wave of the signal from the radio terminal, and for estimating the distance between the terminal and each base station based on measurement results of a radiowave arrival time difference to thereby specify the position based on the principle of trilateral survey, also called the trilateration. JP-A-11-178042 discloses therein a method of specifying the position based on the trilateration principle by estimating the distance between a wireless terminal and each base station from a difference in radiowave intensity between received signals from the terminal, in place of the time difference.

In human societies, there are needs for a service of managing positions of target persons and a service of providing circumstance-sensitive information to a person whose position is specified. To do this, in customer-care services at shops for example, it is required to grasp the positions of visitors and shop stuffs and then issue appropriate instructions to the stuffs. Additionally in the field of attractions, a need is felt to recognize the position of a player who freely moves and roll out a game in a way pursuant to his or her actions.

In such the facility environment, when specifying the position of a radio terminal by the trilateration principle in the way as taught by the Japanese Patent Bulletin (JP-A-8-129061 or JP-A-11-178042), it is sometime difficult to closely lay out the base stations in such a way as to enable simultaneous communications of one terminal with more than two base stations. In addition, in order to perform the estimation of a present terminal position with increased accuracy, it is needed to accurately determine in advance the positions of respective base stations.

In the trilateration-based distance estimation method using time differences as disclosed in JP-A-8-129061, it is required to accurately compare a time taken by a base station to communicate with the radio terminal in order to obtain the highest possible measurement accuracy. This in turn requires employment of a means for strictly performing time synchronization between base stations. Regarding the trilateration-based distance estimation method using radio wave intensity as disclosed in JP-A-11-178042, it is required to accurately measure the radiowave intensity in order to obtain the highest possible measurement accuracy. Unfortunately, in the above-stated facility environments, the radiowave intensity can be affected by the presence of wave-absorbing or reflecting bodies, such as partition walls, floors, layout of installed things, existing persons and things or else. The radiowave intensity is also affectable by other static and/or dynamic environmental factors, such as humidity and influence of other electric waves, so that measurement errors will possibly become larger in cases where communications are performed in a relatively long distance. Additionally the above-noted prior art techniques are such that the terminal is usually required to transmit over the air electrical signals for position measurement.

### SUMMARY OF THE INVENTION

A brief summary of a representative one of the principal concepts of the invention as disclosed herein is as follows.

A sensor network system includes a node having a display unit, a sensor for acquiring sensing data, a first controller for generating first transmission data including the sensing data and node identification (ID) information, and a first wireless processing unit for sending the first transmission data to a base station. The network system also includes a locator node having a second wireless processing unit for catching the transmission data of from the node to the base station when the node exists in a detection region of the locator node and a second controller for extracting the node ID information from the transmission data and for generating second transmission data including the extracted node ID information and locator node ID information. The base station has a node communication processing unit for receiving the first and second transmission data from the node and the locator node and for extracting the first node ID information, second node ID information and the locator node ID information and a node management unit for sending the extracted ID information to a server. The server has an event action control unit for receiving the ID information, a recorder unit for recording a locator node position table which causes the locator node ID information and the locator node position to correspond in relationship to each other, a database control unit for using the received ID information and the locator node position table to specify a position of the node, and a command control unit for sending information to be determined by the event action control unit based on the position of the node toward the position-specified node via the base station. The position-specified node has its display unit operative to display the information determined by the event action control unit.

In the sensor network system, it is no longer necessary to estimate the exact distance between a base station and sensor node, which in turn makes it unnecessary to perform strict position determination of the base station. In addition, it becomes unnecessary to perform accurate time synchronization between base stations, thus avoiding the need to densely dispose the base stations. Further, it becomes unnecessary to execute complicated calculations for reducing the influence of radiowave intensity variations. It is also unnecessary for the sensor node to send a signal for position measurement, thereby making it possible to reduce power consumption of the sensor node. Furthermore, by providing services using information incidental to the sensor node's position and ID, it becomes possible to achieve increased efficiency of hospitality business works, improvement of customer/visitor-care services, and providing attractions with high degrees of entertainment.

### BRIEF DESCRIPTION OF THE DRAWINGS

FIG. 1 is a diagram showing an exemplary configuration of a sensor network system which specifies the position of a sensor node by using a locator node.

FIG. 2 is a block diagram showing one example of function of the sensor network system.

FIG. 3 is a block diagram showing one example of a wireless sensor node WSN.

FIG. 4 is a graph showing an exemplary operation state of the radio sensor node for indication of a relationship of time versus consumed current.

FIGS. 5A to 5C are diagrams each of which is for explanation of one example of a mobile sensor node detection method by means of a locator node LCN.

FIG. 6 is a diagram for explanation of one example of the concept for specifying a present position of a moving object using the locator node LCN.

FIG. 7 is a block diagram showing one example of the locator node LCN.

FIG. 8 is a block diagram showing another example of the locator node LCN.

FIG. 9 is a block diagram showing a further example of the locator node LCN.

FIG. 10 is a block diagram showing another further example of the locator node LCN.

FIG. 11 is a diagram for explanation of one example of a state change of a locator node.

FIG. 12 is a diagram for explanation of another example of a state change of the locator node.

FIG. 13 is a diagram for explanation of another example of a state change of the locator node.

FIG. 14 is a diagram for explanation of a further example of a state change of the locator node.

FIG. 15 shows an exemplary layout of locator nodes within an observation field.

FIG. 16 shows an exemplary layout of locator nodes within the observation field.

FIG. 17 shows another exemplary layout of locator nodes in the observation field.

FIG. 18 shows a further exemplary layout of locator nodes in the observation field.

FIG. 19 shows an example in the case of controlling the directivity of a locator node.

FIG. 20 is a diagram for explanation of an example of data flow.

FIG. 21 is a diagram for explanation of one example of the processing flow of a locator node.

FIG. 22 is a diagram for explanation of one example of the processing flow of a base station.

FIG. 23 is an explanation diagram showing one exemplary layout of wireless sensor nodes.

FIG. 24 is a block diagram showing one example relating to measurement data of an object and a sensor node.

FIG. 25 is an explanation diagram showing one example of a sensor information table.

FIG. 26 is a block diagram showing one example of an event action control unit of a distributed data processing server DDS.

FIG. 27 is a diagram for explanation of one example of an event table.

FIG. 28 is a block diagram showing one example of an action control unit ACC of a directory server DRS.

FIG. 29 is a diagram for explanation of one example of an action table.

FIG. 30 is an explanation diagram showing one example of entry of an event table of the distributed data processing server DDS.

FIG. 31 is an explanation diagram showing one example of entry of an action table of the directory server DRS.

FIG. 32 is a time chart showing one example of a setup flow of a single action.

FIG. 33 is a time chart showing one example of a response flow of a single action.

FIG. 34 is a diagram for explanation of one example of a setup method of a detection region of locator node.

FIG. 35 is a diagram for explanation of one example of a setup method of a detection region of locator node.

FIG. 36 is a diagram for explanation of one example of a setup method of a detection region of locator node.

FIG. 37 is a diagram for explanation of one example of a selection method in case more than two locator nodes detect a sensor node.

FIG. 38 is a diagram for explanation of one example of a selection method in case more than two locator nodes detected a sensor node.

FIG. 39 is a diagram showing a configuration example of a locator node having a sensor.

FIG. 40 is a diagram for explanation of one example of a sensor network application system of the type using terminal position information.

FIG. 41 is a diagram for explanation of one example of a sensor network application system employed for supporting the concierge services of visitors or customers in a store.

FIG. 42 shows an example of a display screen of a sensor network application system.

FIG. 43 shows another example of the display screen of the sensor network application system.

FIG. 44 shows still another example of display screen of the sensor network application system.

FIG. 45 shows yet another example of display screen of the sensor network application system.

FIG. 46 shows a further example of display screen of the sensor network application system.

FIG. 47 shows another further example of display screen of the sensor network application system.

FIG. 48 is a diagram for explanation of one example of a sensor network application system employable in attraction facility.

FIG. 49 is a diagram showing an exemplary configuration of a sensor net application system using terminal position information.

FIG. 50 is a diagram for explanation of one example of an operation flow of a switch node SWN.

FIG. 51 a diagram for explanation of a configuration example of the switch node SWN.

FIG. 52 is a diagram for explanation of one example of an operation flow of a mobile sensor node MSN.

FIG. 53 is a diagram for explanation of a configuration example of the mobile sensor node MSN.

FIG. 54 a diagram for explanation of one example of an operation flow of a locator node.

FIG. 55 is a diagram for explanation of one example of an operation flow of a sensor net system SNS in a store-use sensor net application system.

FIG. 56 is a diagram for explanation of a configuration example of an application system APS of a sensor network application system adaptable for use in attraction facility.

FIG. 57 is a diagram for explanation of another configuration example of the mobile sensor node MSN.

FIGS. 58A to 58C are diagrams each of which is for explanation of one example of the processing flow of sensor net system SNS in the attraction facility-use sensor net application system.

FIGS. 59A through 59E are diagrams each for explanation of one example of the processing flow of application system APS in the attraction facility-use sensor net application system.

FIG. 60 is a diagram for explanation of an example of a real world model list that retains states or conditions of shop stuffs.

FIG. 61 is a diagram for explanation of examples of shop visitor/customer information and proposed contents.

### DETAILED DESCRIPTION OF THE INVENTION

A principal feature of the present invention lies in that the position of a node is specifiable by use of a locator node to thereby avoid the need for complicated processing, such as strict position determination of a base station(s).

Preferred forms of this invention will be described with reference to the accompanying drawings below.

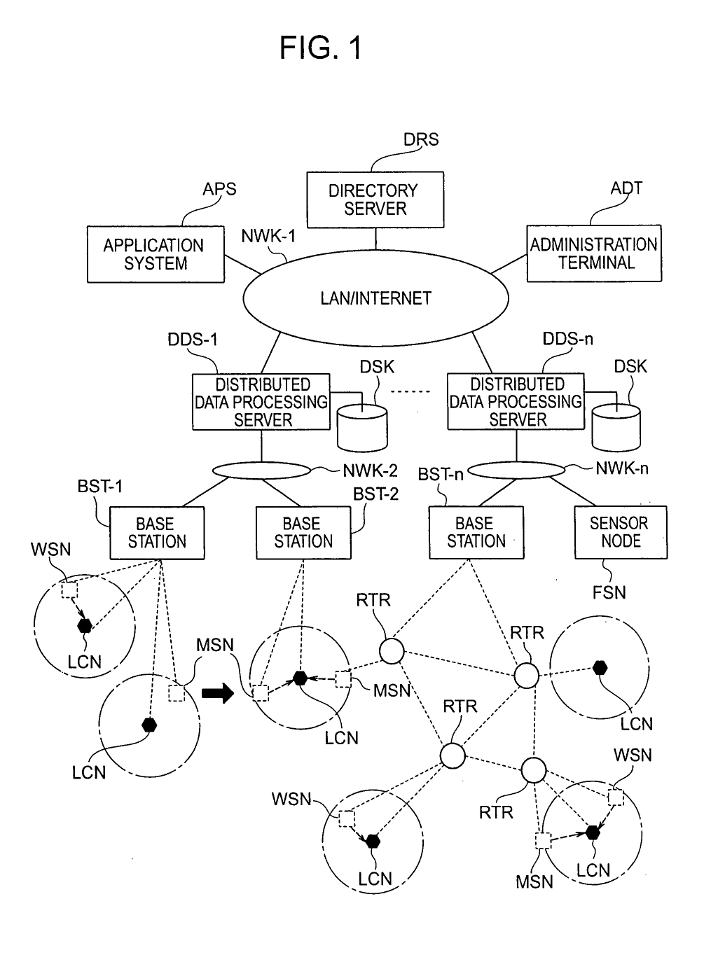

FIG. 1 is a diagram showing an overall configuration of a sensor network system embodying the invention, which is for specifying a present position of a sensor node by using a position-specifying locator node which catches or “intercepts” a communication from the sensor node. Although in the description specific components such as base stations BST, distributed data processing servers DDS and a directory server DRS are disclosed as one embodiment, it is also permissible that these functional units are integrated together in a single data processing server, which is used to execute the processing tasks required.

<Overview of Sensor Network System Configuration>

Several types of sensor nodes, or sensor networks, are installed at predetermined positions or attached to prespecified things or persons, for collecting information concerning environments or information about the things or persons and for transmitting over the air the information to base stations BST-1 to BST-n. The sensor nodes include wireless sensor nodes WSN, wireless mobile sensor nodes MSN, and a wired sensor node FSN that is linkable by a wire cable to a network NWK-n as shown in FIG. 1.

A wireless sensor node WSN that is fixedly installed is typically arranged to have a built-in sensor, which operates to periodically sense its surrounding circumstances and send sensing information to a preset base station BST directly or alternatively via a router RTR operative to interexchange or “repeat” radio signals. A wireless mobile sensor node MSN is designed in the form of a handheld or mobile instrument which is installed in a movable body and thus is changeable in position—i.e., hand-carriable by a person or built in a land vehicle. This node operates to send information directly to its nearest base station BST or alternatively via its nearest router RTR, which is connected to the base station BST and functions as a repeater.

Locator nodes LCN are installed at prespecified positions, each of which detects a sensor node that exists therearound and sends the information of such detected node to base stations BST-1 to BST-n directly or via more than one router RTR for use as a wireless repeater. Each locator node LCN functions to catch a communication that is sent by a sensor node to a base station BST or router RTR. In case a sensor node appears within a specific distance from the locator node LCN, it detects this sensor node for sending detection information to base station BST.

The router RTR may be provided solely between a sensor node WSN or MSN and its associated base station. Alternatively, more than two routers RTR may be connected together by a single path to thereby constitute a multi-hop type repeater network. Still alternatively, more than two routers RTR may be connected into a mesh form to thereby make up a mesh type repeater network.

Note here that in the description, an entirety of the radio sensor nodes is designated by “WSN” or “MSN” whereas the individual one of them is indicated by use of a suffix, such as WSN-1, WSN-2, WSN-3, . . . , WSN-n or MSN-1, . . . , MSN-n. The same goes with the other constituent elements.

Each base station BST-1, . . . , BST-n is operatively associated with one or a plurality of wireless sensor nodes WSN, MSN and a locator node LCN, which are connected thereto. Each base station BST-1, . . . , BST-n is linked via a network NWK-2, . . . , NWK-n to a distributed data processing server DDS-1, . . . , DDS-n which collects data from each sensor node. The network NWK-2, . . . , NWK-n connects together its associated one of the base stations BST and a corresponding one of the distributed data processing servers (distributed servers) DDS. The distributed data processing servers DDS are changeable in connection number in a way depending upon the significance of a system scale. Additionally, the sensor nodes WSN or MSN and locator nodes LCN are designed to communicate with base stations BST directly in some cases and communicate via repeater networks made up of routers RTR in other cases. A sensor network system embodying this invention is arranged to have a function of controlling the repeater networks. Regarding this repeater network control function, any one of known functions used in currently available wireless repeater networks are employable, so its detailed description is eliminated herein.

Each distributed data processing server DDS-1, . . . , DDS-n is generally made up of a wireless or wired sensor node (hereinafter, simply referred to as “sensor node” in cases where the means for connection to distributed data processing servers DDS is not specifically limited) and a disk device DSK for storing the data detected by locator node LCN along with a central processing unit (CPU) and a memory, which are not depicted, for executing a prespecified software program to collect measurement data from a sensor node(s) in a way as will be described later and for performing several kinds of operations or “actions” in accordance with predefined conditions, such as data storage, data processing, notifying and data transmission to a directory server (management server) DRS or other servers via a network NWK-1. The network NWK-1 may illustratively be a local area network (LAN) or the Internet.

Note here that the data collected from a sensor node is typically a combination of a specific identification (ID) code unique to the sensor node and numerical data sensed thereby whereas the data collected from the locator node LCN is mainly a bundle of a specific ID unique to the locator node LCN and a specific ID for identification of a sensor node detected by the locator node LCN. Although each data exhibits a change in deference to timeline, it still fails to be in a form that is readily utilizable by an application system APS. To overcome this, the directory server DRS is designed to convert, based on preset definitions, output data of the sensor node into a real world model (such as a person, thing, state, etc.) which is easily usable by the application system APS for providing it to the application system APS.

Target objects for data collection of the distributed data processing server DDS-1, . . . , DDS-n are a sensor node belonging to the base station BST of a network NWK-2, . . . , NWK-n to which the server per se is connected, locator node LCN, and a wireless mobile sensor node MSN that was moved from another base station BST. The wired sensor node FSN may be designed so that it is connected to distributed data processing server DDS-1, . . . , DDS-n. The wired sensor node FSN may alternatively be linked to the base station BST for enabling this base station BST to manage the wired sensor node FSN in a similar way to wireless sensor nodes.

Connected to the network NWK-1 are a distributed data processing server DDS which manages real world models correlated with the sensing information as sent from distributed data processing servers DDS, the directory server DRS, distributed data processor servers DDS, base stations BST, an administrator terminal ADT which performs sensor node setup and management, and the application system APS which makes use of the information of this directory server DRS. Regarding the administrator terminal, two separate terminals may be prepared, one of which is for a sensor administrator in charge of sensor node management and the other of which is for a service administrator in charge of management of sensor network services.

The directory server DRS has a CPU, memory and storage device, which are not depicted, for executing a preinstalled software program(s) to thereby manage objects as correlated with significant or meaningful information in a way to be later described. More specifically, when the application system APS requests access to a real world model via an application interface, the directory server DRS provides access to the distributed data processing server DDS-1, . . . , DDS-n that owns measurement data corresponding to the real world model, for acquiring corresponding measurement data, and converting sensing data thereof into a format readily utilizable by the application system APS, if necessary, and then passing it to the application system APS.

Although in this example the sensor network system is configured by using the base stations BST which connect the sensor nodes and locator nodes LCN to perform communications, the distributed data processing servers DDS that collect via BST the information of such sensor nodes and locator nodes LCN and the directory server DRS for management of real world models correlated with the sensing information of distributed data processing servers DDS, the base stations BST and distributed data processing servers DDS plus directory server DRS may be arranged in the same hardware as stated previously. Additionally in an example which performs communications between a node and base station by means of over-the-air radio signal transmission at relatively short distances, it is needed to lay out the base station within a distance that is communicable from the node. In this case, if only the base station functions are separated, a single base station becomes simpler in configuration, thereby enabling downsizing and cost reduction thereof. This makes it possible to dispose an increased number of ones at various locations in an observation field. Thus it becomes possible to permit the entirety of such field to become a communication capable area at relatively low costs. On the other hand, when employing an arrangement that causes the distributed data processing servers to be situated one-by-one in observation fields, for example, for performing node management and data collection of the entire field while letting the directory server provide sum-up control of a plurality of observation fields, advantages are obtainable as to achievement of processing distribution and facilitation of general management of the sensor network system.

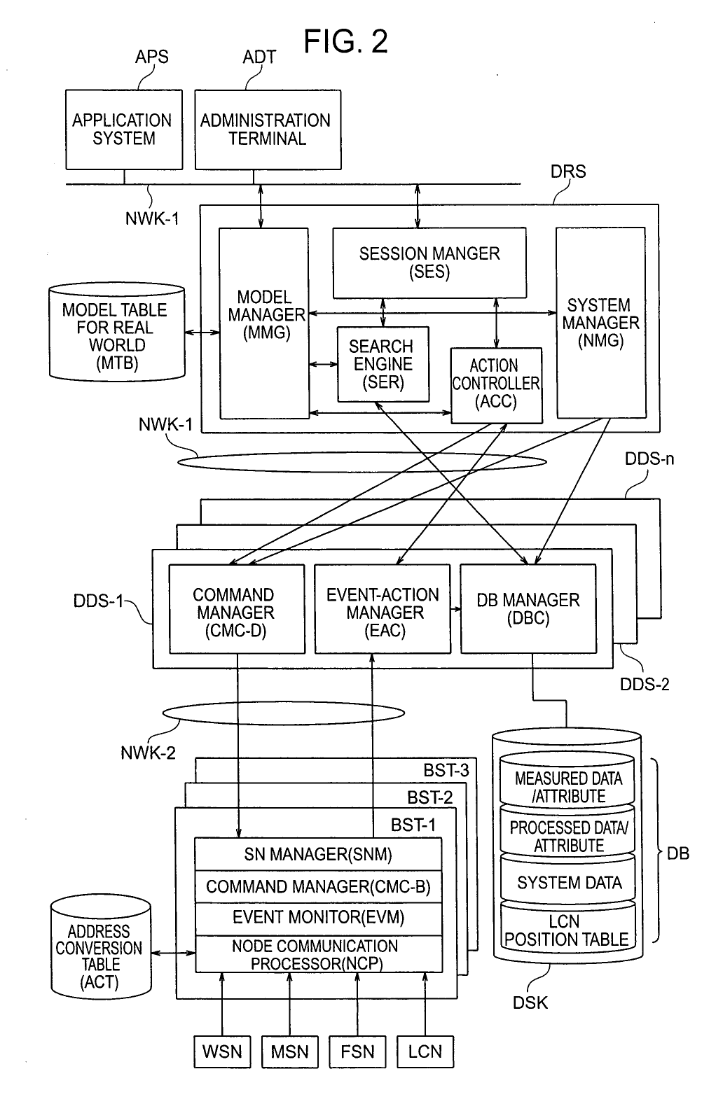

FIG. 2 is a functional block diagram of the sensor network system shown in FIG. 1. For purposes of convenience in illustration and discussion herein, a detailed configuration of only one distributed data processing server DDS-1 among the distributed data processing servers DDS of FIG. 1 is depicted, and only one base station BST-1 of the base stations BST is shown, which is connected to the distributed data processing server DDS-1. The remaining distributed data processing servers DDS and the other base stations BST are arranged similarly. Respective parts or components will be explained below.

<Base Station BST>

The base station BST performs management of preset wireless sensor nodes WSN, MSN, wired sensor nodes FSN and locator nodes LCN which are linkable thereto, for transmitting to the distributed data processing server DDS the measurement data of each sensor node and locator node LCN and/or state data of the base station per se.

A node communication processing unit NCP receives a communication from a sensor node or locator node and uses an address conversion table ACT to convert address information contained in the received contents into an address format for use in an upper-level host system which includes a distributed data processing server DDS. In addition, this unit NCP extracts various kinds of data contained in the received contents, such as a sensing result and the state of a sensor node itself, e.g., a residual battery capacity, communication retry number, etc.

In the illustrative embodiment, a local address and a personal area network (PAN) ID are used as the address information for specifying a node during communication between the node and its associated base station. The PAN ID is an ID which is assigned per wireless network that is made up of a base station BST, a wireless sensor node WSN connected to the base station BST, and a locator node LCN. In other words, in order to identify that each constituent element belongs to which one of the networks involved, the same PAN ID is added to the node, locator node and base station which belong to a single PAN. The sensor node and locator node have local addresses that are preassigned to have their unique values among PANs to which respective nodes belong. Accordingly, by combination of PAN ID and local addresses, the ID of a node is uniquely determined in the sensor network system SNS. A global address to be later described is an ID which is added to each node in the sensor network system or is preassigned to each node in the network system.

Note here that in the description, S_PID which is PAN ID of a sensor node and its local address S_LAD are defined as sensor node ID information whereas L_PID and local address L_LAD of a locator node are defined as locator node ID information.

Meanwhile, in order to avoid confusion with nodes belonging to another sensor network system or another similar system, it is necessary for the sensor node and locator node to perform unique identification within a region with a risk of confusion with the nodes belonging to another system. Additionally, in cases where node information of another system is processed in a consolidated way in the distributed data processing servers DDS and directory server DRS and application system APS, a need is felt to uniquely identify every node. To this end, the global address for individual identification is assigned to each node.

Usually, the number of nodes belonging to each PAN becomes less than the number of nodes belonging to the sensor network system SNS to which the node group belongs and the entirety of another system. Thus it is possible to lessen the data size required to represent the local address when compared to the data size needed to represent the global address. This makes it possible to lessen the address data size of a node to be added during local communication between a node and a base station, which are in the same PAN, thereby enabling reduction of an entire communication data amount. In particular, in the case of over-the-air radiocommunication with a limited frequency band, lessening the communication data mount results in a communication time being shortened. This communication time cut-down becomes advantageous both in a viewpoint of saving of the exclusive occupation time of a transmission path and in a viewpoint of sensor-node power consumption reduction.

As previously stated, the node communication processing unit NCP shown in FIG. 2 performs conversion of a local address into global address by using the address conversion table ACT. It should be noted that although in FIG. 2 a specific example is shown in the case that the address format of a node used during node-base station communication is different from the address format to be used in a host system including its distributed data processing server DDS, these formats may be arranged to be the same as each other without having to pose practical problems in cases where there are no constraints in the communication data amount. In such cases, the address conversion table ACT becomes unnecessary.

An event monitoring unit EVM monitors, as an event(s), the global address that is ID information of the sensor node or locator node acquired from the node communication processing unit NCP and the sensing result plus node state information. In addition, the event monitor EVM notifies a sensor node management unit SNM of a result of processing to be executed based on preset judgment conditions, such as data conversion and abnormality judgment or else, in accordance with the contents, e.g., the sensing result and node state or else.

A command control unit CMC-B performs transmission and reception of a command(s) between it and a command control unit CMC-D of distributed data processing server DDS-1 to be described later. For instance, the command controller CMC-B is responsive to receipt of a command from the distributed data processing server DDS-1, for executing setup of parameters of the base station BST-1, executing setup of state parameters of base station BST-1, and sending the states of sensor node and locator node LCN to the distributed data processing server DDS-1.

The sensor node management unit SNM performs data communications with an event action control unit EAC of the distributed data processing server DDS-1. More specifically, the sensor node manager SNM receives from the event monitor EVM the sensing result of sensor node and locator node LCN which are managed by the sensor node manager SNM and a result of the processing of node state information and then sends to the distributed data processing server DDS via the network NWK-2 in accordance with predefined transmission conditions.

The sensor node manager SNM retains the management information (such as operating state, residual power, etc.) of the sensor node and locator node LCN, which information is managed by itself. Upon issuance of any inquiry as to the sensor node and/or locator node LCN from the distributed data processing server DDS-1, it notifies the management information while operating in place of each sensor node and locator node LCN. In other words, the distributed data processing server DDS-1 that is in charge of a great number of sensor nodes and locator nodes LCN is able to reduce its own workload by entrusting the management of sensor nodes and locator nodes LCN to the base station BST.

When the event monitor EVM detects abnormality, the sensor node manager SNM updates the management information of sensor node and locator node LCN and notifies the distributed data processing server DDS-1 of a sensor node or a locator node LCN that is abnormal in operation. The abnormality of the sensor node or locator node LCN refers to the state that the functional operation of the sensor node or locator node LCN is accidentally interrupted or is in the process of interruption due to the loss of a response from the sensor node or locator node LCN, irregular drop-down of electrical power of the sensor node or locator node LCN to an extent below a preset threshold value thereof, and appreciable deviation of the sensing value from the allowable range of a predefined proper value.

Upon receipt of a command (output timing setup) for the sensor node or locator node LCN from the command control unit CMC-D, the sensor node manager SNM sends forth this command to the sensor node or locator node LCN, performs setting, and updates the management information of the sensor node or locator node LCN after having received a notice indicative of setup completion from the sensor node or locator node LCN. Additionally the output timing of the sensor node or locator node LCN indicates a cycle or period at the time the wireless sensor node WSN periodically sends data to the base station BST-1.

<Distributed Data Processing Server DDS>

The distributed data processing server DDS-1 includes a disk device DSK which stores a database DB, and command control unit CMC-D for performing communication with the base station(s) BST and directory server DRS in a way to be later described to thereby perform transmission and reception of commands or the like.

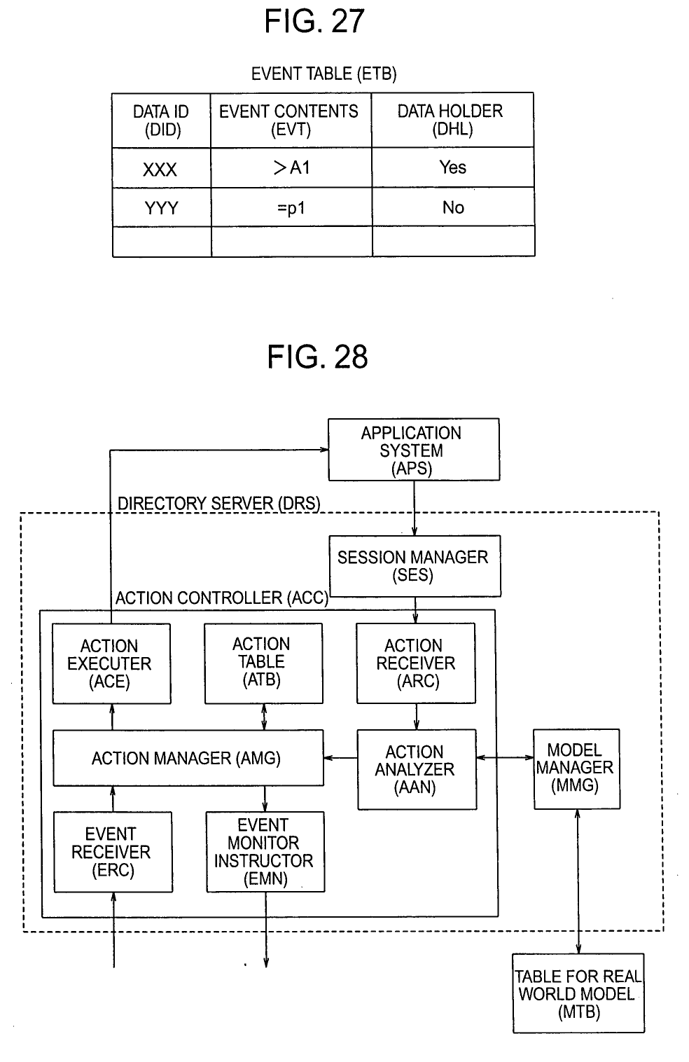

The event action control unit EAC receives data from a sensor node management unit of the base station. More specifically, whenever receiving measurement data from a sensor node or locator node LCN, the event action controller EAC acquires ID of such sensor node or locator node LCN to be contained in the measurement data, and reads from a table to be later described (i.e., event table ETB of FIG. 27) an event generation rule corresponding to ID of the sensor node or locator node LCN, and then determines whether the occurrence of an event pursuant to the value of measurement data is present or absent. This controller EAC also executes an action corresponding to the occurrence of the event matching the sensor node ID.

The contents of such action execution include, but not limited to, conversion of the measurement data into processed data which is performed by application developers or system designers based on preset rules, storing the measurement data and processed data in the database DB under the control of a database control unit DBC, and notifying the directory server DRS.

In this embodiment, as shown in FIG. 1, for the plurality of base stations BST, more than two distributed data processing servers DDS which put together some of them in a certain area (or site) are laid out to enable achievement of distributed processing of the information from a great number of sensor nodes and locator nodes LCN. For example, in offices, distributed data processing servers DDS are provided on a per-floor basis; in industrial plants or factories, the distributed data processing servers DDS are provided in units of buildings.

The disk device DSK of distributed data processing server DDS-1 stores as the database DB the measurement data of sensor nodes WSN, MSN, FSN and locator nodes LCN which are received from the base stations BST, processed data of these measurement data, device data concerning the base stations BST, wireless sensor nodes WSN, MSN, wired sensor node FSN and locator nodes LCN, and a locator node position table with pre-correlation of the ID information of locator nodes LCN and the installation position information of locator nodes LCN.

The database control unit DBC of distributed data processing server DDS-1 stores in the database DB the measurement data being outputs of a sensor node(s) and locator node(s) LCN as have been sent from the event action controller EAC. It also operates, when the need arises, to apply numerical processing to the measurement data and store in the database DB the processed data obtained by integration with other data. Additionally the device data may be updated opportunistically in response to receipt of a request from the administrator terminal ADT.

Further, for sensor node ID information detected by a locator node LCN, the database controller DBC uses the locator node position table to extract an installation position from ID information of this locator node and correlates it as the sensor node position and then makes correspondence in relationship between the sensor node position and sensing data for transmission to the directory server DRS. Additionally, in case the same sensor-node ID information is sent from more than two locator nodes in a synchronized way, e.g., when a sensor node exists within an overlapping region of the sensor node detection areas of more than two locator nodes LCN, it executes the processing in the case of more than two locator nodes having detected a sensor node to be later described—this processing is preset as one of those actions for coping with the event occurrence as previously stated in conjunction with the above-noted event action controller EAC—to thereby perform sensor-node position correlation.

<Directory Server DRS>

The directory server DRS that manages a plurality of distributed data processing servers DDS includes a session control unit SES operative to control communications from the administrator terminal ADT and/or application system APS as linked via the network NKW-1.

A model management unit MMG manages, by a real world model list MDL as set in a real world model table MTB, the corresponding relationship between real world models (objects) readily utilizable by the application system APS and the sensor node position information determined based on the measurement data collected by the distributed data processing servers DDS from sensor nodes or the processed data or the sensor node detection information gathered from locator nodes.

The directory server DRS also manages the position information (links of uniform resource locators (URLs) or the like) of residual locations of either the measurement data equivalent to real world models or the processed data thereof. In brief, designating a real world model(s) makes it possible for application system developers to give direct access to over-time variable measurement information of sensor nodes and locator nodes LCN. While the track record or “history” of the measurement data from sensor nodes and locator nodes and processed data plus position information data increases with time, the real world model information stays almost unchanged even after the elapse of a time, with only its contents being variable. This real world model will be described in detail later.

The real world model table MTB is stored in a storage device (not depicted) of the directory server DRS.

An action control unit ACC of the directory server DRS performs communication with the event action controller EAC and command controller CMC-D of distributed data processing server DDS and accepts an event action setup request from the application system APS or the administrator terminal ADT. Then, it analyzes the contents of such accepted event or action by referring to the information of real world model table MTB and then sets up function allocation between the directory server DRS and the distributed data processing server DDS-1, . . . , DDS-n in a way pursuant to the result of analysis. Note that in some cases, a single action or event is related not only to one distributed data processing server DDS but also to more than two of the distributed data processing servers DDS-1 to DDS-n.

A search engine SER is responsive to receipt of a search request relative to an object received by the session control unit SES, for referring to the information of real world model table MTB to conduct a search with respect to the database DB of distributed data processing server DDS.

If the search request is a query, it executes processing for correspondence of the database DB in accordance with the contents of such query and structured query language (SQL) conversion of the query, and then conducts the search required. The database DB that becomes a search object extends to cover more than two distributed data processing servers DDS in some cases. Acquisition of the last updated data (stream) is achievable by action setup of the action controller ACC. As an example, an action for transferring corresponding data to the application system APS in any events is set up in the event action controller EAC of a corresponding one of the distributed data processing servers DDS.

Next, a device management unit NMG is the one that totally manages the distributed data processing servers DDS connected to the network NWK-1 for constituting a sensor network, the base stations BST connected to the distributed data processing servers DDS, and sensor nodes WSN, MSN and locator nodes LCN linked to base stations BST. The device manager NMG provides to the administrator terminal ADT those interfaces concerning registration and searching of distributed data processing servers DDS, base stations BST, sensor nodes and locator nodes LCN, thereby to manage the state of each device and the state of each sensor node or locator node LCN.

The device manager NMG is capable of issuing commands for the distributed data processing server(s) DDS, base station(s) BST, sensor nodes and locator nodes LCN, which commands are used to manage the resources of sensor network. Additionally, the sensor nodes and locator nodes LCN are arranged so that each receives a command from the device manager NMG via the command control unit CMC-B of a base station BST that becomes an upper-level “host” computer thereof whereas the base station BST receives a command from the device manager NMG via the command control unit CMC-D of upper-level distributed data processing server DDS.

Examples of the command to be issued by the device manager NMG via the command controller CMC-D include reset, parameter setup, data erase, data transfer, and fixed-form event/action setup.

<Example of Sensor Node>

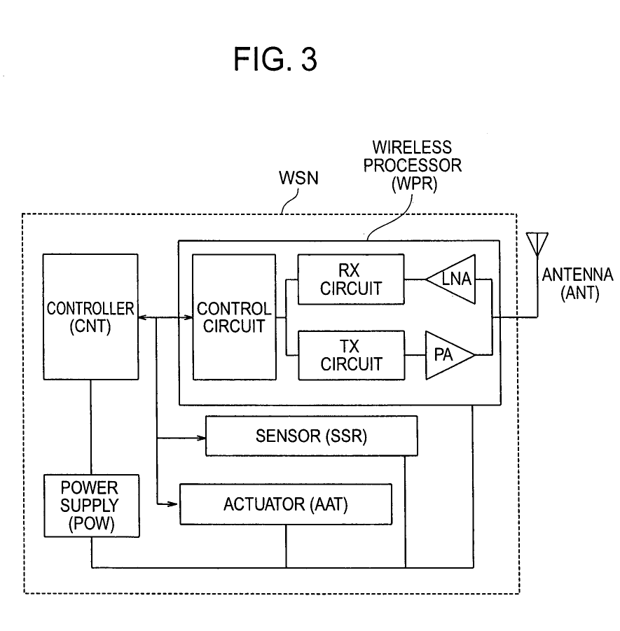

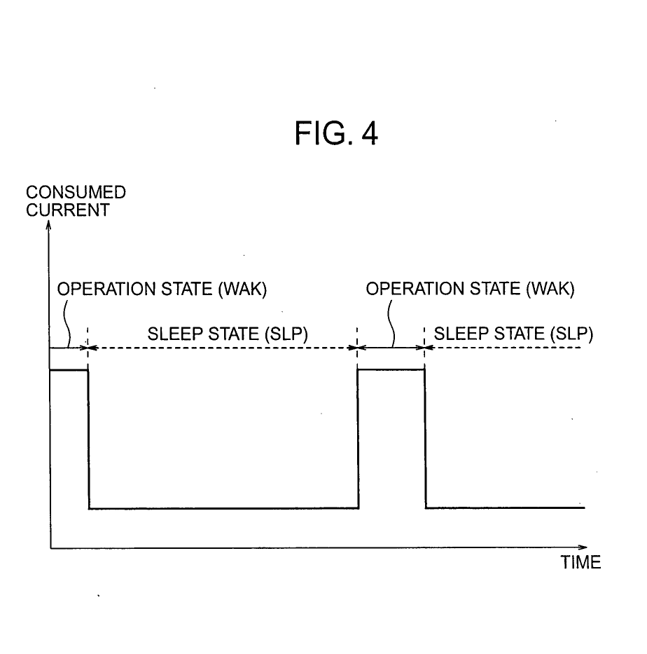

An example of the sensor node is shown in FIGS. 3 and 4.

FIG. 3 is a block diagram showing one example of the wireless sensor node WSN.

A sensor SSR measures either a state quantity (temperature, humidity, illuminance, position, etc.) of an object to be measured or a change in state quantity.

An actuator AAT is constituted from a light-emitting diode (LED), a speaker module, a vibration motor, an output device such as liquid crystal display (LCD) monitor, and a driver for driving these components.

A wireless processing unit WPR is made up of a receiver circuit for receiving via an antenna ANT a radio-communication such as a command or response as sent from a base station BST after having amplified it by a low-noise amplifier (LNA), a transmitter circuit for sending via the antenna ANT a signal generated by a sensor node WSN toward the base station BST after having amplified the signal by a power amplifier (PA), and a control circuit for controlling the receiver circuit and the transmitter circuit based on a control signal from a controller CNT.

The controller CNT reads the measurement data of sensor SSR periodically at preset time intervals or opportunistically at irregular intervals and then transfers this measurement data after having added thereto a preset sensor node ID. In some cases, information indicative of a time point at which the sensing was executed is given to the measurement data as a time stamp. The controller CNT also controls the actuator AAT based on a command received via the wireless processor WPR and a sensing result plus a predesignated processing procedure, thereby driving the output device. Further, it controls electrical power supply POW to thereby control the power feed state of each component making up the sensor node. Although not specifically shown in FIG. 3, the controller CNT is arranged to include a storage device, such as a memory, for storing therein various kinds of data along with control programs.

In addition, the controller CNT analyzes each command received and performs prespecified processing (e.g., setup alteration). Additionally the controller CNT monitors residual power (or charged amount) of the power supply POW and, when the residual power drops down below a threshold level, causes the wireless processor WPR to send to base station BST an alarm indicating that the power is going dead.

As the wireless processor WPR performs measurement with limited power for a long time, it is desirable that this processor operates intermittently to thereby reduce its power consumption. For example, as shown in FIG. 4, the controller CNT is arranged to temporarily halt driving of the sensor SSR in a sleep mode SLP and then switch or “wake up” to its operation mode WAK from the sleep mode for driving the sensor SSR to send measurement data.

The power supply POW supplies electrical power to the wireless processor WPR that performs communications with base station BST and each function block SSR, AAT, CNT, WPR. A typical example of the power supply is a battery (including a rechargeable battery pack) although this invention is not limited thereto. Other examples are a self-power generation module, such as a solar cell, vibration power generator or the like, and an external power feedable arrangement which is adaptable for use with stationary sensor nodes rather than mobile sensor nodes.

Although the example of FIG. 3 is designed to have one sensor SSR and actuator AAT in one sensor node, this may be modified so that more than two sensors SSR and actuators AAT are disposed therein. Alternatively, the sensor SSR may be replaced by a memory storing its unique identifier ID. Still alternatively, the sensor node may be used as a tag. As for the wireless mobile sensor node MSN and wired sensor node FSN also, each is arrangeable in a similar way to the configuration shown in FIG. 3 or 4.

<Examples of Locator Node>

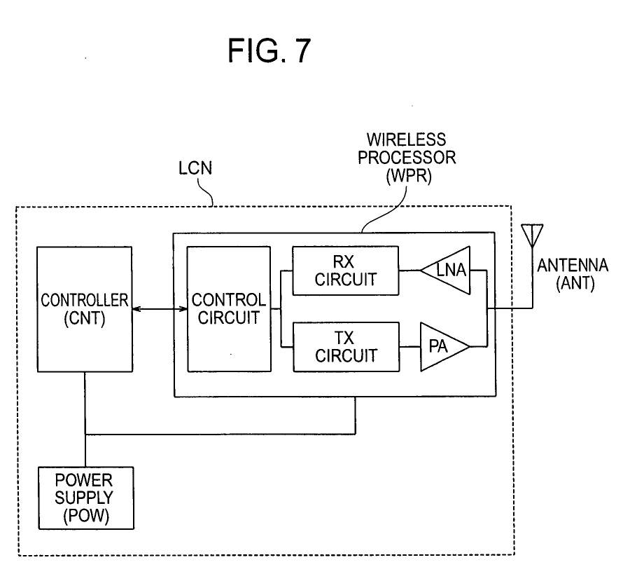

Examples of the locator node LCN are shown in FIGS. 7 through 14.

FIG. 7 shows an exemplary configuration of the locator node LCN. This locator node is generally made up of a wireless processing unit WPR which performs interception of a communication of from a sensor node to base station and which communicates with the base station BST, a power supply POW for supplying electrical power to each block CNT, WPR, a controller CNT for controlling the wireless processor WPR and power supply POW, and an antenna ANT for performing transmission and reception over the air. The controller CNT adds a locator node ID to the information received and then transfers it to the wireless processor WPR. The controller CNT, wireless processor WPR, power supply POW and antenna ANT are arrangeable by identically the same constituent elements as those of the wireless sensor node WSN in FIG. 3. A primary objective of the locator node LCN lines in interception of a communication of its nearby sensor node for transferring its information to base station BST so that the sensor SSR and actuator AAT shown in FIG. 3 are not depicted in FIG. 7; however, the sensor SSR and actuator AAT may be built therein in a similar way to the configuration example of the wireless sensor node WSN of FIG. 3. Thus it is also possible to arrange the locator node LCN by use of identically the same hardware as that of the wireless sensor node WSN of FIG. 3.

The locator node LCN has at least a node monitoring mode for interception of a communication of its nearby sensor node and a communication mode for communication with the base station BST. In the normal communication mode, a communication-capable distance is set at a maximally increased value in order to stably perform communications with base station BST; in the node monitor mode, a sensor node detection region NDA is set up in accordance with a position specifying accuracy request of an application. This sensor node detection region setup is performed by the controller's control of the wireless processor.

The example of FIG. 7 is the one that realizes the communication mode and the node monitor mode by a hardware configuration. For example, when the maximal communicable distance between the locator node LCN and base station BST in the communication mode is set at “Am” while letting the radius of the detection region in the node monitor mode be set to “Bm” (A>B), it is necessary to design the low-noise amplifier LNA and receiver circuit in the wireless processor WPR of FIG. 7 in a way which follows: in the communication mode, these receive electrical waves reached from a faraway base station BST in the maximum distance Am; in the node monitor mode, they do not receive a communication from a sensor node which is far apart by a distance exceeding the value Bm in maximum.

A first approach to attaining this requirement is to employ a method which uses a specific barometer called the received signal strength indicator (RSSI). More specifically, the intensity of received radiowave that was transmitted from a sensor node with the RSSI value of Bm is used as a threshold value, and only when RSSI of the received or “intercepted” radiowave is greater than the threshold, an attempt is made to acquire ID information of the sensor node from the received wave and transmit the information. Adjusting the threshold makes it possible to change the radius of the detection region.

Determining whether it is greater than the threshold value may be performed by a control circuit which controls the receiver circuit or, alternatively, may be done by the controller CNT.

A second approach is to use a method for adjusting the gain of low-noise amp LNA to match a preset distance. Usually, the gain of LNA is adjusted by auto-gain control (AGC) function or else so that received radiowave is treated at the maximum gain level in accordance with the intensity of this wave. This makes it possible to absorb a difference in received wave strength, amplify it up to a signal level required for received signal processing in a later process, and perform the received signal processing. It is noted that if the signal reception level is too low, the signal reliability is no longer guaranteeable due to unwanted noise mixture; thus, certain processing is required for ignoring those signals that do not exceed a prespecified signal level even after having amplified by AGC to the maximum level, which signals are not regarded as effective signals.

In contrast, when setting is done to deal as a minimal receivable level the strength of radiowave transmitted by a sensor node that is spaced by a distance equal to the preset detection region radius, it becomes impossible to deal as an effective signal a received signal with its wave intensity lower than the preset level. A setup method therefor is to force the gain of LNA to stay at a value at which the strength of radiowave transmitted by a node at a distance equal to the detection region radius becomes the minimum receivable level. With this method, it becomes possible to detect only the communication of a sensor node residing within the preset detection region in the node monitor mode. Adjusting the fixed gain value makes it possible to modify the radius of such detection region. Additionally, the signal level for the later processing may be adjusted at an optimal value by amplifying the gain of LNA with the minimum level being as an upper limit. In this case, a need is felt to notify a post-stage signal reception processing unit of the information of a gain value which was actually used for AGC.

The first and second approaches stated above are combinable together for practical implementation.

Generally, radiowave given off from a transmission source and reaching the antenna of a receiver is a mixture or “superposition” of a direct wave that is directly reached from the transmitter and an indirect wave that is reached by way of a plurality of paths (multi-path) as a result of reflection due to the presence of ceilings, installed objects or the like as well as diffraction and penetration. Respective radiowave components are different from each other in propagation distance due to differences in route to the antenna, resulting in deviation in arrival time. This leads to occurrence of a phase difference, which causes radiowaves to strengthen and attenuate each other (multi-path fading). The wave arrived is variable in strength because its transmission conditions can vary depending on the positions of transmission source and receiver circuit and the spatial and over-time characteristics of surrounding environments. Due to this wave strength fluctuation, an error can take place in the specified radius of the detection region. Generally, the longer the distance between the transmitter and receiver, the greater the influence of such multi-path fading.

On the contrary, the method of this invention for specifying the position of a sensor node by use of the locator node LCN is such that the distance between the transmitter and receiver antenna becomes shorter when compared to the trilateration measurement methods based on distance presumption using radiowave strength; thus, it is expected that the influence of measurement errors occurring due to multi-path fading becomes smaller. This enables the measurement accuracy to increase accordingly. Simultaneously the processing speed is improved as it does not require any complicated computation for reducing the influence of radiowave strength variations.

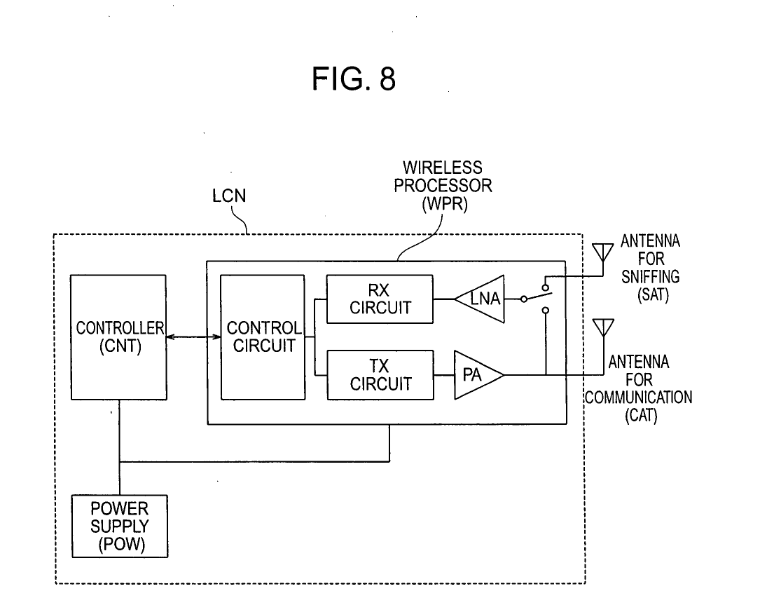

See FIG. 8, which shows an example which realizes the above-noted communication mode and node monitor mode by switching between antennas optimized for respective modes. More specifically, a switch is provided for switching between a communication-use antenna CAT and a monitor-use antenna SAT in such a way as to connect the communication antenna CAT during communications and, in the node monitor mode, connect the monitoring antenna SAT. The communication antenna CAT is illustratively an antenna which is low in signal reception sensitivity than the monitoring antenna SAT while letting the antenna sensitivity be adjustable in conformity to a detection region radius to be set up.

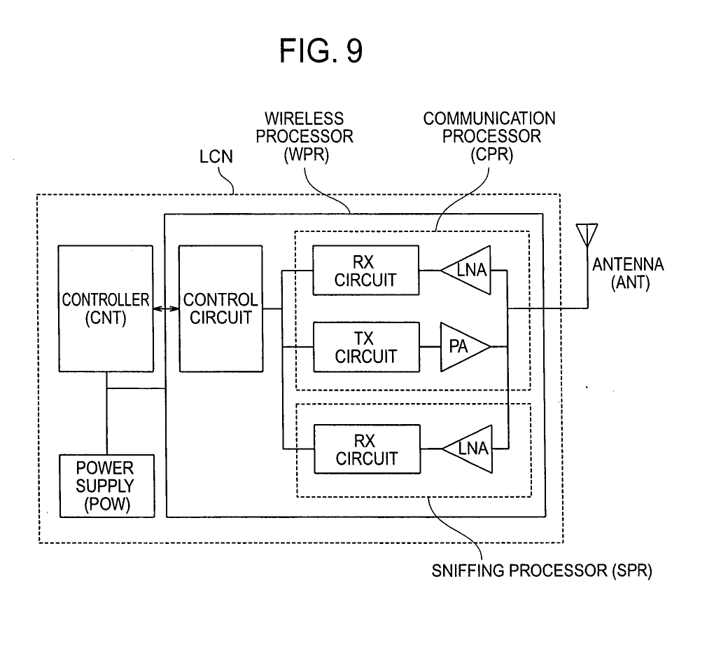

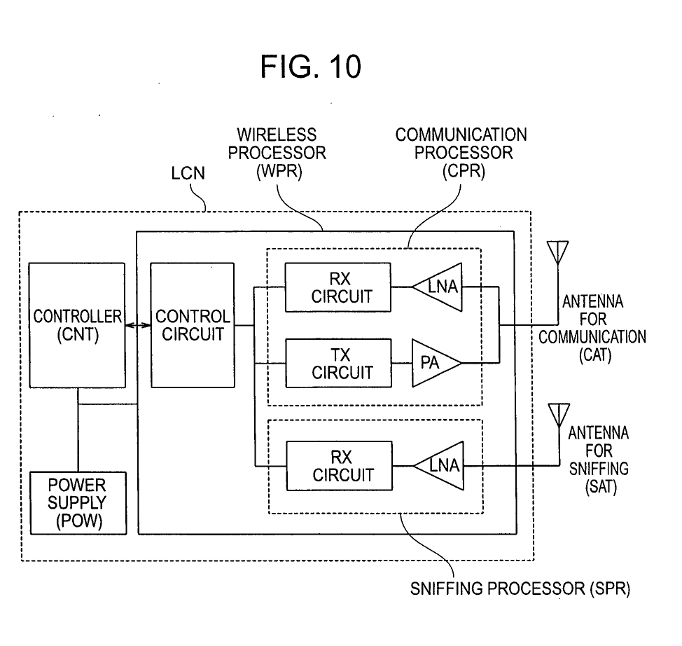

Turning to FIG. 9, an example having two receiver circuits is shown, wherein one of them is for the communication use and the other is for the node monitoring use. A wireless processor WPR shown herein includes a communication-use processing unit CPR and a monitoring-use processing unit SPR. The communication processor CPR has a receiver circuit for receiving a signal of base station BST in the communication mode, and a transmitter circuit for transmitting a signal to base station BST. The monitoring processor SPR has a receiver circuit which is adjusted to receive only a communication of a sensor node that exists within the preset detection region radius in the node monitor mode. A control circuit performs communications using the communication processor CPR in the communication mode and intercepts a communication of the sensor node using the monitoring processor SPR in the node monitor mode. In the case of this configuration example, it is possible to perform operations both in the communication mode and in the monitor mode at a time. Alternatively, as shown in FIG. 10, the communication antenna CAT and monitor antenna SAT may be arranged so that the former is connected to the communication-use processing unit whereas the latter is to the monitor-use processor unit.

<Sensor Node Position Specifying using Locator Node>

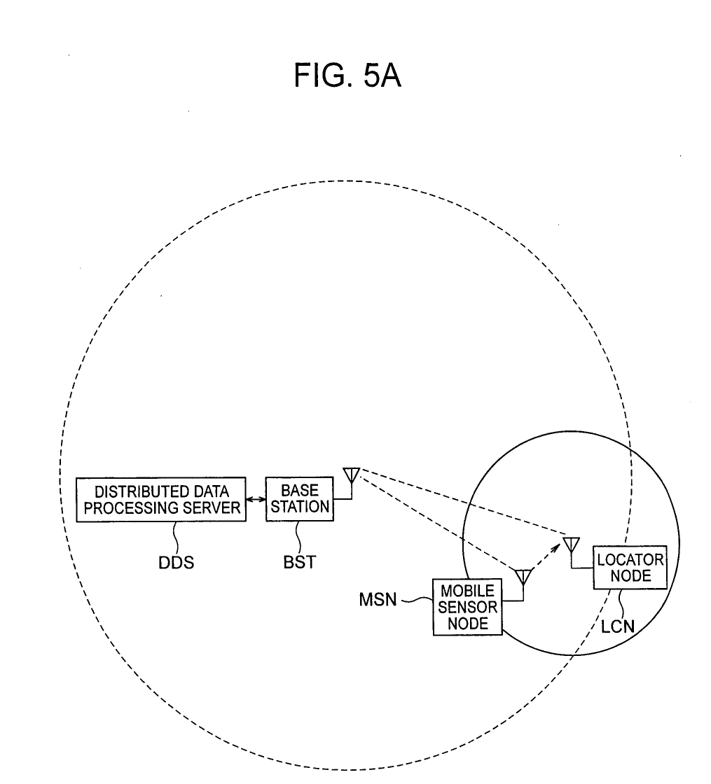

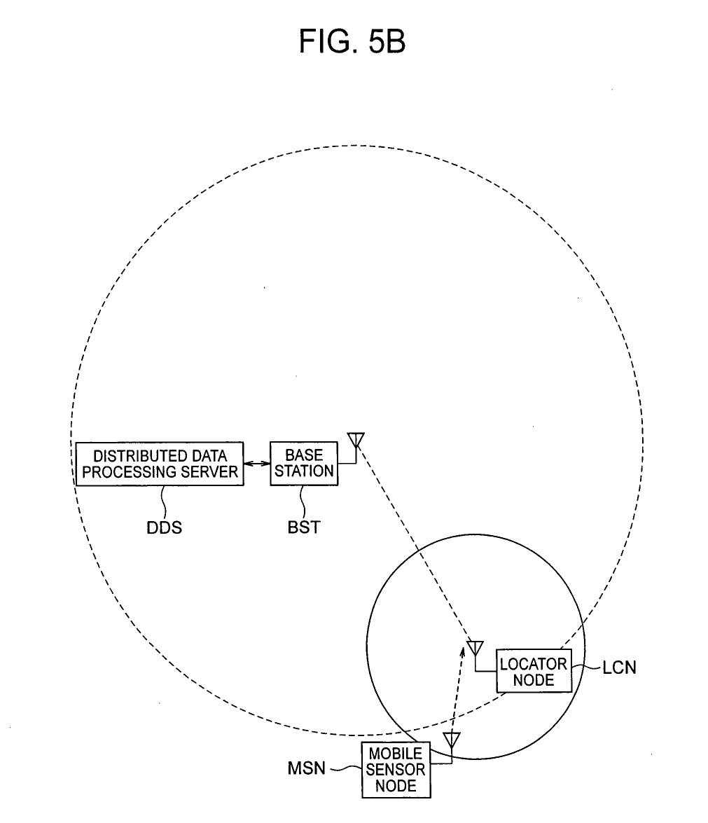

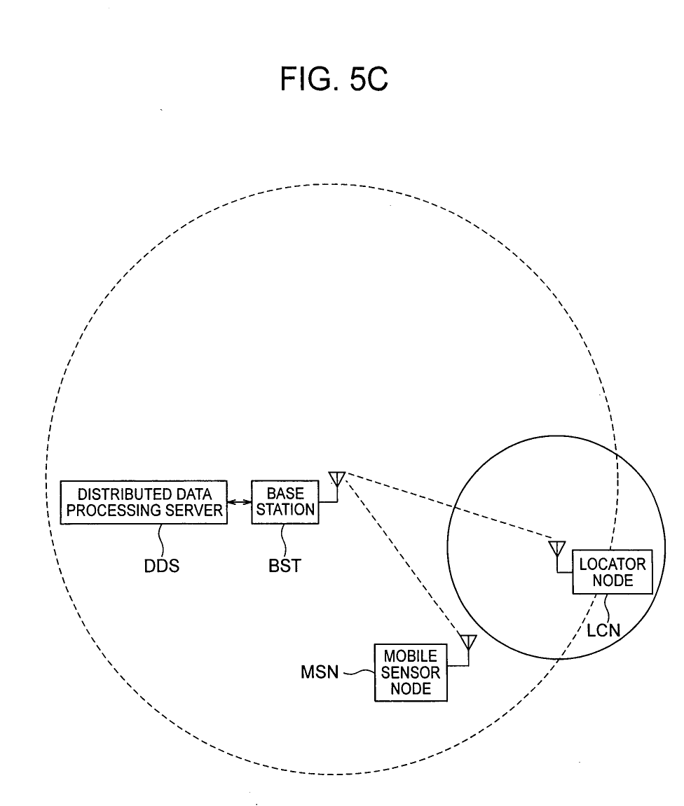

FIGS. 5A to 5C are diagrams for explanation of methodology of detecting a mobile sensor node MSN by using a locator node LCN. The locator node LCN is a one constituent element of the sensor network SNS, which communicates with a base station BST by the same communication scheme as the sensor node. As previously stated, the locator node LCN catches a communication of a sensor node to the base station within a preset region and extracts information such as the ID code of this sensor node and then transfers it to the distributed data processing server DDS via base station BST.

FIG. 5A shows a case where both the locator node LCN and sensor node MSN are present within the communication region of the base station and, simultaneously, the sensor node exists within the locator node's detection region. The base station BST receives from the sensor node certain data containing sensing data and sensor node ID information and also receives data received from the locator node, which contains sensor-node ID information and locator-node ID information. A server regards the position of the locator node as the sensor node position when two sensor-node ID information being contained in the data received from the base station are the same as each other. Thus it is possible to make correlative correspondence between the sensing data and the node position.

FIG. 5B shows a case where only the locator node exists within the base station's communication region whereas the sensor node resides within the detection region of the locator node. The base station receives only the transmission data from the locator node and does not receive any transmission data from the sensor node. Whereby, the server detects that the sensor node of interest exists within the detection region of the locator node and, at the same time, resides outside of the communication range of the base station. The sensor node may not be a sensor node under management of the sensor network system to which the locator node belongs. If this is the case, it detects that a “foreign” sensor node with its affiliation being presently unknown exists within the detection region of the locator node. At this time, if its format is the same as that of the sensor node under management of the sensor net system, acquire ID information of such affiliation-unknown sensor node; if the format is different then send to the server the information indicating that it is a sensor node with unknown ID and affiliation. With this procedure, it is possible in the server or the application system to notify a system manager of the fact that the affiliation-unknown sensor node exists.

FIG. 5C shows a case where both the locator node and the sensor node exist within the communication range of the base station and, simultaneously, the sensor node is out of the detection region of the locator node. While the base station extracts sensor-node ID information from transmission data received from the sensor node, it does not receive from the locator node the data containing therein sensor-node ID information that is the same as the extracted sensor-node ID information. Whereby, the server detects that the sensor node exists within the base station's communication range and, simultaneously, resides out of the detection region of the locator node.

As apparent from the foregoing, the sensor network system embodying the invention is arranged to specify the position of a node existing within at least either one of the detection region of locator node and the communication range of base station. Accordingly, it is no longer required to presume the exact distance between a base station and terminal when compared to prior known trilateration techniques so that strict base-station position determination becomes unnecessary. In addition, accurate time synchronization between base stations becomes unnecessary. It is no longer needed to situate base stations so that adjacent ones are in close proximity to each other. This results in cost reduction. Further, as the locator node is installable at any place desired by a user by taking into consideration those factors that affect the strength of radiowaves due to the presence of shieldings, such as walls, floors, and installed things, any complicated calculations for reduction of wave strength fluctuations becomes unnecessary. Furthermore, what the sensor node must do is merely to send its sensing data to the base station, and it is not needed to send a signal for position measurement to the base station and/or the locator node. Thus it is possible to reduce power consumption of the sensor node.

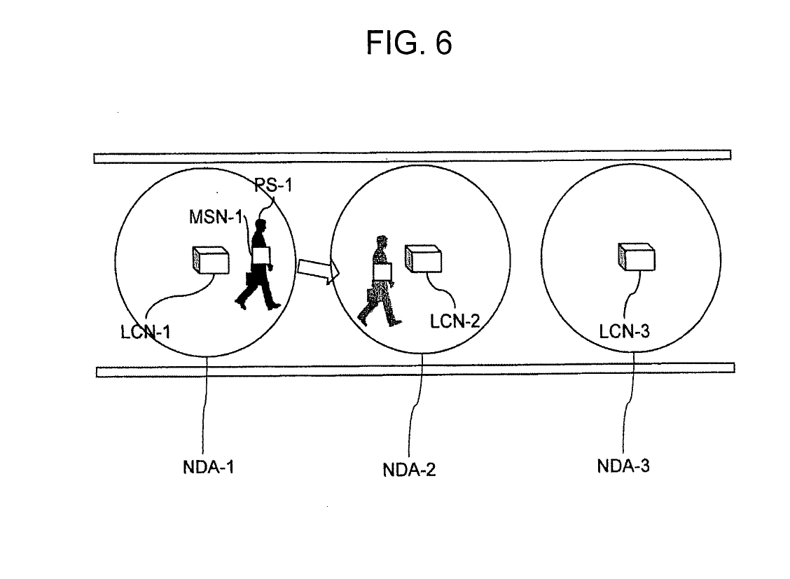

FIG. 6 shows a principal concept for specifying a present position of a moving body by using locator nodes LCN. Assume here that the moving body is a walking business person PS-1, who has a mobile sensor node MSN-1, which is linkable with locator nodes LCN-1 to LCN-3 having sensor-node communication receivable detection regions NDA-1 to NDA-3, respectively. The person PS-1 is presently within the detection region NDA-1 of locator node LCN-1. When the mobile sensor node MSN-1 makes communication with a base station, the locator node LCN-1 catches this communication to acquire ID information of MSN-1 and then transfers it over the air to a distributed data processing server DDS. This server manages the installation position information of each locator node LCN in the form of a table (i.e., the locator node position table within DSK in FIG. 2) and determines, based on detection information of mobile sensor node MSN-1 by means of the locator node LCN-1, the position of the person PS-1 having MSN-1 to be near or around the locator node LCN-1. Next, suppose that the person PS-1 moves into the detection range NDA-2 of locator node LCN-2. When the mobile sensor node MSN-1 perform communication within this region, the locator node LCN-2 detects the presence of MSN-1 by catching such communication and acquires from this communication the ID information of MSN-1 and then transmits it to the distributed data processing server DDS. This server DDS judges, based on the locator-node position table, that a present position of the person PS-1 having node MSN-1 is near the locator node LCN-2. In this way, it becomes possible for the sensor network system SNS to specify the position of the moving body as the position of locator node LCN whenever this body performs communication within the detection region NDA of locator node LCN while simultaneously moving.

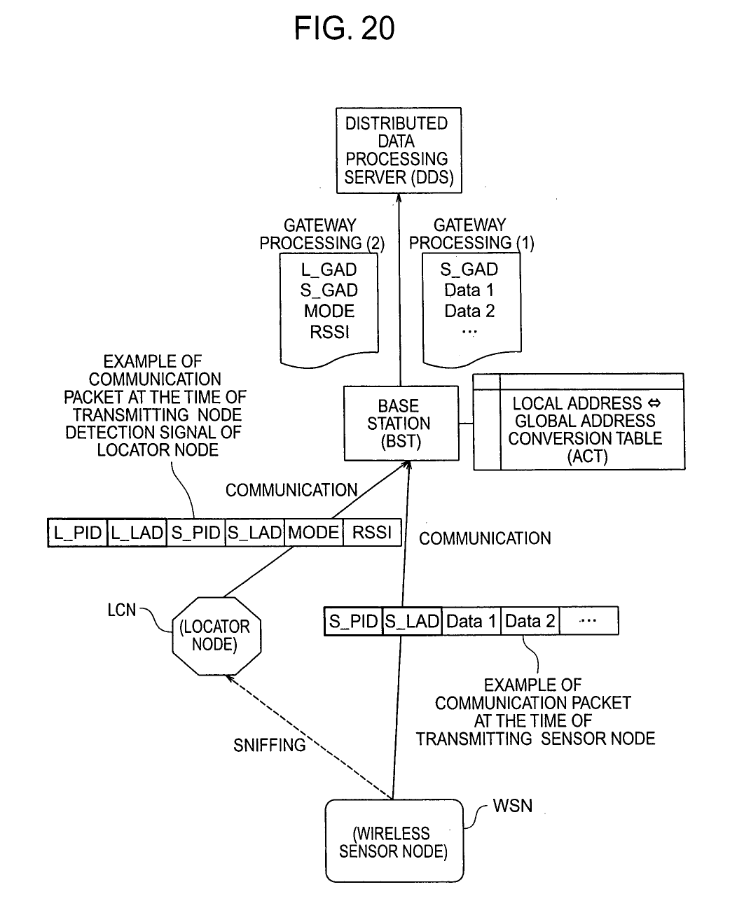

A detailed explanation will be given of the sensor-node position specifying method with reference to FIGS. 20 to 22. FIG. 20 is a diagram showing an exemplary data flow in case a locator node LCN catches a communication of a wireless or “radio” sensor node WSN.

A packet data signal is transmitted over the air from the radio sensor node WSN to a base station BST, which signal includes a packet having a header with an S_PID being PAN ID of sensor network and a local address S_LAD being contained therein plus a data field containing data (Data1, Data2, . . . ) such as sensor values. Taking as an example the radio sensor node configuration of FIG. 3, a sensor value (Data1, Data2, . . . ) acquired by a sensor SSR in reply to an instruction from the controller CNT is processed into a communication packet(s) along with the local address S_LAD of the radio sensor node WSN per se being held in a storage device (not shown) in the controller CNT and S_PID that is PAN ID to which it belongs and then sent out via the wireless processor WPR.

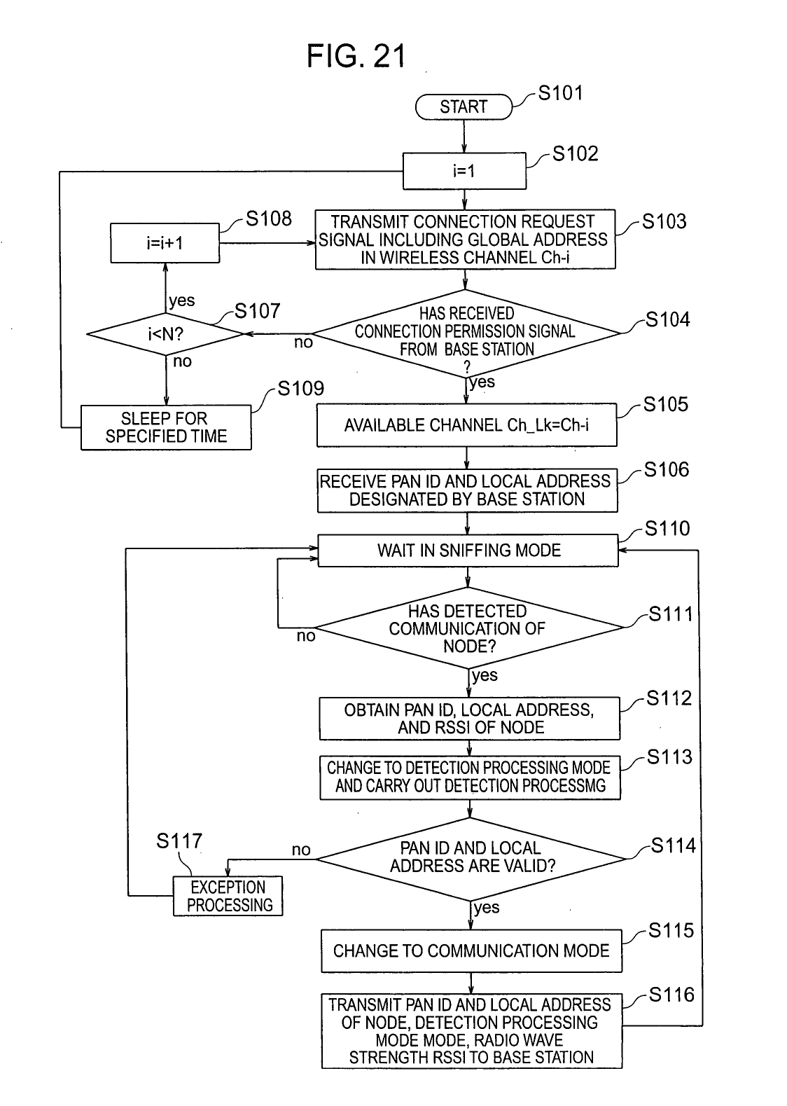

The processing to be performed by the locator node LCN will be described using FIG. 21. Upon power-up or resetting (at step S101), the locator node LCN sequentially uses a plurality of existing wireless channels ch-i (i=1, 2, . . . , N) (at S102) to transmit a connection request signal together with its own global address (S103) in order to search a connectable base station and establish connection thereto. In contrast, upon receipt of a connection permission signal from a specific base station (S104), determine its channel ch-i to be an in-use or “busy” channel (S105); then, acquire PAN ID and local address designed by this base station for continuous use in the communication to be later performed (S106). This processing flow will be repeated until receipt of a connection permission signal from base station (S107, S108). In case such connection permission signal is received from no radio channels, it is determined that no respondable base stations are present within the communication range, followed by an attempt to retry after having slept for a specified length of time (S109).

After establishment of the connection with the base station, the locator node waits in the node monitor mode (at step S110), and periodically performs detection of a communication from the node; upon detection of the communication, acquire the node's PAN ID, local address and RSSI (S111, S112). When such node communication is not detectable, return to the node monitor mode.

After having acquired the node's PAN ID and local address and RSSI, go into a detection processing mode for executing detection processing (S113). When the node's PAN ID and local address obtained by the detection processing are effective PAN ID and local address which are included within the range of a predefined value (S114), go into the communication mode (S115); then, send to the base station BST the detected sensor node PAN ID and local address and detection processing mode MODE plus wave strength RSSI upon receipt of the communication together with the locator node's own PAN ID and local address (S116); thereafter, go back into the node monitor mode.

In case the acquired PAN ID and local address are failed to be accepted as effective ones, ignore the communication or, alternatively, perform exception processing such as transmission of abnormality detection information to the base station BST (S117); thereafter, return to the node monitor mode.

Taking as an example the configuration of locator node LCN of FIG. 7, the wireless processor WPR catches a packet of the radio sensor node WSN and then sends it to the controller CNT. The controller CNT acquires S_PID and S_LAD from the header of this packet, which will be processed into a communication packet along with the locator node LCN's own local address L_LAD being held in the storage device (not shown) in the controller CNT and L_PID of PAN ID to which it belongs and then sent via the wireless processor WPR.

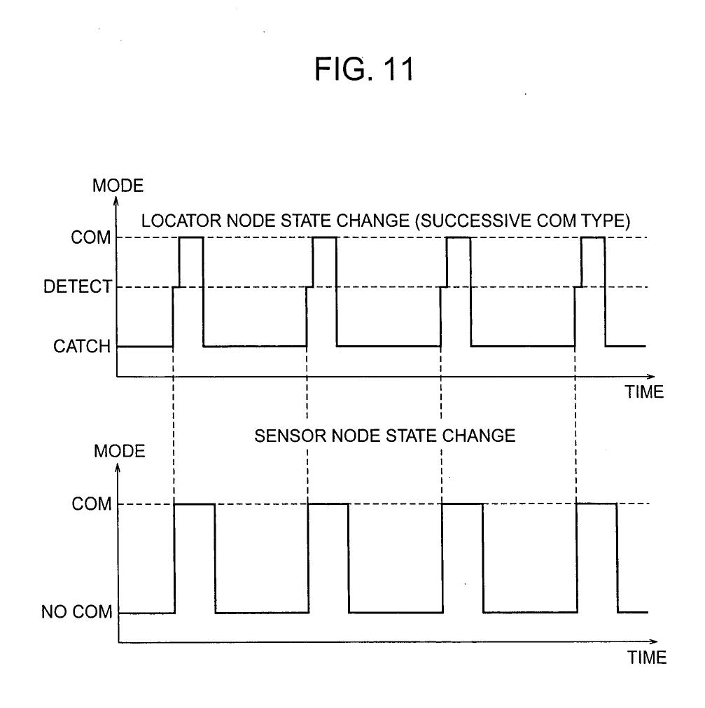

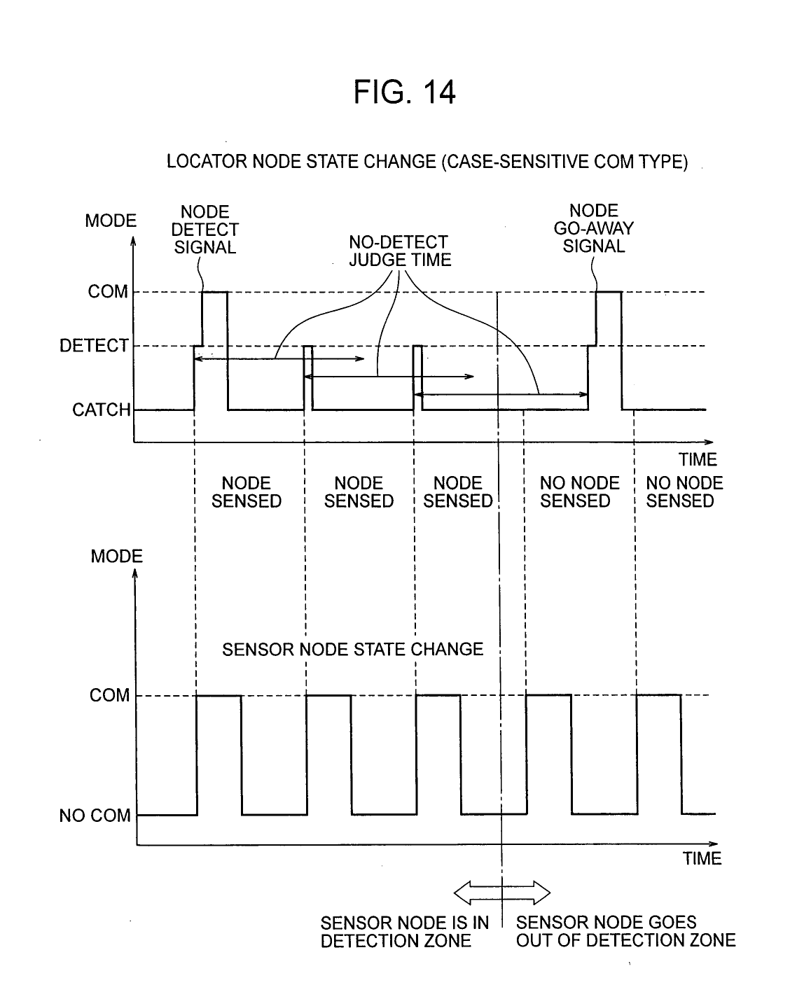

In the example of FIG. 20, additional information items to be used in the other distributed data processing servers DDS and applications are also sent together, which include a node detection processing mode (either a node detection signal of the successive transmission type or a node detection signal of the event-sensitive transmission type) as will be discussed later with reference to FIGS. 11-14 and the radiowave strength RSSI at the time of receipt of a communication of the radio sensor node WSN. In case the locator node LCN is operating in the event-sensitive communication type to be later described in FIG. 14, a node departure signal is sent as a communication packet when the radio sensor node WSN goes out of the detection region of locator node LCN. In this case the data field contains at least S_PID being PAN ID of radio sensor node WSN, local address S_LAD and node detection processing mode MODE (indicating it is a node departure signal of the event-sensitive communication type).

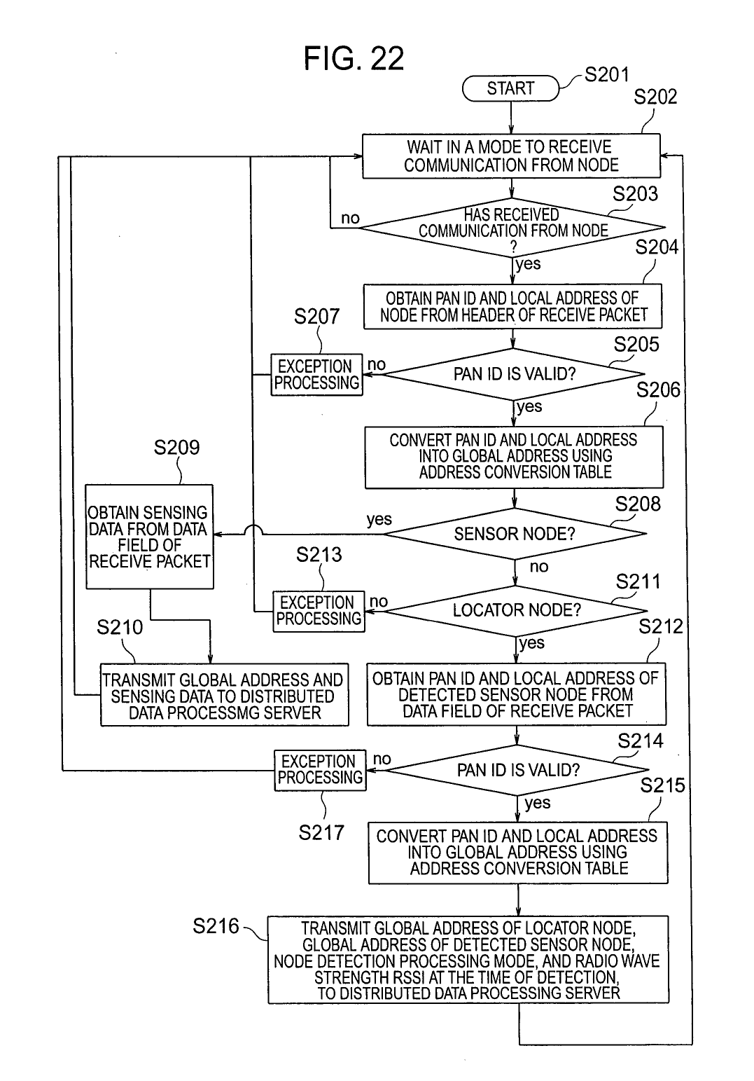

Next, the processing to be performed by the base station BST will be described with reference to FIG. 22. Note that the explanation below is related only to the processing to be performed upon receipt of a communication packet(s) from a sensor node and/or locator node LCN which relate to this invention, with description of the remaining processing to be done by the base station BST being eliminated herein, such as initialization, quit processing, and inter-server processing.

When the base station is ready for receipt of a communication from any node (at step S201), this station waits in a mode for receiving the communication from the node (at S202). Upon receipt of a communication packet as sent from a radio sensor node WSN or locator node LCN (S203), it acquires from the received packet header both the PAN ID and local address of such node (S204). If this PAN ID is equal to PAN ID to which the base station BST belongs, determine it must be a correct PAN ID (S205); then, use a local/global address conversion table to convert the PAN ID and local address into a global address (S206).

In case the communication packet received is transmitted from the radio sensor node WSN, the PAN ID becomes S_PID, the local address is S_LAD, and the global address is S_GAD. Alternatively, when the received communication packet is sent from the locator node LCN, the PAN ID becomes L_PID, the local address is L_LAD, and the global address is L_GAD.

The base station BST makes reference to the global address under management of the sensor node manager SNM and, when a global address which was converted from the local address being contained in the received packet is the one that was given to the radio sensor node WSN (at step S208), acquires sensing data Data1, Data2, . . . from the data field of the received packet (at S209). After completion of transmission to the distributed data processing server DDS (S210), go into a mode for receiving communications from nodes. Upon failure of judgment as correct PAN ID, ignore it or, alternatively, perform the exception processing while regarding it as abnormal detection information (S207); then, return to the node communication receive mode.

When the global address that was converted from the local address being contained in the received packet is the one that was given to the locator node LCN (S211), an attempt is made to acquire the radio sensor node PAN ID and local address as extracted from the data field (S212). If this PAD ID is identical to PAN ID to which the base station BST belongs, determine it is a correct PAN ID (S214) and then use the local/global address conversion table to convert the PAN ID and local address to a global address (S215). Upon failure of judgment as correct PAN ID, ignore it or, alternatively, perform exception processing while regarding it as abnormal detection information (S217); thereafter, return to the node communication receive mode. Then, send to the distributed data processing server DDS the locator node's global address and the detected sensor node global address along with node detection processing mode MODE and detected communication's wave strength RSSI (S216). If the received packet is from none of the radio sensor node WSN and locator node LCN, ignore it or, alternatively, perform the exception processing while regarding it as abnormal detection information (S213), followed by returning to the node communication receiving mode.

The distributed data processing server's database controller DBC checks the received WSN's S_GAD and S_GAD included in LCN; if these are the same then let the position of L_GAD be the position of S_GAD. Further, it specifies the position of S_GAD using the locator node position table.

Additionally, when the sensor node of interest moves to another base station's network, a PAN ID of another base station residing in its moved area is newly given to a request from the node: at a stage prior to execution of the granting of such new PAN ID, it will possibly happen that the sensor node tries to communicate with the base station or, alternatively, the locator node catches the communication thereof. In the explanation above, if such sensor node's PAN ID is different from PAN ID to which the base station belongs, then ignore it or, alternatively, perform the exception processing while regarding it as abnormal detection information. However, if the base station BST is designed to have a conversion table between a local address of another base station BST that belongs to another PAN and a global address, it becomes possible to convert the PAN ID and local address being contained in the communication packet into the global address even where the locator node LCN belonging to the same PAN as the base station BST catches a communication packet(s) of a radio sensor node WSN′ belonging to another PAN.

Additionally, when another locator node exists within the locator node's detection region, one locator node LCN-1 can detect another locator node LCN-2 depending on the timing. In this case, the system lapses into a circulation or “closed-loop” state, wherein the locator node LCN-2 on the detected side adversely detects a node detection signal packet as sent from the locator node LCN-1 on the detecting side and sends its own node detection signal, which is again detected by LCN-1. To avoid this, a fixed length of packet insensitive time interval is provided in the node monitor mode of locator node for performing control in such a way as to do nothing upon detection of a successively transmitted communication from the same node.

An example is that a time taken for process detection processing is added to a time required for the locator node LCN to send a detection signal packet since its detection of a communication packet sent from another node and, further, an appropriate marginal time is added thereto, thereby providing a total time which may be used as an insensitive time. By setting a time interval taken for the same sensor node to send its communication packet to be sufficiently longer than this insensitive time, there is no risk as to detection failure of the communication from the sensor node. Another available approach is to add in advance an identifier code indicative of the node type to a communication packet to be sent by each node, thereby deactivating the node detection processing in cases where a packet received by the locator node contains the identifier code of the locator node per se. An alternative approach is to retain the local address of more than one locator node with certain detectability in the internal storage device of each locator node, for disabling the node detection processing in case the local address contained in the received packet is ascertained, through address verification prior to execution of the detection processing, to be identical to the local address of locator node being presently stored.

Although in this embodiment the detected sensor node's PAN ID and local address are included in the data field of the node detection signal being sent by the locator node, it is also possible to perform transmission while containing the detected sensor node's local address in a short address storage region of locator node of a node detection signal packet header and containing in its data field the global address owned by the locator node. In this case, the base station may be arranged to use the same processing routine as the communication packet from the sensor node to convert only the local address of the packet header into a global address and then send the global address of locator node being stored in the data field directly to the distributed data processing server DDS while regarding it as a sensor value. With such the arrangement, it is no longer necessary to provide within the base station a processing unit for determining whether it is a packet from the locator node and for acquiring the local address of sensor node from the data field only in the case of the packet from the locator node to thereby convert it to a global address, resulting in the base station becoming simplified in its processing.

<State Change of Locator Node>

FIG. 11 is a diagram graphically showing a state change pattern of a sensor node when this node is within the detection region of a locator node and a corresponding state change of the locator node. The sensor node performs communication periodically or opportunistically in an “event-driven” way that is sensitive to an event, such as a sensing result, while alternately repeating communication and non-communication modes (see a lower graph of FIG. 11).

The locator node operates with transition among three modes, i.e., the node-monitoring mode, detection processing mode, and communication mode (an upper graph of FIG. 11). When the sensor node performs communication while the locator node is in the node monitor mode (at step S110 of FIG. 21), the locator node detects such communication and goes into the detection processing mode (at S113 of FIG. 21). In the detection processing mode, it collects ID information of the sensor node from a received sensor-node signal and then transits into the communication mode (S115 of FIG. 21) to thereby send the sensor-node ID information acquired (S116 of FIG. 21) and, thereafter, returns to the monitor mode. The locator node successively performs the series of operations whenever it catches a communication from the sensor node. With the automatic return to the monitor mode in this way, it is possible to acquire an increased amount of information.

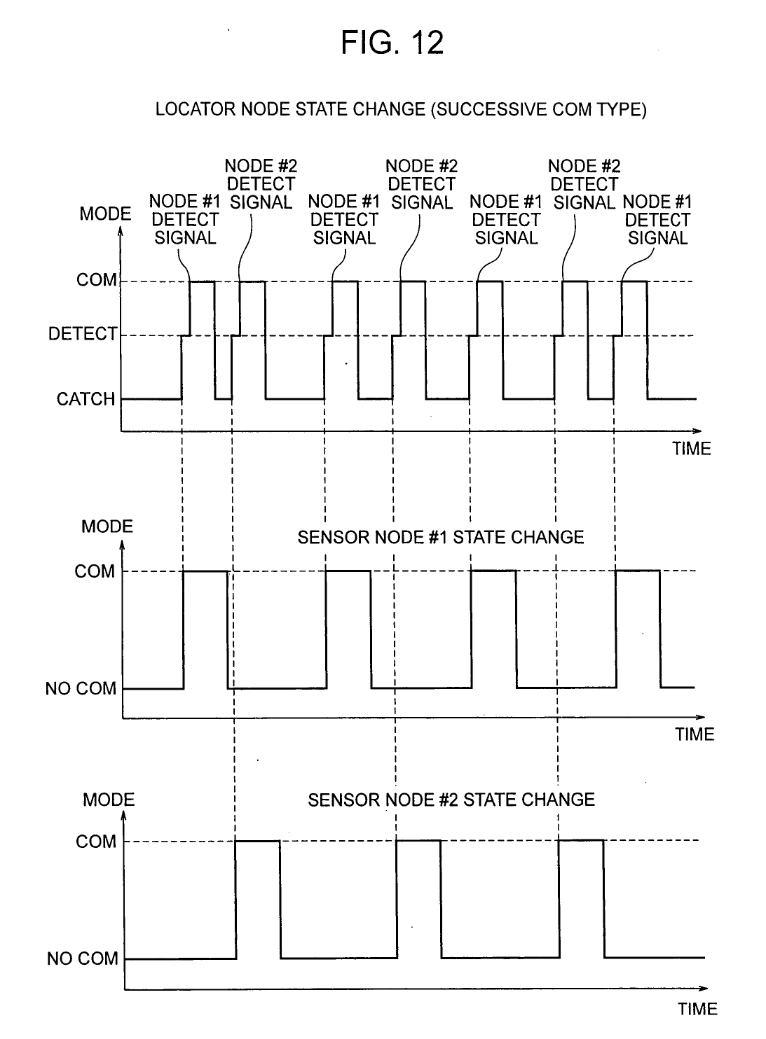

FIG. 12 is a diagram graphically showing state changes in case two sensor nodes are present within the detection region of a locator node. Upon detection of a communication of a first sensor node, the locator node sends ID information of this sensor node as a first node detection signal; when detecting a communication of a second sensor node, the locator node sends its ID information as a second node detection signal. If the sensor node's communication occurs while the locator node is in an operation mode other than the node monitor mode, the locator node fails to catch such sensor-node communication—in this case, it catches the next communication. To minimize the time period that the locator node is incapable of catching any communication of the sensor node, some designs are employable, such as shortening the communication times of the locator node and sensor node, or resending the communication of sensor node, etc.

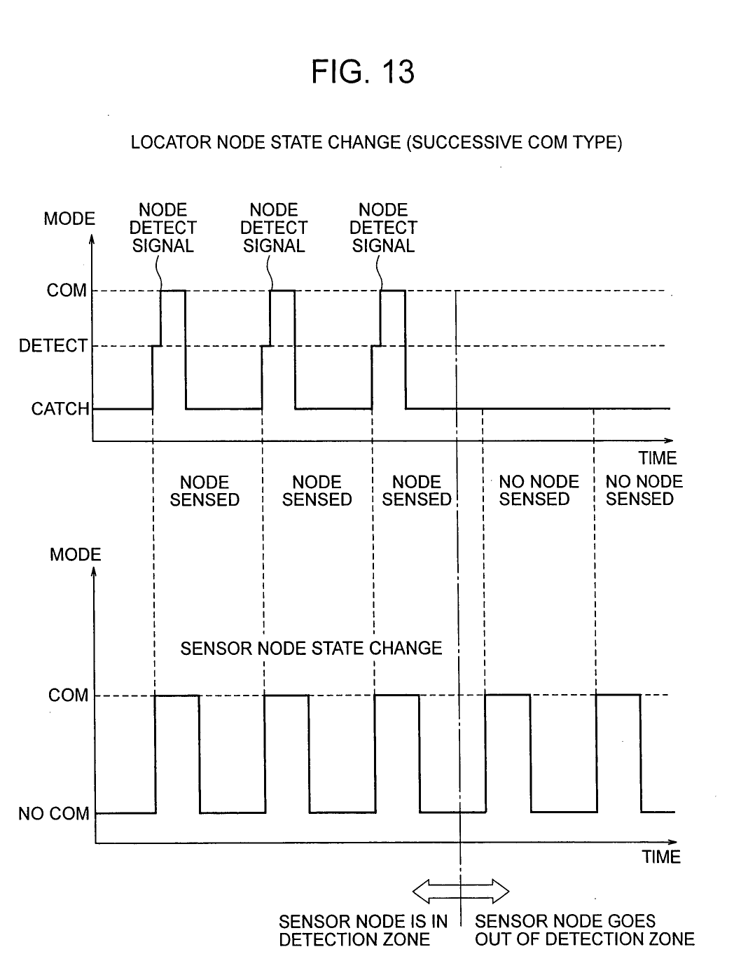

FIG. 13 shows a pattern of state changes in case the sensor node moves and goes out of the detection region of the locator node. As shown herein, a similar state change to that of FIG. 11 is repeated while the sensor node exists within the detection zone; however, after the sensor node has escaped from within the detection zone, the locator node cannot detect any communication of the sensor node so that no node detection signal is sent from the locator node.

Although each of the cases shown in FIGS. 11-13 is a method of the successive communication type for causing the locator node to send a detection signal, once at a time, whenever it receives a communication of a sensor node. With this approach, when the sensor node is high in repetition of communication or when many sensor nodes are present within the detection region of the locator node, the detection signal to be sent from locator node becomes higher in repetition of communication, resulting in an increase in traffic. In view of this, as shown in FIG. 14, an event-sensitive or “timely” communication type method may alternatively be used, which permits the locator node to send a node detection signal when it first detected a communication of the sensor node and to send a departure signal when it becomes unable to detect the sensor-node communication.

In FIG. 14, the locator node detects a communication which was made immediately after the sensor node enters the detection region of locator node, and sends a node detection signal. The locator node has non-detection judgment time intervals and, when catching the next communication from the same sensor node within one of the non-detection judgment time intervals, performs a sensor-node detection operation, but does not send any detection signal. In case the locator node cannot detect the next communication from the sensor node within the non-detection judgment period since the last detected communication, such as when the sensor node escaped from the detection zone or when no subsequent communications are made due to other causes, the locator node adds to the sensor-node ID information certain information indicating that the sensor node escaped after elapse of the non-detection judgment time and then sends it as a node departure signal.

The non-detection judgment time is a time period defined per sensor node: even when a communication from a certain sensor node is detected within the non-detection judgment time of a different sensor node, this does not affect measurement at the non-detection judgment time. An example of the non-detection judgment time is a predefined fixed value. Another example is a value adjusted in conformity with the communication interval of a sensor node detected. To do this, the locator node is arranged to have its built-in memory which stores a table describing IDs or types of sensor nodes and information for determining corresponding non-detection judgment time lengths, thereby enabling determination and setup of an appropriate non-detection judgment time by referring to the table using ID of a sensor node detected. An alternatively employable approach is to make inquiries to the distributed data processing server DDS at the first transmission of a node detection signal, receive as a command the information for determination of the non-detection judgment time, and then perform setup.

It is also possible to arrange the controller CNT of locator node to perform preselected processing to thereby determine the locator node is forced to operate in which one of the successive communication type and the event-sensitive communication type. Alternatively, the both methods are usable at a time, which are changed over by a dip switch or else attached to the locator node. Still alternatively, it is possible to transmit a command indicating the use of a method that is developed by a system manager or an application designer toward the locator node via the directory server DRS, distributed data processing server DDS and base station BST, and use it selectively through switching. It is also permissible to use a technique which provides means for observing the congestion of a radiocommunication transmission channel(s), for registering, as an action through the use of the function of the sensor network system SNS, the processing of sending a changeover command to the locator node by selecting the successive communication type when the transfer channel is busy or selecting the event-sensitive communication type when the transfer path is idle, and for causing the event action controller of distributed data processing server DDS to perform judgment and switching when acquiring the congestion as an event.

<Layout of Locator Nodes>

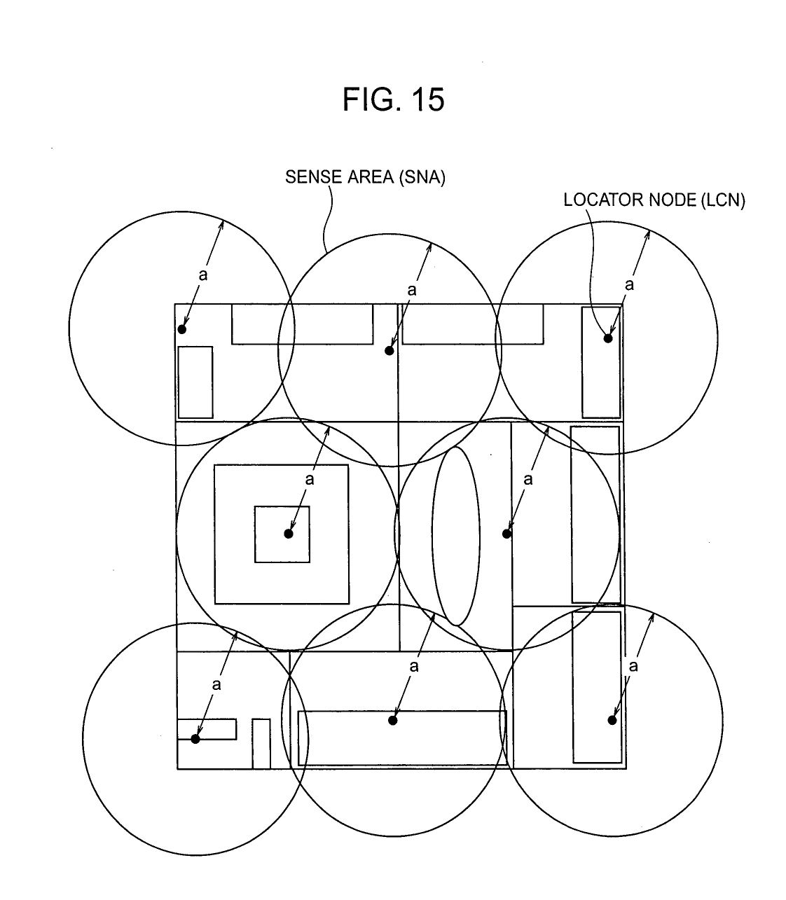

FIGS. 15 to 18 depict exemplary layout patterns of locator nodes in an observation field. Small circles shown herein designate locator nodes LCN whereas large circles denote detection regions SNA thereof.

FIG. 15 shows a setup example which covers the entire area of an observation field by the detection regions SNA of multiple locator nodes. With this setting, by enlarging the radius “a” of detection region, it is possible to cover almost the entirety of the observation field by a reduced number of locator nodes.

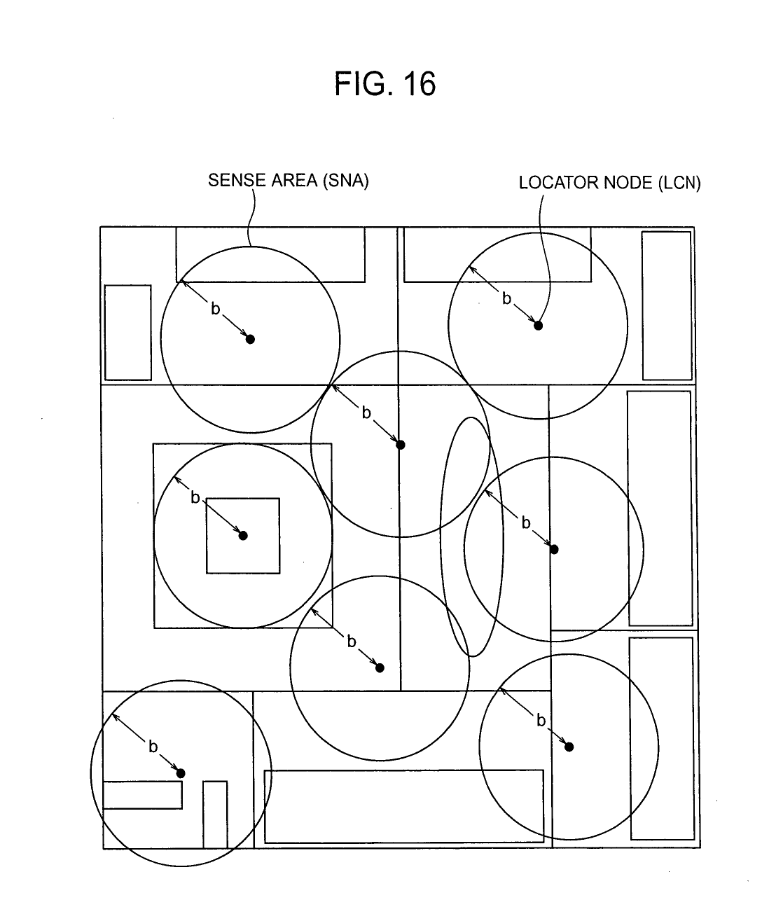

FIG. 16 shows an example which uses the same number of locator nodes to set up several detection regions each having a relatively small detection radius “b.” With this setting, it is possible to accurately specify positions with the aid of a less number of locator nodes, although there are the areas incapable of specifying sensor-node positions because the entire observation field is not covered. In such case, the sensor-node position is roughly presumable by using a process having the steps of calculating the moving speed and direction of a mobile sensor node based on a mobile sensor-node position detection time point and locator node layout for example, and applying time integration to the moving direction and the distance of from the last observed land point to a present position. Thus it is possible to cover the whole observation field even by use of a reduced number of locator nodes. The velocity/direction calculation and the position presumption based thereon are performed by either the application system APS or the directory server DRS.

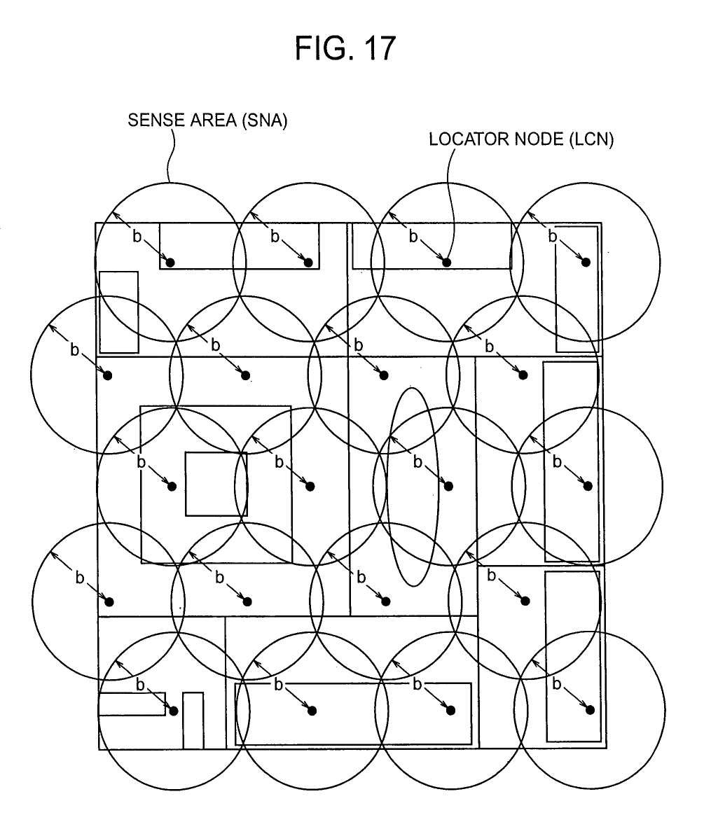

FIG. 17 shows an example which closely disposes a great number of locator nodes each having a relatively small detection radius b in the observation field. With this setting, it is possible to cover the entire observation field while offering high position specifying accuracy.

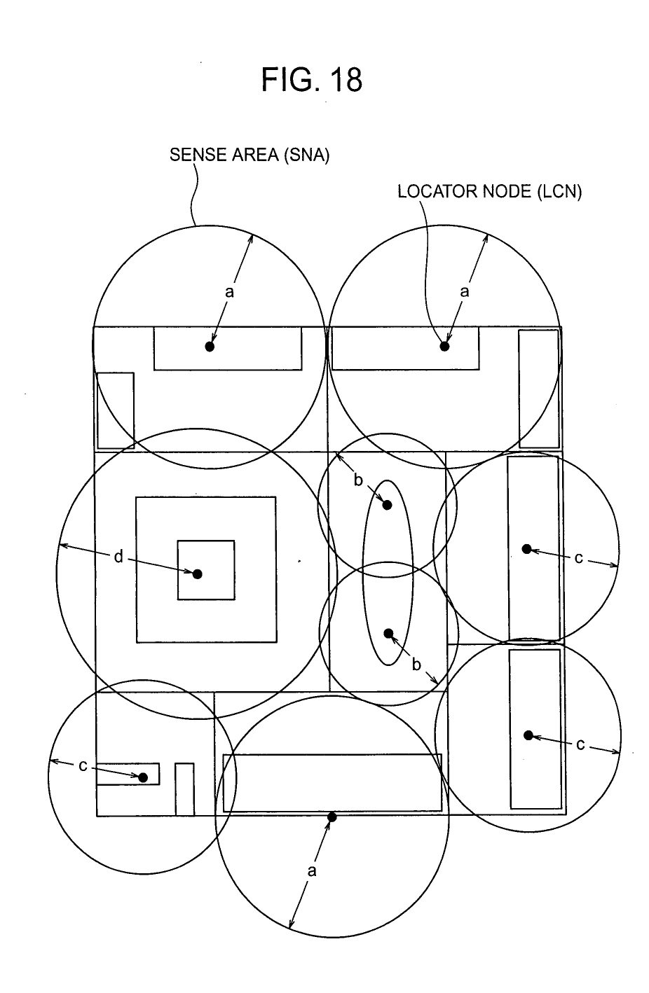

FIG. 18 shows an example which determines the layout positions of locator nodes LCN and the radius values of detection regions SNA in a way pursuant to a present situation of the observation field. For instance, for those areas with rough position determinability, locator nodes with a large detection radius “d” are disposed densely; for areas under the requirement for precise position specifiability, locator nodes with small detection radius “b” are placed sparsely. In the other areas with intermediate requirements, locator nodes with an intermediate detection radius “c” are laid out. With this layout design, it is possible to realize both the required accuracy and the coverage without having to significantly increase the number of locator nodes used.

By adjusting the number of locator nodes and their layout plus the detection region radius in this way, it becomes possible to specify node positions with proper setting optimized for the aimed observation field and application.

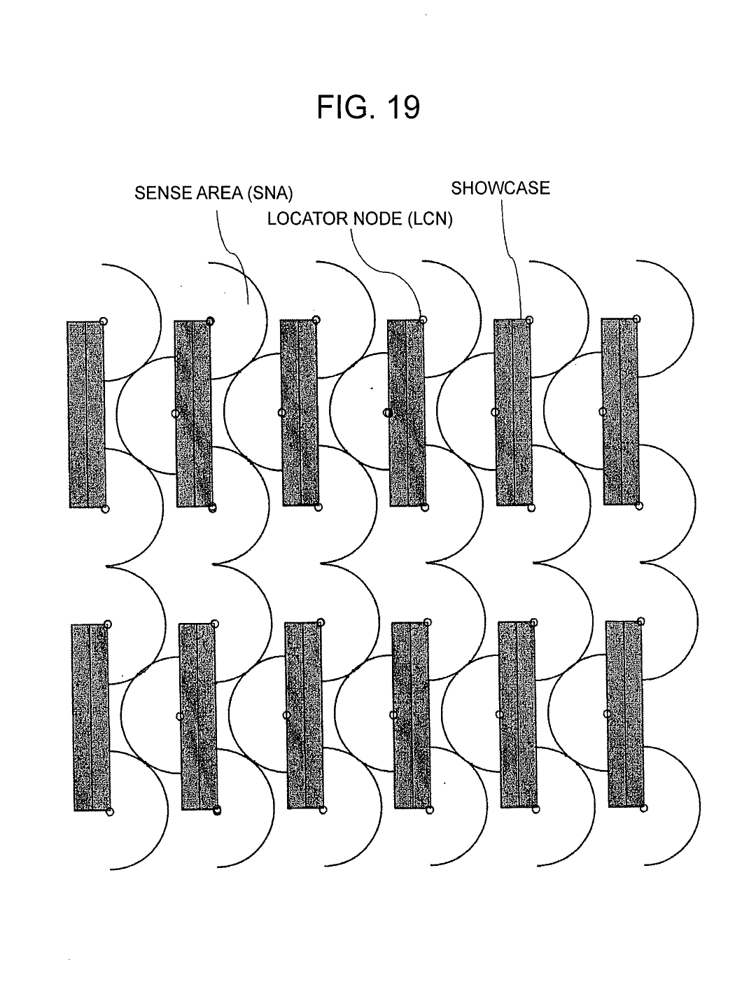

FIG. 19 shows an example which controls the directional characteristics of detection regions by letting antennas have directivity in the node monitor mode of locator nodes LCN or by installing radiowave-shielding things around the antennas. For example, in an application for installing the locator nodes at merchandise showcases in a store or shop and for specifying the position of a mobile sensor node, when it is desired to recognize the mobile sensor node is present on which one of passages between adjacent showcases, control is provided so that the detection region of interest becomes a semicircle when looked at planarly for example by installing shieldings around the antennas or by using antennas of the type having directivity, thus making it possible to limit the detection region to a specified direction only. Examples of the shieldings are metallic showcases and installed things with increased radiowave shieldability.

<Sensor Network Installation Examples>

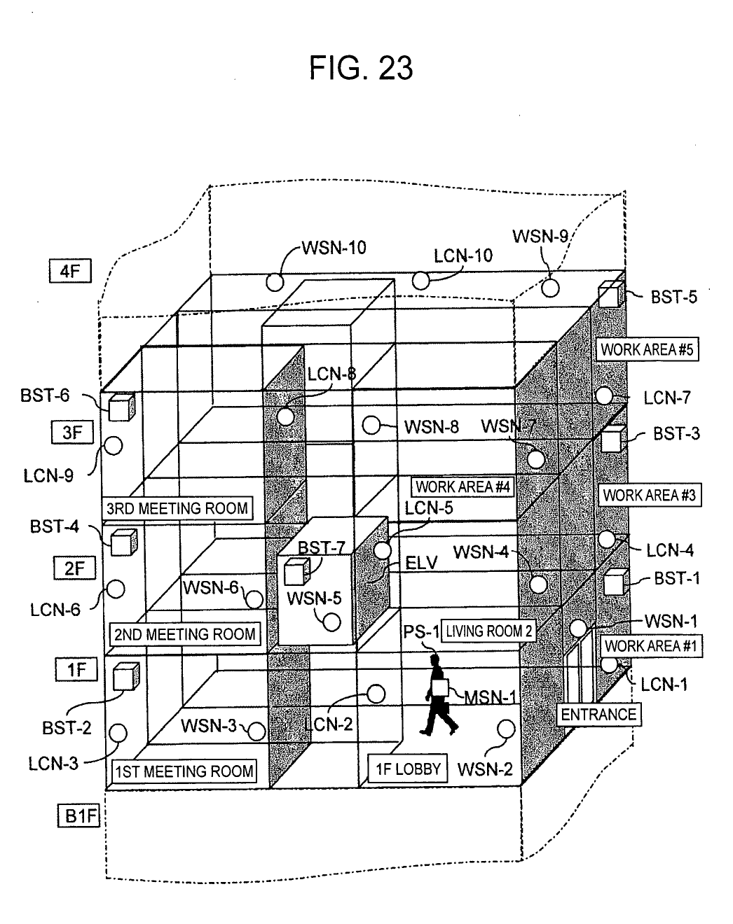

FIG. 23 is a diagram showing an installation example of sensor nodes and locator nodes to be linked to distributed data processing servers DDS. In this example shown herein, a base station is installed on each floor of an office building, and the locator nodes are situated at selected locations, such as a lobby, rooms, elevators, etc., while letting persons in this building have their own mobile sensor nodes. While this example assumes the use of wireless sensor nodes, a distributed data processing server and a sensor nodes are connectable together either by a radiocommunication link or by a wired communication link: selecting which one of them may be done on a case-by-case basis.

The building of FIG. 23 has a first floor with a stuff room No. 1 and a first meeting room, wherein a base station BST-1 is installed in the former whereas a base station BST-2 is in the latter. On the second floor, a base station BST-3 is installed in a stuff room No. 3, and a base station BST-4 is in a second meeting room. On the third floor, a base station BST-5 is installed in a stuff room #5, and a base station BST-6 is in a third meeting room. A base station BST-7 is placed in an elevator cab ELV.

The locator nodes LCN are installed at those locations within the building under the need for specifying present positions of moving objects, such as persons. In the example of FIG. 23, locator nodes LCN-1 to LCN-10 are situated at a portal, lobby, meeting rooms and stuff working spaces, respectively. A person PS-1 in the building has a mobile sensor node MSN-1 of the nameplate shape, for example. Stationary wireless sensor nodes WSN-1 to WSN-10 are installed at doorways, stuff rooms and meeting rooms, for using human body sensors to detect entry and exit of persons at the portal of building, and for using temperature sensors, humidity sensors, illuminance sensors to detect the absolute values of a room temperature, humidity and brightness or changes thereof in the stuff rooms and meeting rooms.

Any one of the sensor node MSN-1 and stationary wireless sensor nodes WSN-1 to WSN-10 plus locator nodes LCN-1 to LCN-10 perform over-the-air wireless communications with either one of the base stations BST-1 to BST-7 to thereby send a node detection signal at the time of sensor-aided detection of a state quantity, a change in the state amount or the presence of a sensor node. The base stations BST-1 to BST-7 transmit the state amount or a change in state amount as received from a sensor node and/or locator node toward the distributed data processing servers DDS via the networks NWK-2 to NWK-n.

<Operation Concept of Sensor Network>

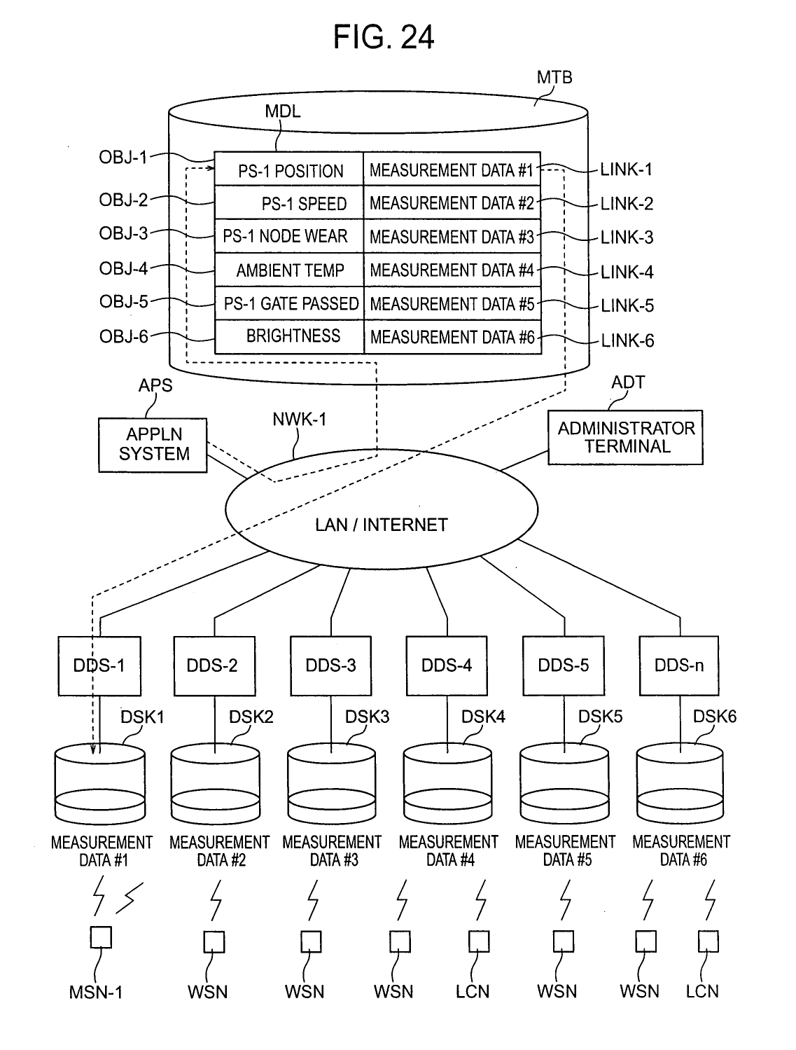

An explanation will next be given of the overview of an operation of the sensor network system SNS with reference to FIG. 24. FIG. 24 is a block diagram showing the correlation of objects in the practically implemented form of a real world model and measurement data of sensor nodes.

The distributed data processing servers DDS that have been explained using FIGS. 1-2 pregenerate as the real world model certain objects (OBJ-1 to OBJ-6) as will be described later and define them in the real world model list MDL of real world model table MTB as shown in FIG. 24. Shown here is the case of the person PS-1 who visits or works in the office building of FIG. 23 under an assumption that this person has the wireless sensor node MSN-1 shown in FIG. 24, which is attached to his or her cloth as a personal item.

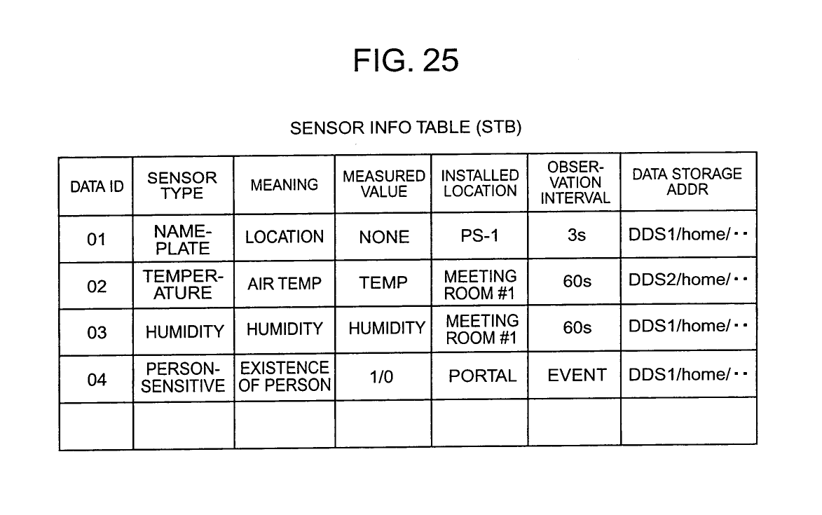

The position information of the mobile sensor node MSN-1 is defined by the device manager NMG to be stored in a distributed data processing server DDS that is designated by measurement data No. 1 (data storage destination of FIG. 25). The position information of mobile sensor node MSN-1 is defined as the position of a locator node LCN which detected the sensor node MSN-1.

The real world model list MDL of real world model table MTB defines that an object (OBJ-1) representing the position of person PS-1 has an entity of data at the storage destination of the measurement data #1 (LINK-1), with management of one-to-one correspondence relationship between the real world model and the actual data storage position. More specifically, in the real world model list MDL, the object OBJ-1 that is the position of person PS-1 is correlated with the storage position of distributed data processing server DDS corresponding to the measurement data #1 (LINK-1). In the example of FIG. 24, the position information of wireless sensor node MSN-1 indicative of a present position of the person PS-1 (i.e., it exists at which one of the base stations) is stored in the disk device DSK1 of distributed data processing server DDS-1, as an example.

Although the value of the PS-1 position (OBJ-1) is accessible from the application system APS as if it exists in the real world model table MTB of directory server DRS, its actual data is stored not in the directory server DRS but in the disk device DSK-1 of distributed data processing server DDS-1.

An object OBJ-2 that is the moving speed of the person PS-1 is defined in the real world model table MTB so that the moving sensor node MSN-1's velocity information is stored in measurement data No. 2 (LINK-2). While there are several approaches to obtaining the velocity of mobile sensor node MSN-1, the simplest one is to obtain it from the switching time of a locator node LCN for detection of the moving sensor node MSN-1, although the invention is not specifically limited thereto. Further defined are a distributed data processing server DDS corresponding to the measurement data #2 and its storage position. For example, store it in a disk device DSK2 of distributed data processing server DDS-2.

An object OBJ-3 that represents PS-1 node attachment is defined in the real world model table MTB so that a detected node installation state is stored in measurement data #3 (LINK-3), which state is judged through mount/demount detection by a switch or else attached to a clip of the nameplate type wireless sensor node MSN-1. Further defined are a distributed data processing server DDS corresponding to the measurement data #3 and its storage position. For example, the state of the switch attached to MSN-1 is stored in a disk device DSK3 of distributed data processing server DDS-3.

An object OBJ-4 that represents an ambient temperature is defined in the real world model table MTB so that temperature information is stored in measurement data #4 (LINK-4), which temperature is measured by a temperature sensor of a wireless sensor node (e.g., WSN-3 in FIG. 23) that is linked to the person PS-1's connected base station (e.g., BST-1). Further defined are a distributed data processing server DDS corresponding to the measurement data #4 and its storage position. For example, the temperature from wireless sensor node WSN-3 is stored in a disk device DSK4 of distributed data processing server DDS-4.

An object OBJ-5 that represents the pass-through of person SP-1 is defined in the real world model table MTB so that person detection information is stored in measurement data #5 (LINK-5), which is detected by the living body sensor of a wireless sensor node (e.g., WSN-2) that is linked to the person PS-1's connected base station (e.g., BST-1). Further defined are a distributed data processing server DDS corresponding to the measurement data #5 and its storage position. For example, the person detection information from wireless sensor node WSN-2 in FIG. 23 is stored in a disk device DSK5 of distributed data processing server DDS-5.

An object OBJ-6 that represents the ambient brightness is defined in the real world model table MTB so that illuminance information is stored in measurement data #6 (LINK-6), which is detected by the illuminance sensor of a wireless sensor node (e.g., WSN-3 in FIG. 23) that is linked to the person PS-1's connected base station (e.g., BST-1). Further defined are a distributed data processing server DDS corresponding to the measurement data #6 and its storage position. For example, the illuminance from the wireless sensor node WSN-3 is stored in a disk device DSK6 of distributed data processing server DDS-6.

In this way, the respective objects OBJ that are defined in the real world model table MTB retain the storage destinations (LINK) corresponding to the measurement data. Although it is seen from the application system APS that its aimed data exists in the directory server DRS, the real data is stored in the distributed data processing servers DDS.

In the information storage destination LINK, the application system's utilizable data storage positions are set up, such as measurement data of sensor nodes or processed data converted from the measurement data into a form readily treatable by the application system. The measurement data from sensor nodes are collected and accumulated in respective distributed data processing servers DDS; if one or more event actions are set as will be described later, computational processing is applied to the measurement data for storage in a specified one or ones of the distributed data processing servers DDS as processed data.

The actual data collection from sensor nodes, data accumulation and data processing are performed by the distributed data processing servers DDS while the directory server DRS manages the storage destinations of the real world model and information along with the sensor node definitions.

With this arrangement, it is possible for application system developers to obtain any desired data corresponding to the measured value (or processed data) of a sensor node while eliminating the need for intentional attention to the presence of sensor nodes.

The directory server DRS manages the storage destination (linked part) per object OBJ while causing the real data to be stored in and processed by the distributed data processing servers DDS so that it is possible to prevent the distributed data processing servers DDS from becoming excessively large in workload even when the sensor nodes involved becomes extremely larger in number. In other words, it is possible to lessen the risk of an excessive increase in traffic of the network NWK-1 that connects together the directory server DRS and distributed data processing servers DDS plus application system APS while using a great number of sensor nodes.

After a predetermined length of time has elapsed since startup of measurement, the actual measurement data from sensor nodes are written in the disk devices DSK1-6 of distributed data processing servers DDS, with the amount of such data increasing with time. On the contrary, the storage destinations LINK-1 to LINK-6 corresponding to the objects OBJ-1 to OBJ-6 being set in the real world model list MDL of real world model table MTB of directory server DRS are kept unchanged in information amount even with elapse of time—what is changeable is only the content of the information indicated by the storage destinations LINK-1 to LINK-6.

Although in the example of FIG. 24 different objects are stored in different data processing servers, some different objects may be stored in the disk device of the same data processing server, when the need arises. A rule may be determined in view of the treatability of data processing, which rule describes that a measurement data from which one of the objects is to be stored in which data processing server.

<Relationship of Measurement Data and Event>

The relationship of the measurement data to be collected by the distributed data processing servers DDS versus the event actions based on such measurement data will next be described with reference to FIGS. 25 to 27.

FIG. 25 shows an example of a sensor information table STB under management of the directory server DRS. The sensor information table STB is stored in the above-noted real world model table MTB. In the sensor information table STB, several items are stored per data ID to be given to measurement data, such as the sensor type, the meaning of sensing information, measured value, sensing interval, and data storage destination. Although here the ID is given on a per-measurement data basis by taking into consideration the fact that a one sensor node is correlated with a plurality of kinds of sensing data, the data ID is replaceable by a sensor node ID if a sensor node is correlatable with only one kind of sensing data. The information being stored in the sensor information table shown in FIG. 25 is exemplary and may be increased or decreased according to manageability of the sensor network system.

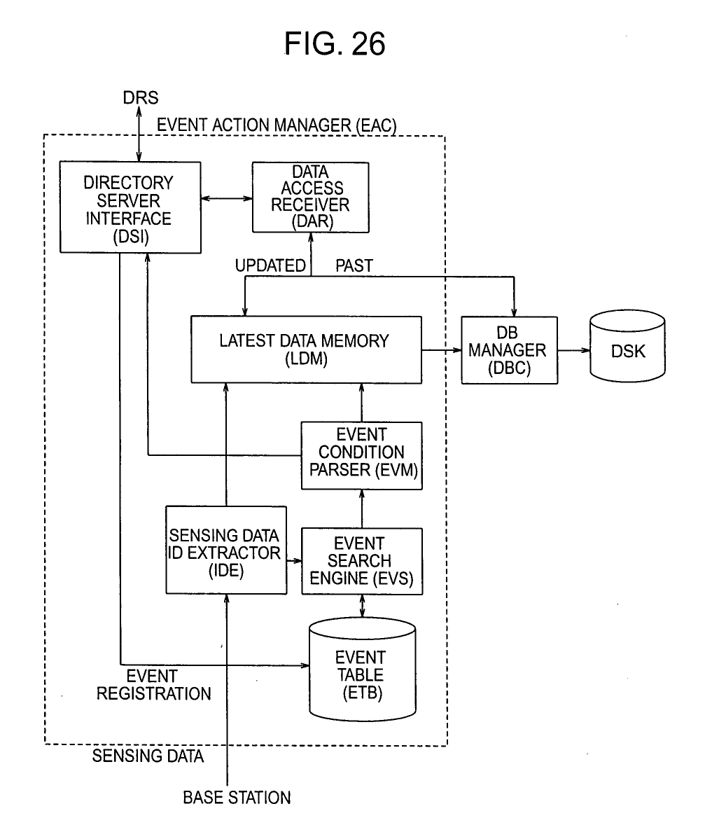

As shown in FIG. 26, the event action controller EAC of a distributed data processing server DDS has an event table ETB which correlates with an event the measurement data collected from its associated base station(s) BST via a directory server interface DSI. As shown in FIG. 27, this table ETB contains records each consisting essentially of a data ID (DID) that is assigned per sensor node and is given to measurement data, an event content EVT that is an event generation judgment condition with respect to the measurement data, and a data storage DHL for determining whether the measurement data is stored in the database DB or not.

For example, for measurement data with its data ID of “XXX,” event generation is notified to the directory server DRS when its value is larger than A1. Additionally, the data with the ID of “XXX” is set to be written in the disk device DSK at the time of data arrival.

The distributed data processing server DDS includes a sensing data ID extraction unit IDE, which accepts the measurement data received from the base station BST and then extracts a data ID given thereto. The sensing data ID extractor IDE sends the data to a latest data memory LDM.

The data ID extracted is sent to an event search unit EVS, which searches the event table ETB; if a record that matches the data ID is found, this record's event content and the measurement data are passed to an event generation judging unit EVM.

The event generation judge unit EVM compares the value of measurement data to the event content EVT and, if the condition is satisfied, notifies the directory server DRS of the event generation via the directory server interface DSI. Simultaneously this judge unit EVM sends a request of data storage DHL to the memory LDM.

The database control unit DBC receives from the memory LDM certain data with its data storage DHL flagged with “YES” and writes it in disk device DSK.

When the directory server interface DSI receives a measurement data referencing request from the directory server DRS, the distributed data processing server DDS sends this request to a data access reception unit DAR.

If the access request is the last updated data, the data access receptor unit DAR reads out of the memory LDM measurement data corresponding to the data ID included in the access request and then returns it to the directory server interface DSI. Alternatively, if the access request is a past data then read from the disk device DSK the measurement data corresponding to the data ID contained in the access request for return to the directory server interface DSI.

In this way, in the distributed data processing server DDS, the last updated data of the sensor node data collected from base station BST is held in the memory LDM whereas only data expected to be required in later processing is recorded in the disk device DSK. It is also settable that only the data at an event occurrence time is recorded in the disk device DSK. In this case, it is possible to prevent unwanted increase in disk use amount otherwise occurring due to periodical data collection (at observation time intervals). With the method stated above, it becomes possible to manage a plurality of base stations BST (i.e., a great number of sensor node) by a single distributed data processing server DDS.

<Action Control Unit>

FIG. 28 is a block diagram showing a configuration of the action control unit ACC of the directory server DRS.

The action controller ACC is arranged to automatically perform a preset operation (action) based on the event generation amount as received from event action controllers EAC of more than two distributed data processing servers DDS.

To do this, the action controller ACC is configured from an action reception unit ARC which receives and accepts action setup from the application system APS via the session controller SES, an action analyzer unit AAN which analyzes the received action while making reference to the information of the real world model table MTB through the model manager unit MMG to thereby set up function (workload) sharing between the directory server DRS and distributed data processing server DDS in accordance with the analysis result, an action manager AMG that manages action definition and execution, an action table ATB that stores the relationship of an event(s) and action(s) in reply to a setup request from the application system APS, an event surveillance instructing unit EMN that sends out an instruction to distributed data processing server DDS-1, . . . , DDS-n so that it surveils or “watchdogs” the event(s) defined in the action table ATB, an event receiver unit ERC that receives the notice of an event occurred in each distributed data processing server DDS-1, . . . , DDS-n, and an action execution unit ACE which executes a specified action based on the received event and the definition of action table ATB.

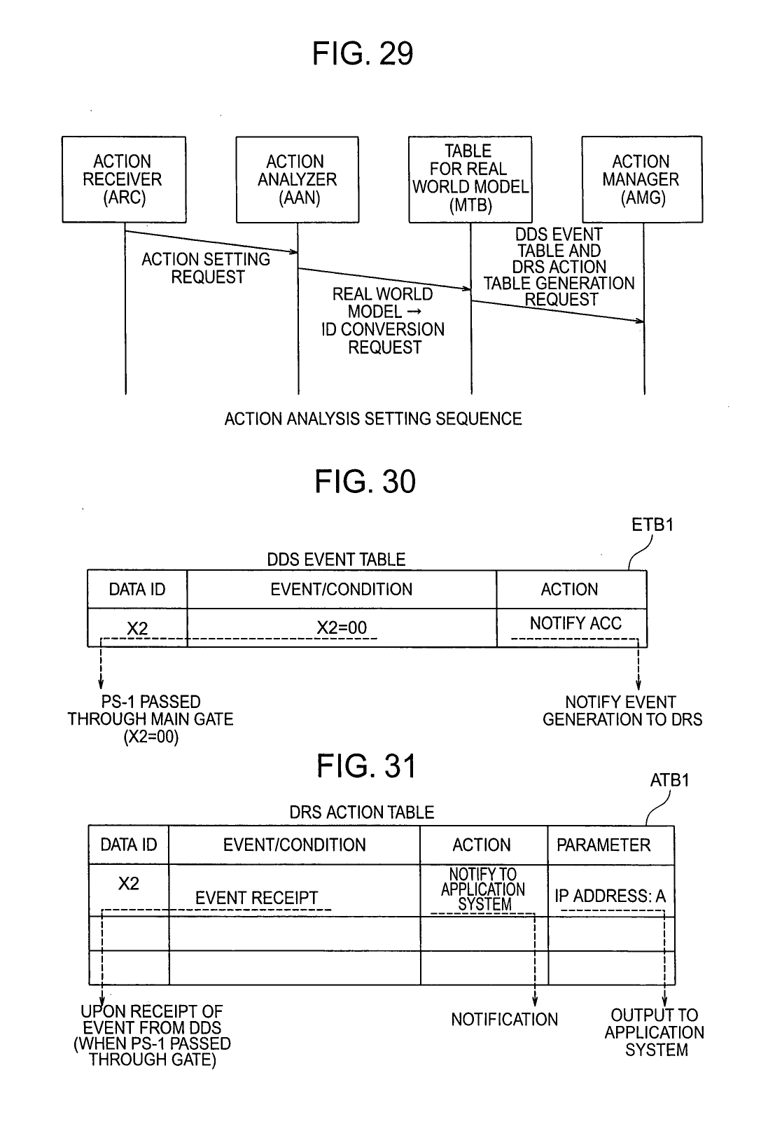

A procedure of action registration will be described with reference to a timing chart of FIG. 29. As shown herein, firstly, an application system manager connects the application system APS to the action controller ACC of directory server DRS and issues a request for setup of an action. The explanation below assumes that an example of the action is to monitor Mr. X's passing through a gate, such as entryway, and then transmit a notice to the application system APS.

Upon receipt of this action setup request, the action reception unit ARC of action controller ACC requires the action analyzer AAN to set this action. The action analyzer AAN selects a data ID of the object to be monitored and determines conditions of measurement data for permitting generation of the event. In other words, the phenomenon in the real world that is “Mr. X's passing through the gate” is established as a model which is judgeable by the sensing data being accumulated in the sensor network system.

Here, in the case of Mr. X=person PS-1, since the model has already been defined in the real world table MTB as shown in FIG. 24, an attempt is made to acquire from the real world model list MDL the data ID (e.g., “X2”) and an information storage destination (distributed data processing server DDS-1) in which the data is to be stored.

Next, in order to cause the distributed data processing server DDS to generate the event “Mr. X's passing through the gate,” the action manager AMG transmits over the air an instruction for generation of this event toward the distributed data processing server DDS which is expected to manage the above-noted selected sensor node. Then, the action manager AMG sets in the action table ATB an action that is “send a notice to application system” and sets the sensor node as the ID of an event for execution of this action.

Upon receipt of the instruction from the action manager AMG of directory server DRS, the distributed data processing server DDS sets, for the data ID=X2 obtained from the real world model list MDL, a condition “00” of gate pass-through and registers the action controller ACC of directory server DRS to a destination of the notice of the event to be executed as the action, as shown in FIG. 30.

A detailed explanation will be given using the example of FIG. 24. The directory server DRS causes the data processor server DDS-1 that manages the object OBJ-1 (position information of wireless sensor node MSN-1) to register the event table ETB shown in FIG. 30. Assuming here that the condition “00” is the ID of a base station containing this gate in its communication range, the value of the data ID (X2) corresponding to the object OBJ-1 (position information of wireless sensor node MSN-1) returns the value “00” when the person PS-1 passed through the gate. In this way, the phenomenon in the real world and the sensing information are correlated together and, when the condition of X2=00 is approved, the distributed data processing server DDS-1 notifies the event generation to the action controller ACC of directory server DRS.

The above-stated event generation condition is a mere example. Another example is that both the information of a people-sensitive sensor added to the gate and the position information of person PS-1 are for use as the event generation condition.

An action table ATM of the directory server DRS is shown in FIG. 31. This table includes a data ID column indicative of event IDs of objects under surveillance, in which the data ID=2 indicating “PS-1's gate pass-through” is set. In an event condition column, the receipt of the event generation from the distributed data processing server DDS-1 is set; in a column of actions to be executed by the directory server DRS, the notice to the application system APS is set. Further, in an action parameter column, an IP address indicative of the application system APS is set.

As shown in FIG. 31, the action to be registered by the action manager AMG to the action table ATB is to make setup for an application to execute an action of notifying the system with respect to an address recited in the parameter column under the event condition that an event with its data ID=X2 is received.

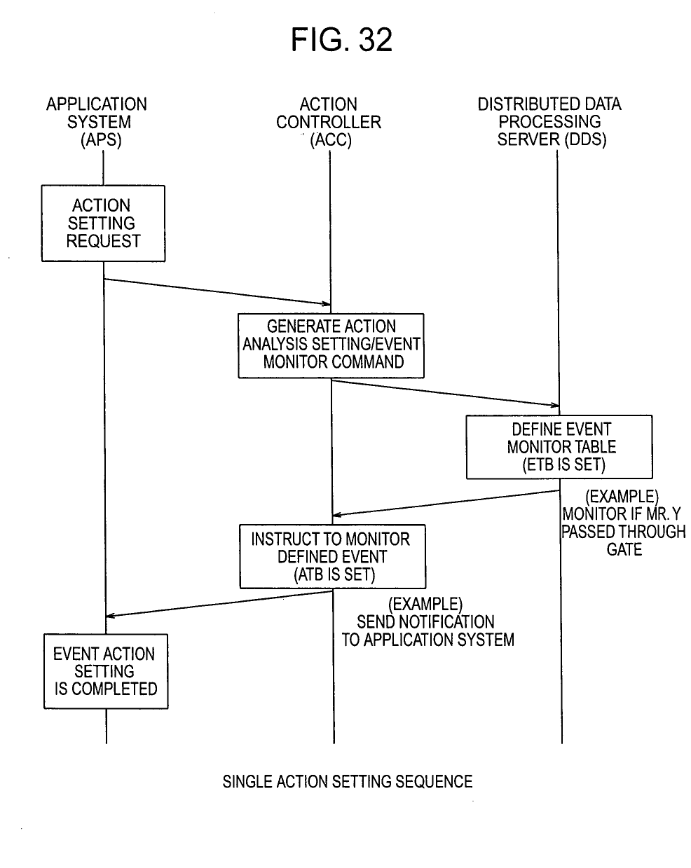

While taking as a single action the process of from generation of an event to taking an action as in the one stated above, the setup of the above-noted action becomes a flow shown in FIG. 32. More specifically, an action setup request is issued from the application system APS to the action controller ACC of directory server DRS whereby an instruction for action analysis and event surveillance is generated by the action controller ACC so that the event table ETB is defined at the action controller EAC of distributed data processing server DDS. Thereafter, the action manager AMG of action controller ACC instructs the event receiver unit ERC to surveil the event (data ID=X2) thus set up. With this procedure, the action controller ACC notifies the application system of the fact that the series of action settings have completed.

<Action Execution>

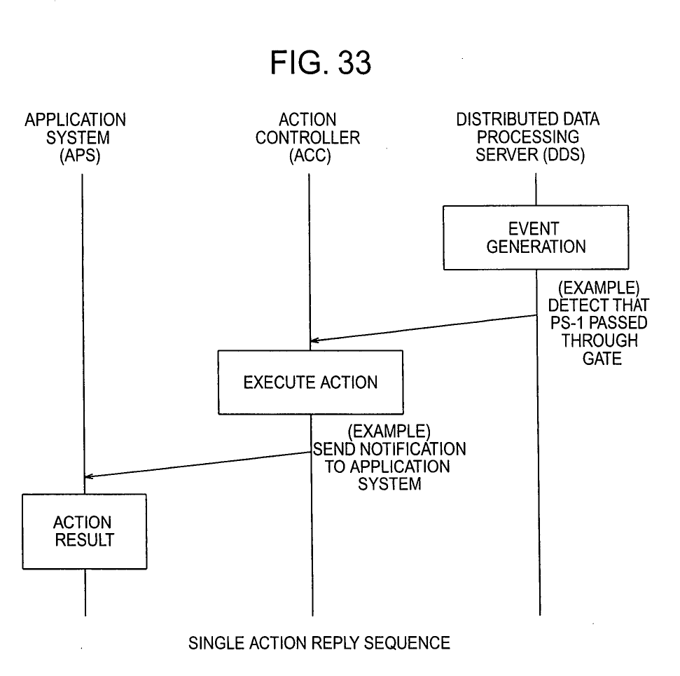

FIG. 33 is a time chart showing execution of an action thus set up.

When the measurement data of a sensor node under surveillance changes to “00” of the event generation condition whereby it is judged that Mr. X passed through the gate, the distributed data processing server DDS-1 generates an event notice concerning the data ID=X2.

This event occurrence is notified from the distributed data processing server DDS to the directory server DRS and is then received by the event receiver ERC of FIG. 28. The action manager AMG of directory server DRS uses the received event ID to search the action table ATM of FIG. 31 and determines whether a condition-satisfied action is present or absent. As the definition of the received ID=X2 event is found in the action table ATB, the action manager AMG notifies the action execution unit ACE of the action of action table ATB and its parameter(s).

The action execution unit ACE informs the application system APS that the person PS-1 passed through the gate and permits execution of the action. Then, the application system APS receives an action result.

Although the description above pertains to a specific example which takes a single action upon occurrence of one event, setup may be done to execute an action when all the generation conditions of more than two events are met together. Alternatively, setup may be done to perform a plurality of actions upon occurrence of one event.

The above-stated event-action control is executable by the directory server or, alternatively, by the distributed data processing server DDS—desirably, which one of them is used is defined depending on the contents of an event and action. An example is that if the event judgment is executable by the data being stored in one data processing server, it is desirable that the judgment be executed by this data processing server to thereby lessen the workloads of the directory server and communication channels. Another example is that in case data is distributed among a plurality of data processing servers, the task is executed by the directory server; alternatively, the event judgment may be allocated to a certain one data processor server.

<Locator Node-Sensor Node Distance Presumption>

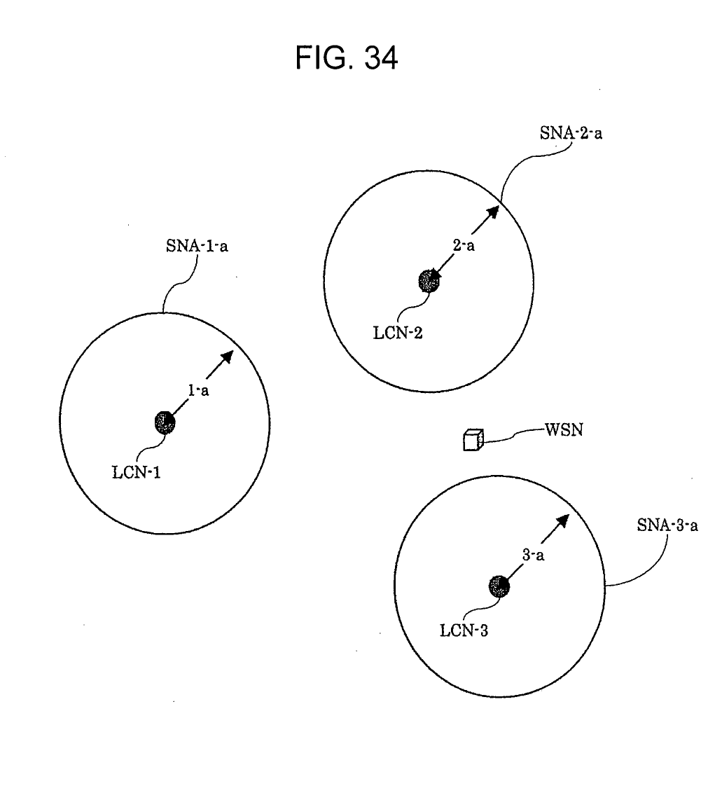

FIGS. 34 to 36 are diagrams for explanation of a method of setting detection regions SNA of locator nodes LCN. Referring first to FIG. 34, respective locator nodes LCN-1 to LCN-3 are laid out around a wireless sensor node WSN. Respective locator nodes and the sensor node are linkable over the air to any one of base stations belonging to the sensor network system SNS. The locator node LCN-1 has its circular detection region SNA-1-a with a radius 1-a; locator node LCN-2 has a detection region SNA-2-a with a radius 2-a; locator node LCN-3 has a detection region SNA-3-a with a radius 3-a. In the state of FIG. 34, the sensor node WSN is out of the detection region of any locator node so that it is detected by none of the locator nodes LCN-1 to LCN-3. However, if a communication channel with a base station is established, data is sent from the sensor node to the base station so that the sensor node is managed which is connected in each hierarchy level or layer of the base stations BST, distributed data processing servers DDS and directory server DRS of the sensor network system SNS; thus, the existence of node WSN is known. In the case of this circumstance, the radius of detection regions SNA is adjusted in order to specify the location of sensor node WSN.

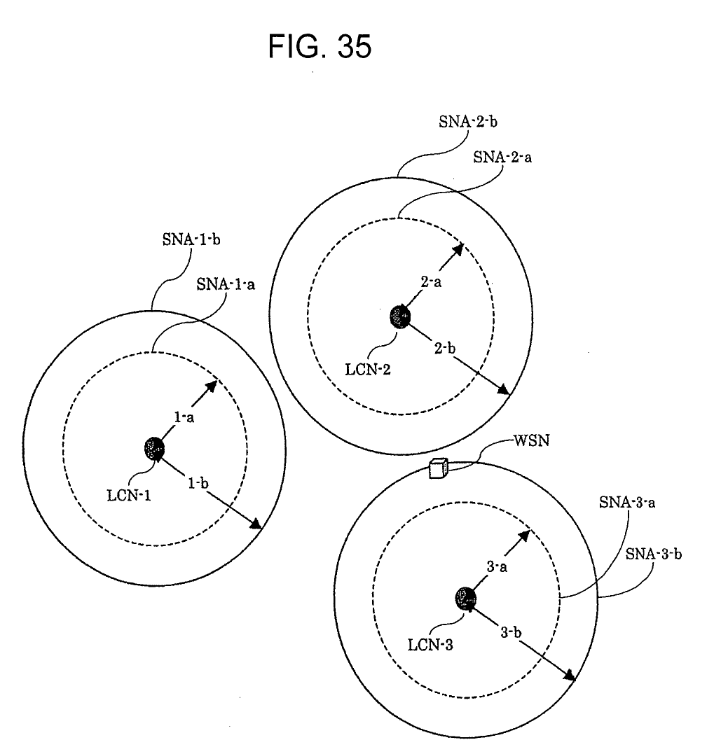

FIG. 35 shows that the detection regions of locator nodes LCN-1 to LCN-3 are expanded to SNA-1-b, SNA-2-b and SNA-3-b, respectively, by increasing the radius thereof. In cases where each locator node LCN-1, . . . , -3 fails to detect the sensor node even after a predefined non-detection judgment time has elapsed, expand the radius of each detection region by use of the processing functionality that is preset to the controller CNT. In the case of FIG. 35, execution of this processing results in the sensor node WSN entering the expanded detection region SNA-3-b of locator node LCN-3, thereby enabling this node to detect the sensor node WSN. At this time, the distance between sensor node WSN and locator node LCN-3 is presumable to be midway between 3-a and 3-b.

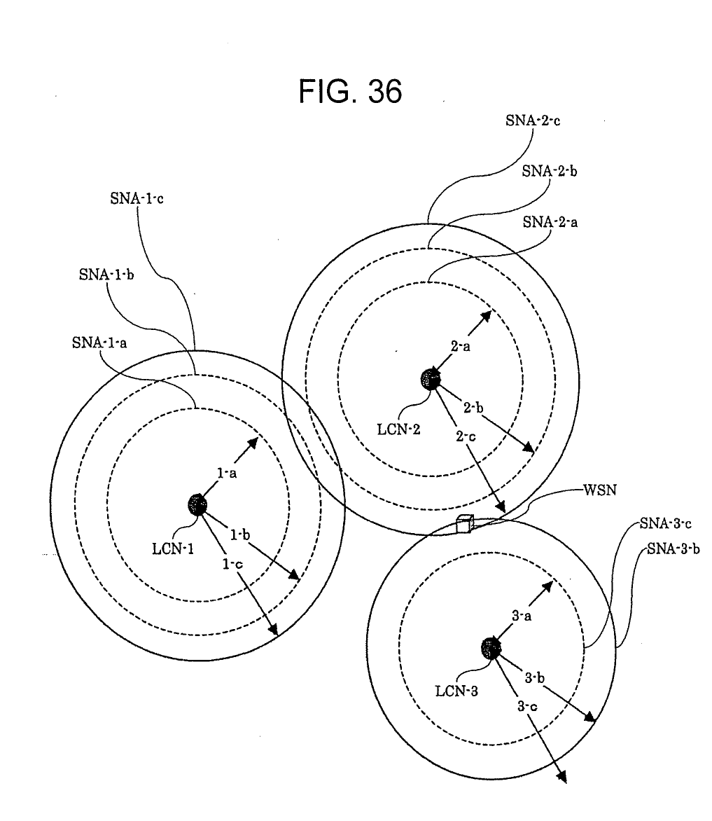

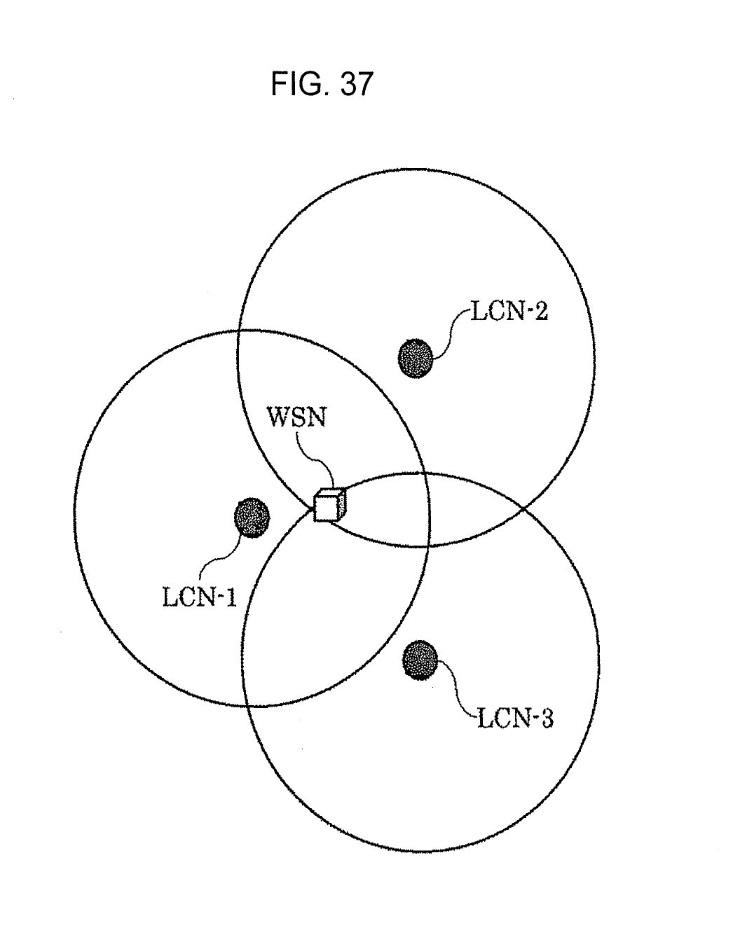

FIG. 36 shows that locator nodes LCN-1 to LCN-2 are further expanded in their detection regions, which nodes still fail to detect the sensor node WSN after elapse of the node non-detection judgement time as set therein even after having expanded the detection regions thereof at the timing of FIG. 35. In FIG. 36, the sensor node WSN enters the detection region SNA-2-c of locator node LCN-2 so that this locator node LCN-2 becomes able to detect the sensor node WSN. At this time the distance between sensor node WSN and locator node LCN-2 is presumable to fall within a range of from 2-b and 2-c.

Similarly, regarding the LCN-1 also, it is possible to expand its detection region so that it can detect the sensor node WSN. As a result, three or more locator nodes are able to detect a single sensor node WSN at a time so that it is possible by performing trilateration using the presumed distance values to calculate the coordinates of sensor node WSN.

In contrast to the above-stated detection region expanding method, it is also possible to shrink the detection region of each locator node until the lost of its sensor node detectability in cases where the individual locator node has frequently detected the same or a plurality of sensor nodes for more than a predefined number of times within a predetermined fixed time period. In this case, the radius value of a detection region that has last detected the sensor node(s) is fixed to a set value.

By continuous execution with time of the series of detection region adjustment processes in the observation field including multiple sensor nodes, it becomes possible to adjust the detection region of each locator node within the observation field in an automated way.

The above-stated adjustment of the detection regions SNA of locator nodes LCN per se is performed in such a way that the controller of each locator node controls the wireless processor unit. A trigger signal for startup of detection region adjustment is given in a way that the locator node receives via its associated base station BST a control command from the command controller of distributed data processing server DDS. Regarding judgment as to whether the adjustment of detection region radius, such as expanding or shrinking of detection regions, is necessary or not and the degree of such radius adjustment, this is done at the event action controller EAC, a judgment result of which is containable in the control command.

In the distributed data processing server DDS, specific condition is registered as an event, which condition is as follows: irrespective of the fact that the event action controller EAC makes sure that a sensor node is linked to a base station, no sensor-node detection signals are received from any one of the locator nodes belonging to the base station even after the elapse of a predefined length of time. An action also is registered, which issues a detection region adjustment startup command to the locator node(s) via the command controller CMC-D. This action is executed when the event occurs.

Upon completion of the detection region adjustment, the locator node notifies the directory server DRS of the resultant detection region radius set value via the base station and directory server DRS. This directory server DRS is responsive to receipt of the detection region radius data for storing as real world model information the detected sensor-node position in the real world model table MTB shown in FIG. 24 and for notifying the locator node of it via the distributed data processing server and base station in response to a request from the application system APS.

In the case of using a communication scheme which causes the command from the base station for each locator node to be sent to the locator node as a response to transmission from the locator node to base station, the command cannot be received in the absence of the transmission from the locator node to base station. As the locator node is usually waiting in the node monitor mode, the command is receivable only upon transmission of either a node detection signal or a node departure signal, except the case of an arrangement capable of operating in parallel in communication and monitor modes as shown in FIG. 9 or 10. In view of this, each locator node may be arranged to include a means for measuring the length of a time period in which it finds no sensor nodes, for sending a sensor node detection fail signal from the locator node to its associated base station in cases where no sensor node are detected within a predefined length of time period while receiving a command for instruction of detection region adjustment. Alternatively, it is also possible to immediately get started the detection region adjustment without questioning the host system.

A time measurement means may also be provided in the locator node, for setting the timing which performs the detection region adjustment at a prespecified time for synchronization to thereby change in unison the detection regions of locator nodes of interest. This makes it possible for every locator node to perform detection processing while having a new detection region when the sensor node performs communication. Thus it is possible to rapidly complete the adjustment required.

In case the sensor node of interest is a wireless sensor node WSN, this sensor node can move and migrate: even in such case, changing all the detection region radius values at a time makes it possible to permit every locator node to perform adjustment based on the same communication transmitted by the mobile sensor node, thereby enabling execution of more accurate detection region radius adjustment.

<When More Than Two Locator Nodes Detect Sensor Node>

As shown in FIG. 37, when two or more locator nodes (e.g., LCN-1 to LCN-3) detect a single wireless sensor node WSN, a need arises to determine either one of the locator node positions as a present position of the sensor node WSN. In case more precise position specifying is required rather than letting the position of a locator node be the sensor node position, a position which is midway between adjacent locator nodes is also determinable as the presumed node position by execution of weighted averaging relative to a radiowave strength RSSI or else; however, the methodology of selecting either one of the locator nodes involved will be disclosed here.

A first method is to provide a means for measuring the radiowave strength RSSI of a transmission signal of sensor node which is caught by each locator node and then select a locator node with the largest value thereof.

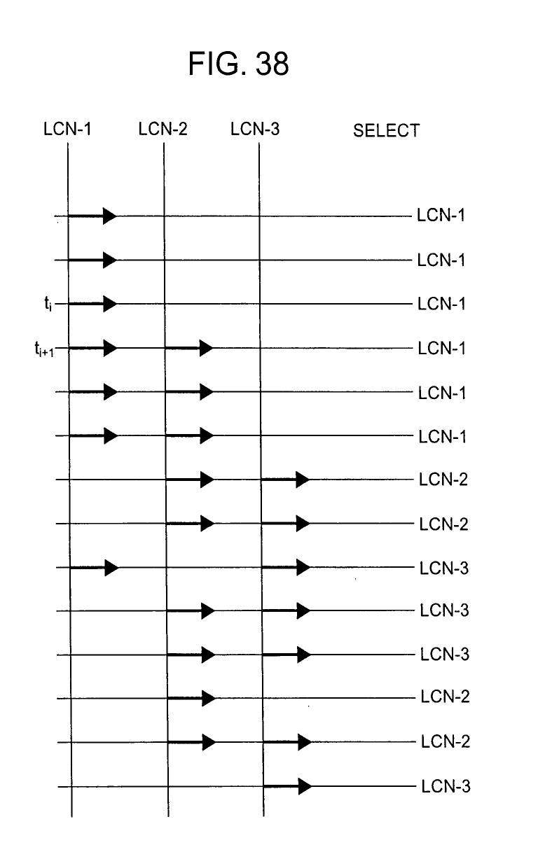

A second method is to determine it based on the sensor-node detection time continuity of each locator node. FIG. 38 shows an example in which each of the locator nodes LCN-1 to -3 detected the sensor node WSN at time intervals equivalent to the time slots of each communication of sensor node WSN. Arrows in FIG. 38 indicate the locator nodes detected the sensor node. As shown herein, when two or more locator nodes detected the same sensor node at a time, a specific locator node is selected from among them, which is the greatest in slot number of continuous detection in the past from a present time point. With this arrangement, it is possible to avoid the risk of influenceability in cases where the sensor node detection state changes suddenly due to the passing of a radiowave propagation-affectable object, such as a person. This judgment processing is executed at the event action controller EAC of distributed data processing server DDS. At this time, the sensor-node detection history of such locator node is stored as the measurement data/attribute in the database DB in disk device DSK of distributed data processing server DDS. The first and second methods stated supra may be combined together for practical use. The detection region of each locator node may be downsized to permit only one locator node to detect the sensor node(s).

<Operation Timing of Locator Node>

Locator nodes are typically designed to wait in the node monitor mode for catching communications of sensor nodes, except when communicating with base stations. Accordingly, their wireless processor units are usually rendered operative at all times, resulting an increase in power consumption. In view of this, it is difficult to operate for a long time while being powered by small-size battery modules. An approach to avoiding this difficulty is to use methodology for saving consumed power of the locator nodes, as will be described below.

A first method is to let the locator nodes normally stay in a sleep mode while permitting them to go into the node monitor mode in sync with the timing of a communication of sensor node. Depending on radiocommunication protocols used, adjustment is made to the timing for causing those nodes belonging to the same personal area network (PAN) to establish communications in a synchronized way. For example, in ZigBee™ radiocommunication standards, a device for adjusting the entire PAN, called the coordinators, is used to periodically transmit a beacon signal while causing the other nodes to perform communications only within time periods defined by the beacon signal. In the case of this communication scheme being used, it is permitted for locator nodes also to catch sensor node communications only within the beacon signal-defined time periods and sleep within the remaining time periods, thereby enabling reduction of power consumption.

A second method for saving the power consumption of locator nodes is to force these nodes to detect sensor node communications by an appropriate means and go into the node monitor mode with the detection result being as a trigger therefor. An example is that the actuator AAT of a sensor node per se is rendered operative immediately before a sensor node attempts to communicate to thereby force its associated speaker or infrared light emitter diode (IR-LED) or else to send forth an audio or optical information signal. This signal is sensed by a locator node detects by using its built-in detector.

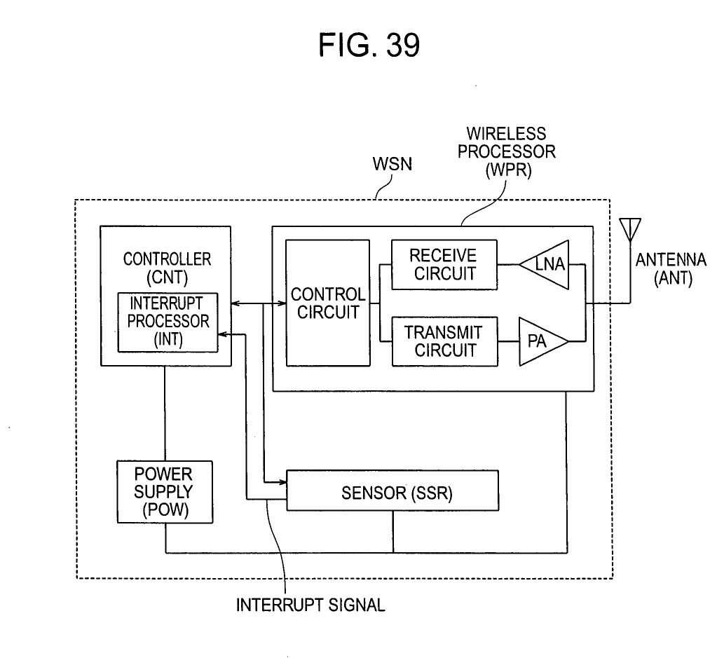

An exemplary configuration of a locator node employing this technique is shown in FIG. 39. This locator node is similar to that shown in FIG. 7 with a sensor SSR being added thereto. This sensor SSR is powered by a power supply POW and functions to generate and send an interruption signal to the controller CNT when a sensor performed the sensing of information with its quantity large enough to detect the sensing object, such as when a sound pressure-sensitive sensor—e.g., a microphone or the like—sensed audio sound with its level exceeding a predefined sound level or, alternatively, when an infrared light-sensitive sensor, e.g., a photodiode or else, sensed light with a predefined level of intensity. Upon receipt of the interruption signal, the controller CNT causes the locator node to go into the node monitor mode. In case the sensor is sufficiently less in power consumption or, alternatively, is capable of deactivating those functions other than the function needed for the locator node's mode shift in response to the interruption signal, it is possible to reduce the power consumption of sensor node. Examples of the sensor SSR include, but not limited to, a person-sensitive sensor or a microwave sensor for detecting the motion of a mobile body, a microphone for detecting supersonic waves or audible sounds as output from the speaker immediately before the communication of a sensor node, a photodiode or phototransistor which senses rays emitted from the infrared LED just before the node's communication. Although the specific example that is a modified version of that of FIG. 7 is discussed here, the sensor SSR may be added to any one of the configurations of FIGS. 8-10 in a similar way.

<Other Applications of Locator Node Functionality>

Although the description above is under an assumption that the functions of locator nodes stated supra are basically realized by use of dedicated hardware components, the locator node functions are realizable by standard sensor node configurations. Consequently, the locator nodes are arrangeable, for example, by stationary sensor nodes for use in observation fields, repeater equipment in wireless multi-hop networks and mesh networks, or wireless processing units in base stations. Mobile sensor nodes MSN are also usable as the locator nodes. Letting persons go around with such mobile sensor nodes makes it possible to specify the installation position of a stationary sensor node. In this case, the mobile sensor node is provided with a position specifying device, such as a global positioning system (GPS) tool or else, which measures a present position of the mobile sensor node when the stationary sensor node is detected and sends it to a base station together with ID information of the stationary sensor node for specifying the position of the stationary sensor node. Furthermore, by using the mobile sensor node to detect another mobile sensor node, it is utilizable as the presence information of a person.

<Sensor Network-Applied System>

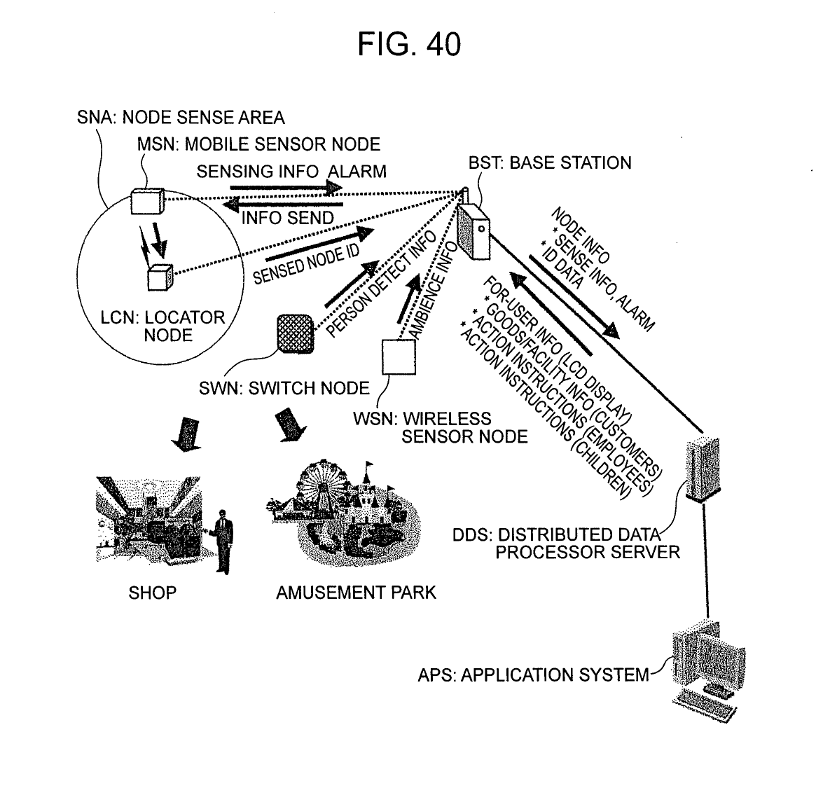

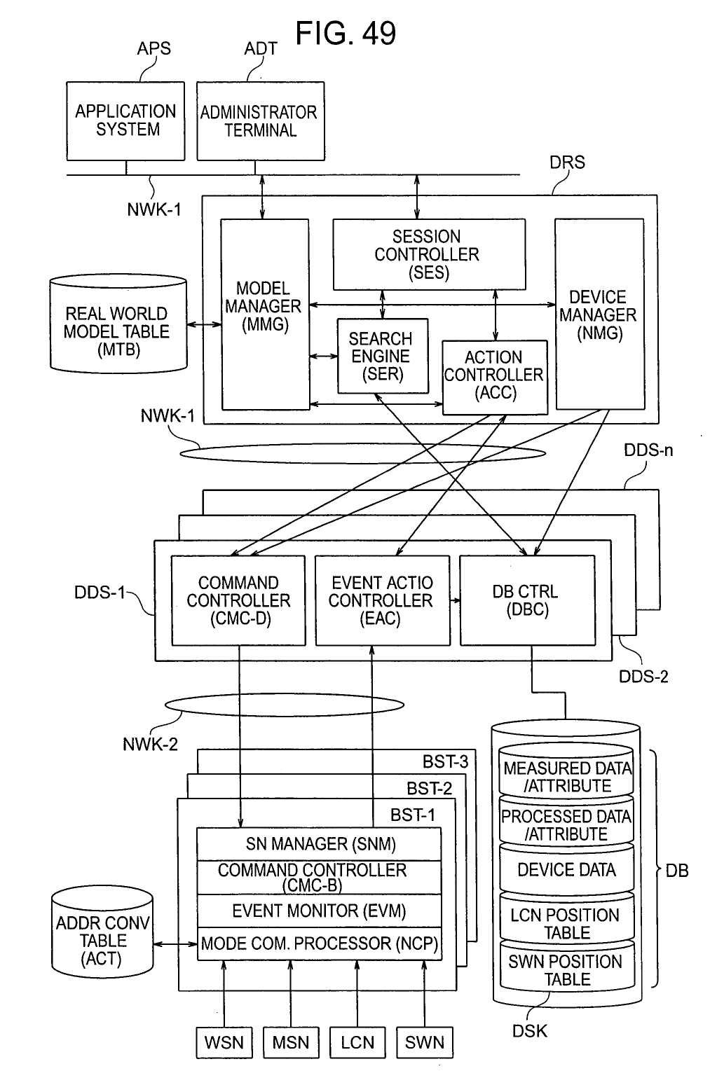

FIG. 40 depicts a sensor network-applied system using terminal position information. FIG. 49 is a diagram showing a configuration of the sensor network-applied system using terminal position information.

The applied system is for a chosen observation field, such as for example a retail store or shop in which salesclerks perform visitor-/customer-care services and an amusement facility including attractions. In these observation fields, mobile sensor nodes MSN are installed or attached to movable bodies, such as shop attendants and attraction visitors, while disposing locator nodes LCN at major locations within the observation fields. Further, wireless sensor nodes WSN with built-in temperature sensors and switch nodes SWN that are sensor nodes with built-in pressure-sensitive sensor switches are disposed in order to observe various states of the observation fields.

These nodes perform communications with more than one base station BST of the sensor network system SNS and are linkable to a software application system APS via distributed data processing server DDS shown in FIG. 40.

The mobile sensor node WSN uses its sensor to sense a moving object or its surrounding state. The node also uses its wireless processing unit to send alarm information or else based on manual operations toward the base station BST while receiving from the base station BST a control command(s) and various kinds of information generated by the application system APS to display them on a display device equipped with the node MSN, such as a liquid crystal display (LCD) display with speakers. The position of the node MSN is specified by more than one of the locator nodes LCN that are laid out at preselected locations.

The locator nodes LCN sends the ID information of the detected mobile sensor node MSN and its own ID information to the distributed data processing server DDS via the base station BST.

The wireless sensor node WSN transmits over the air its sensed environment information to the distributed data processing server DDS via the base station BST.

The switch node SWN detects by its sensor a present operation state of the switch, i.e., depressed or released, due to a person's activity—e.g., getting in or out—and then sends the switch state to the distributed data processing server DDS via the base stations BST.

The distributed data processing server DDS receives from the base stations BST various kinds of information, such as the sensing information, alarm, node ID, etc. It also generates, based on the internode relationship and/or sensing information, information necessary for the application system APS, such as position information, and then sends it to the application system APS.

The application system APS performs software application operations by using the information sent from other system equipments, such as the distributed data processing server DDS and other devices (not shown) linked to the application system to thereby generate user information—e.g., information concerning customer-oriented commodities, facility information, employee activity instruction information, behavior instruction information for children or else—and then sends it to the mobile sensor node MSN via the base stations BST.

<Sensor Network-Applied System for Retail Store>

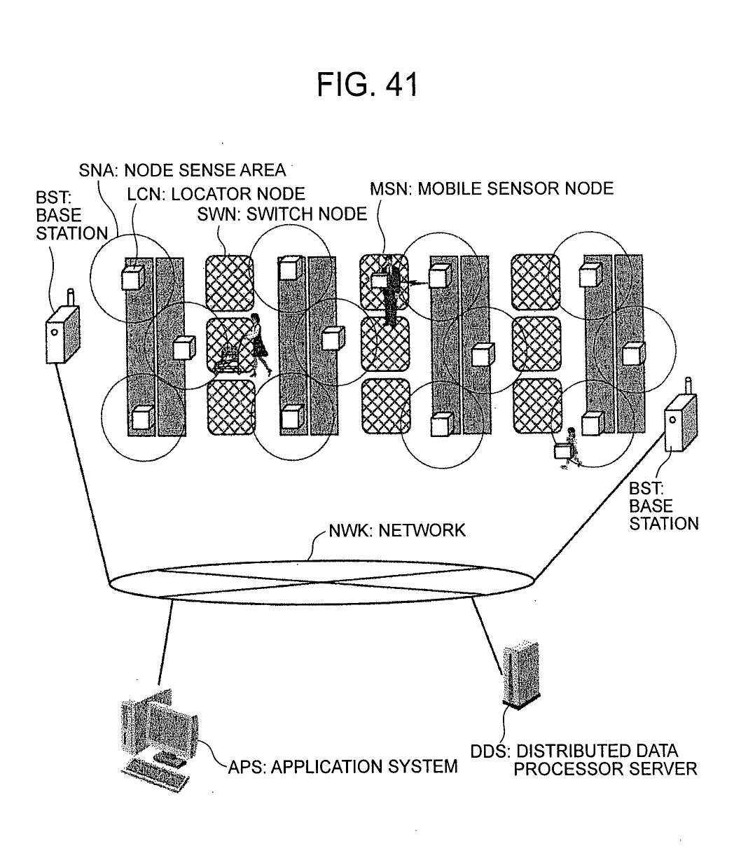

FIG. 41 shows one embodiment of a sensor network-applied system for an observation field, which is a retail store or shop where employees receive visitors. The observation field is a relatively large-scale store handling high-price merchandises and commercial articles requiring complicated manual operations, such as a department store, home-use electronic equipment mass-retailer, fashion store, furniture outlet, sports shop, etc.

In order to provide efficient visitor-care services in the store, a need is felt to figure out present positions of shopping visitors and salesclerks and to issue instructions to the salesclerks so that they are at appropriate positions. It is also necessary to provide these stuffs with information as to commercial articles attractive to visitors. Further, it is effective to grasp in advance the customer-care skills reflecting the stuff's experience and expertise concerning commercial items to thereby provide services while taking advantages thereof. The sensor network-applied system will be described below. In a store with merchandise showcases situated therein, a proper number of sales stuffs who severally have mobile sensor nodes MSN perform visitor-care services while walking around in the store if necessary. At preselected locations in the store, locator nodes LCN are laid out for specifying present positions of the mobile sensor nodes MSN. Also installed in the store are switch nodes SWN each having a pressure-sensitive switch that is rendered operative by application of the weight of a person. These nodes LCN and SWN are linked to more than one distributed data processing server DDS of sensor network system SNS via base stations BST by way of a network NWK. Also linked to this network NWK is an application system APS which executes an application software program needed to assist visitor-care services in the store. An administrator or manager is capable of disposing the locator nodes LCN in a way pursuant to the facility structure and the layout of showcases and others; thus, it is possible to increase sales and improve concierge services by display and concealment effects.

When a store stuff with his or her mobile sensor node MSN enters the node detection region SNA of a locator node LCN and then tries to communicate with the base station BST, the locator node LCN catches this communication. This node extracts ID information of MSN and then transmits it to the distributed data processing server DDS via base station BST together with its own ID information. Whereby, the distributed data processing server DDS, directory server DRS and application system APS gain the information that the mobile sensor node MSN is in close proximity to the locator node LCN.

The switch nodes SWN are each configured from a sensor node having a mat-type pressure-sensitive switch that is rendered operative by a person's stepping on and off. These switch nodes SWN are disposed near merchandise items at respective locations in the store, for transmitting an information signal when a shopping visitor steps thereon in the process of approaching a commercial good or when s/he steps off while leaving the good. The switch nodes SWN may be designed so that each is normally set in a sleep mode for power saving and is powered up for communication only when its switch is rendered operative. In such case, a timer is set to feed power at appropriate time intervals and transmit a heartbeat signal, thereby making it possible to periodically notify the fact that it is operating properly.

The mobile sensor nodes MSN are attached to store stuffs so that each periodically transmits its ID information or else at predetermined time intervals and receives control commands and display information if necessary. With these functions, working conditions including visitor-care capability/incapability, concierge service instructions and others are displayed on an LCD display of MSN. This enables the individual stuff to select through manual operation of an input button his or her working condition, such as visitor-care service handling capability/incapability, instruction ascertainment, work (visitor-care, transportation, item look-up, etc.) start/end or the like and then send it to the base station.

The base stations BST are arranged so that each receives communications from the sensor nodes and locator nodes and sends them to the distributed data processing server DDS of sensor network system SNS. It also receives a communication from distributed data processing server DDS and sends it to a corresponding one of the nodes involved. The base stations BST are such that an appropriate number of ones are installable in a selling space, which number is determined depending on radiocommunication environments, to enable communication with necessary nodes.

The distributed data processing server DDS generates, based on the information obtained from various sensor nodes and locator nodes, information required for the application system APS to perform business task adjustment and instruction and send it to application system APS. It also sends the business task adjustment and instruction generated by the application system toward more than one mobile sensor node MSN via base station(s) BST.

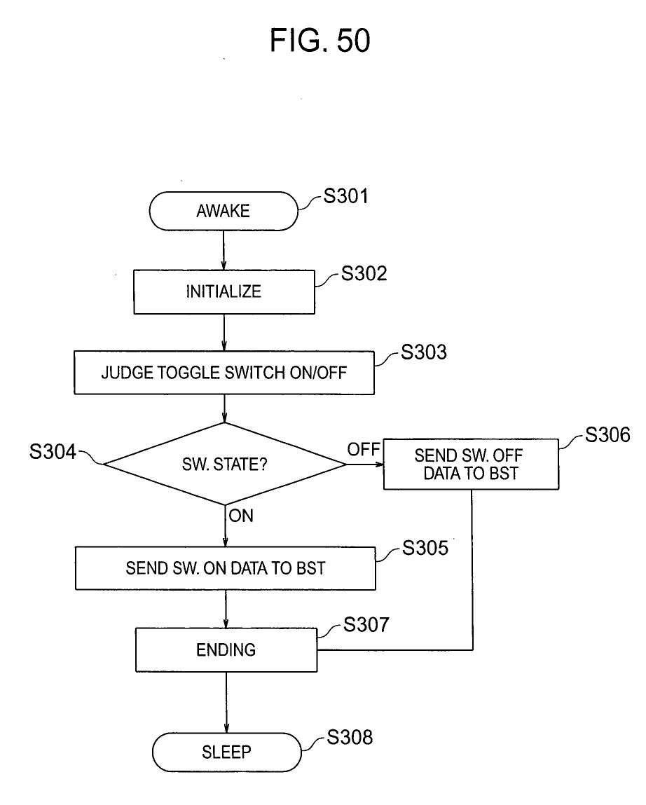

An operation example of a store service-assisting application using this sensor network-applied system will be described using FIGS. 50, 52, 54-55 and 60 below.

(1) When a shopping visitor comes to the store and stays at a location near a specific merchandise article for a prespecified length of time, a switch node SWN detects it and then transmits it as an event (at steps S305, S602-S604 in FIG. 50).

(2) A distributed data processing server DDS associated with the node measures a stay time of the visitor with the event being as a trigger (step S605).

(3) If the stay time exceeds a predefined time duration, then determine s/he must have an interest in the commercial item (S609, S610).

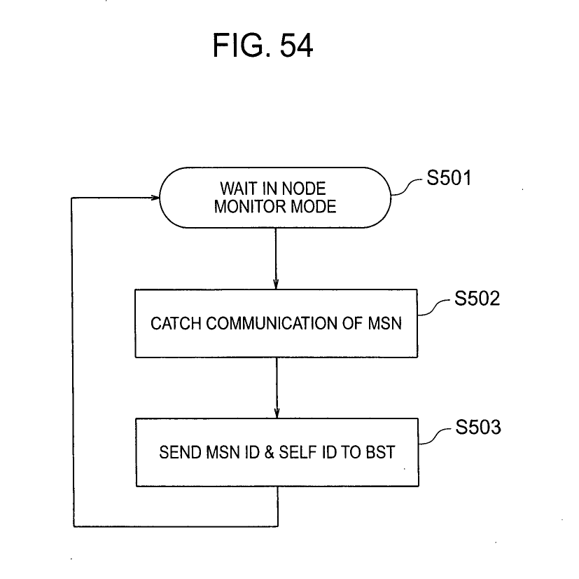

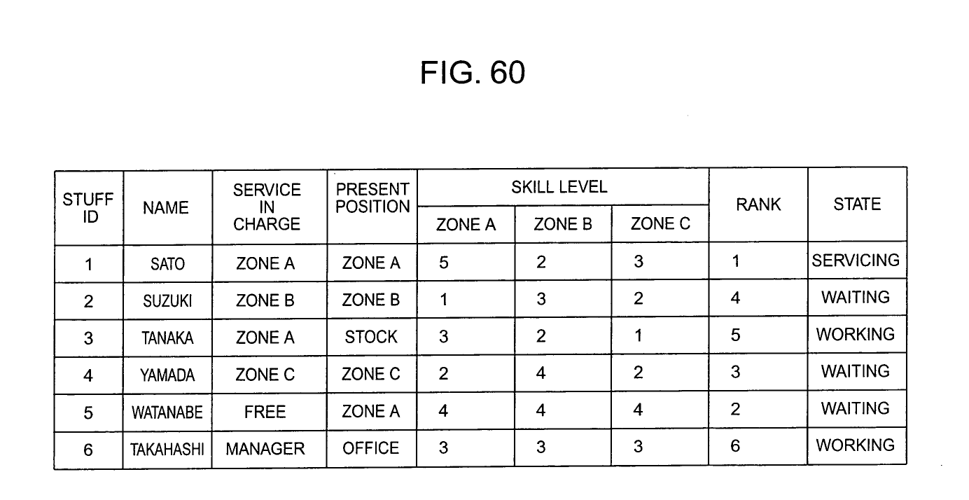

(4) An attempt is made to ascertain whether a store stuff in charge (with an ability to explain about the item and give recommendation for sale) is present around the visitor's location. To this end, necessary information is held as a list (FIG. 60) in the real world model table MTB of directory server DRS, examples of which information are stuff ID data, information such as skills for goods and business tasks in charge, the stuffs' present positions (judged at steps S501-S503 in FIG. 54), and present states or conditions.

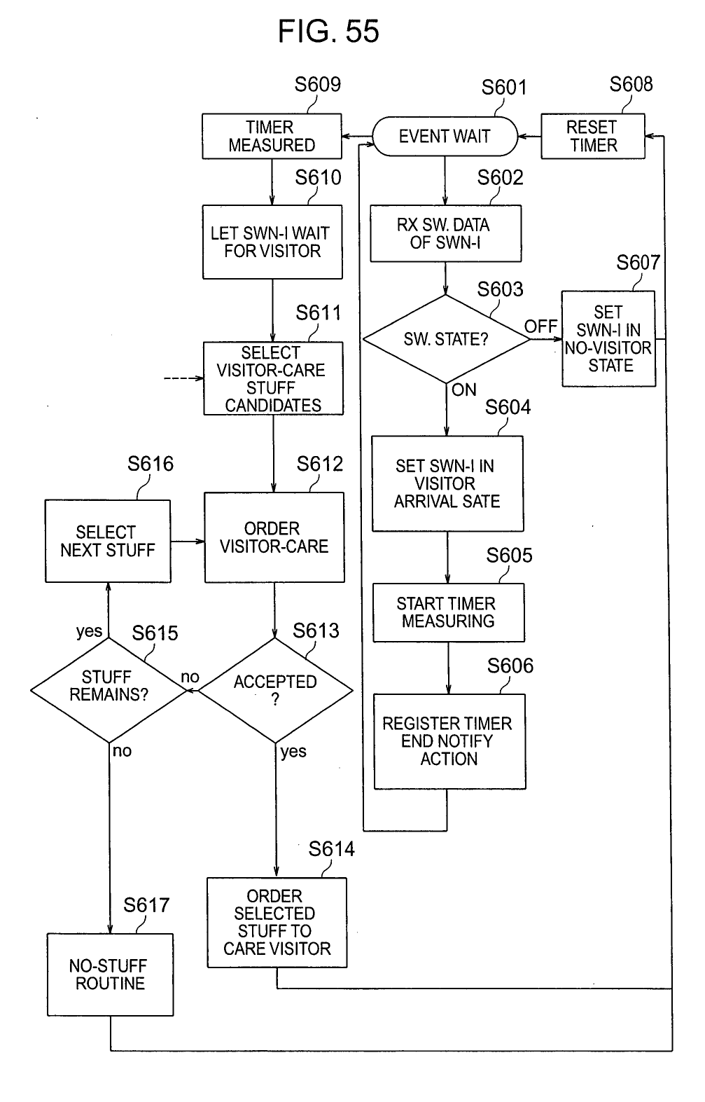

(5) A search is conducted to find a corresponding stuff (at step S611 in FIG. 55); then, instruct the stuff to talk to the visitor by using the communication functionality of the mobile sensor node MSN owned by this stuff (S612-S617). Below is a detailed procedure of searching by use of the list the store stuff who is expected to provide visitor-care services.

(5-1) A decision is made to verify whether this stuff is presently capable of providing the visitor-care services (concierge and working/waiting). An exemplary method of such judgement is as follows.

(5-1-1) Use the communication function of mobile sensor node MSN to make an inquiry about whether the stuff is able to do such job, followed by the stuff's responding.

(5-1-2) Check the state of a switch node installed near the stuff to thereby ascertain whether another visitor is present near the stuff.

(5-1-3) Use a means for operating a surveillance camera that monitors the inside of the store to face to a direction pointing the position of the mobile sensor node to thereby permit a surveillant to perform visual check or to presume the state of the stuff by use of image processing techniques.

(5-2) If the stuff is decided to afford to do the job, then send the visitor-care instruction information to his or her mobile sensor node MSN and display on its display panel. The stuff who ascertained this instruction uses MSN's button to respond thereto and starts the visitor-care service.

Note that the information for decision of (5-1) may include a work startup notice, such as visitor-care, conveyance, etc., and a work completion notice plus a standby start notice, which notices are sent by the store stuff through manual operation of the button of mobile sensor node MSN.

(5-3) If the stuff is decided to be incapable of doing the job instructed, then search and call up another affordable stuff in accordance with the ranking preferable for the visitor-care service, followed by repeated execution of the steps (5-1) and (5-2). At step S611 of FIG. 55, the called stuff may be set to a salesclerk nearest to the shopping visitor of interest; alternatively, call-up priority may be preset in a way which follows.

(Rank No. 1) A stuff who is in charge of the commercial item and who is presently nearest to the visitor

(Rank #2) A stuff in charge of the commercial item, who is at a far location

(Rank #3) A free stuff with knowledge about every item for sale

(Rank #4) A stuff in charge of other goods

(Rank #5) The manager

In cases where none of these stuffs can do the work instructed, perform processing for sending alarm information to a stuff(s) in a nearby shop, for example, and instructing to explain to the shopping visitor that s/he is requested to wait a moment. With the procedure above, it becomes possible to perform backup of visitor-care services.

In this way, the attribute information of node owners, such as store stuff's skill levels, business tasks in charge, etc., are recorded in advance while making correlation with node IDs. In the system embodying the invention, the position of a node is specified while at the same time correlating together the prerecorded attribute information and the node position. Thus it is possible to provide the node management information taking account of not only the position but also the attribute data, thereby making it possible to provide effective services to shopping visitors or customers.

The mobile sensor nodes MSN may be attached to shopping carts for catching visitors' positions and for performing information presentation for such visitors. Alternatively, the mobile sensor nodes MSN may be attached to children or aged persons who come to the store, for monitoring their behavior and performing safety action instructions.

A flowchart of an operation of a switch node SWN used in the store-oriented sensor network-applied system is shown in FIG. 50. The switch nodes SWN is normally set in the sleep mode but ready to leap into action in responding to turn-on or off of the switch of a mat-like pressure-sensitive switch sensor responsive to a person's stepping on and off. When the switch operates, the switch node's sleep mode is released (at step S301). The switch node performs initialization processing needed at the time of sleep break or “wake-up,” such as program loading (at S302); next, read the value of such switch sensor to determine its present state (S303, S304). When the switch turns on, transmit “ON” data to a base station as the switch sensor state (S305). When the switch turns off, send “OFF” to the base station as the switch sensor state (S306). Thereafter, perform termination processing needed for letting the node go into the sleep mode, such as sequential power-down of the power supply of respective modules making up the switch node in a predetermined order of sequence (S307), resulting in the node sleeping (S308). Note that the flowchart of FIG. 50 indicates the operation to be done after completion of connection processing with the base station, which is performed at resetting of the sensor node (switch node SWN is one type of sensor node) or upon first power-up thereof. The base-station linkup processing is separately executed as a routine process of the sensor network system SNS although a flowchart of such processing is omitted herein.

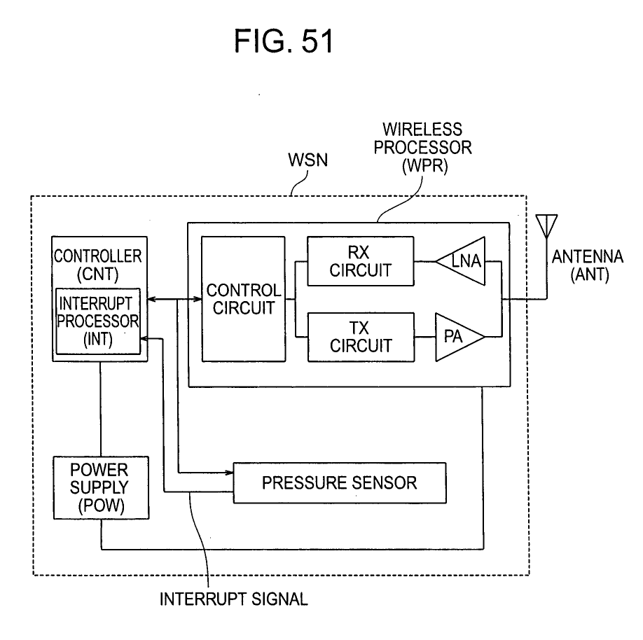

See FIG. 51, which shows a configuration of the switch nodes SWN for use in the store-use sensor network-applied system. A pressure-sensitive switch is connected as the sensor of the wireless sensor node WSN shown in FIG. 3. The node functions to transfer an interrupt signal to the controller CNT when the switch turns on and off. Upon receipt of this signal, the controller CNT breaks the sleep and acquires a present switch state (turn-on/off) and then transmits to the base station the switch state that was obtained by wakeup of wireless processor WPR.

The switch sensor nodes used in this embodiment may be any types of sensor nodes capable of detecting shopping visitors or customers who come closer to articles for sale.

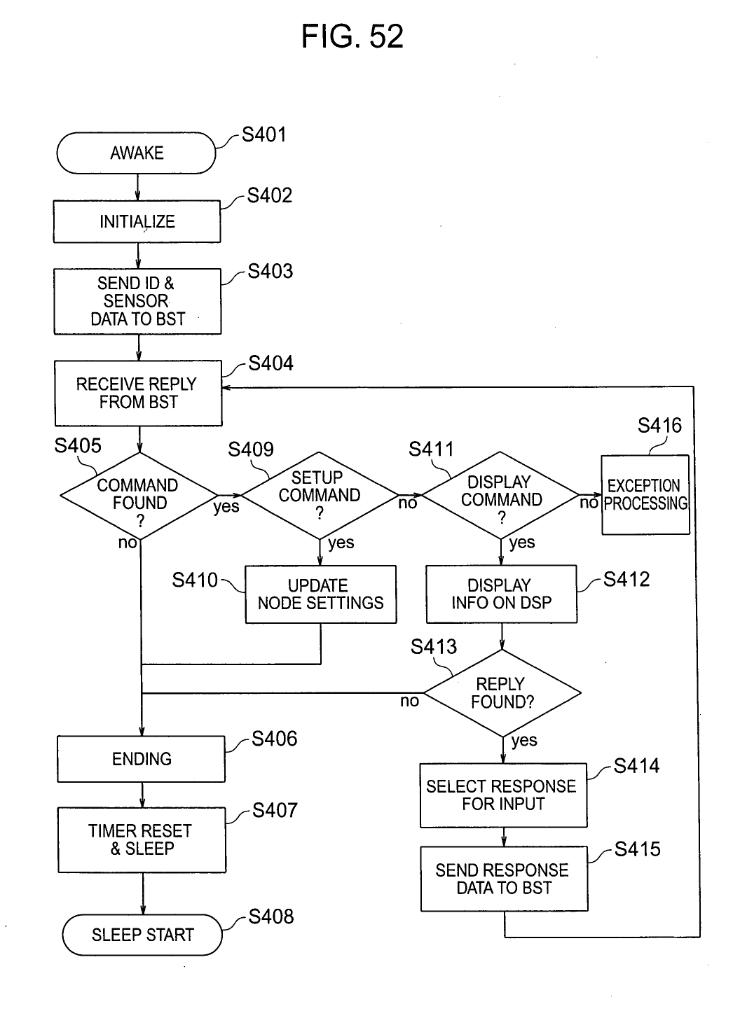

A flow diagram of major steps in an operation of mobile sensor node MSN for use in the store-use sensor network-applied system is shown in FIG. 52. This mobile sensor node MSN is typically arranged to make communications periodically and go into the sleep mode between completion of a communication and startup of the next communication for the power consumption saving purpose. In the initial state, the mobile sensor node exits from its sleep—namely, wakes up—at the timing of the next communication (at step S401). Upon wakeup of mobile sensor node MSN, the initialization processing necessary for startup is executed (at S402); then, transmit its own ID data and sensor data to a base station (S403). Thereafter, wait for arrival of a response from the base station for a fixed length of time (S404). In case the response received contains a command that is a processing request for the mobile sensor node MSN (S405) and when this command is a setup command for alteration of the operation of mobile sensor node MSN (S409), update the node's settings pursuant to parameters of the setup command (S410). If the received command is not the setup command but a display command (S411), then display at a display device, such as an LCD panel with speakers, either display data as sent together with the display command or display data being prestored in the mobile sensor node MSN and designated by the display command (S412). If the display command contains a response request (S413) then let a user his or her selected response through manual operation of an input device such as a button switch provided at mobile sensor node MSN (S414). The mobile sensor node MSN transmits the input response data to the base station (S415) and waits for the next response from the base station (S404). If the received command is none of the setup and display commands, ignore it or, alternatively, execute exception processing, such as sending abnormality detection information to the base station (S416). If no commands are included in the response from the base station (S405), execute the termination processing needed for sleeping the mobile sensor node MSN, such as power control or else (S406); thereafter, reset a sleep timer for execution of sleep processing (S407), followed by transition to a sleep start state (S408). Note that this process flow is also the one relating to the operation to be done after completion of the connection processing with the base station as in the flow shown in FIG. 50, so an explanation as to the linkup processing with the base station is eliminated herein.

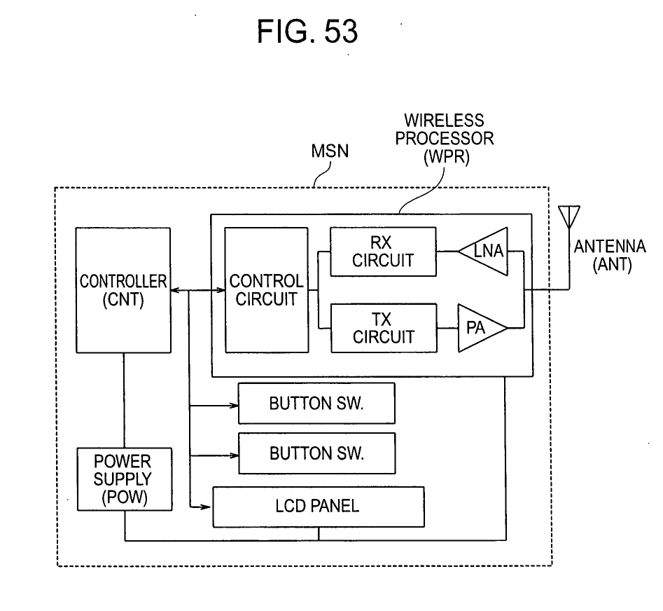

Turning to FIG. 53, there is shown an exemplary configuration of the mobile sensor node MSN for use in the store-use sensor net-applied system. This node is similar to the wireless sensor node WSN of FIG. 3 with the actuator AAT being replaced by an LCD display for displaying a string of characters understandable by shop stuffs. In addition, button switches are connected, for permitting a stuff to input his or her selected response through manual operation.

A flowchart of the operation of a locator node LCN used in the store-oriented sensor net-applied system is shown in FIG. 54. The locator node operation has already stated in conjunction with FIG. 21, so below is an explanation of the summary of only its node monitor mode (S110 to S117 in FIG. 21). While the locator node LCN waits in the node monitor mode (S501 equivalent to S110 in FIG. 21), when it receives a communication of mobile node (S502), the locator nodes LCN transmits ID data of such mobile node and its own ID data to a base station (S503) and then returns to the node monitor mode (S501). This flow is also the one relating to the operation to be performed after completion of the linkup processing with the base station as in that shown in FIG. 50, so an explanation concerning the linkup processing with the base station is omitted.

Referring next to FIG. 55, an operation flow is shown of a sensor network system SNS in the store-use sensor network-applied system, which corresponds to the operation example of the store-use sensor net-applied system stated supra. This flow shows major steps in the entire operation of the sensor network system SNS, which relate to execution of visitor/customer-care service supporting function in the store-use sensor net-applied system.

While no shoppers come, the sensor network system SNS is in an event wait state (at step S601). When a one SWN-i of the switch nodes SWN installed in the retail store is rendered operative in deference to the flow shown in FIG. 50, the distributed data processing server DDS associated therewith receives via base station BST switch state data and ID information of the switch node SWN-i (at S602). Then, the distributed data processing server's database controller refers to the node position table (see FIG. 49) which correlates together ID information and positions of database-recorded switch nodes to thereby specify the position of the switch node of interest. The distributed data processing server DDS's event action controller EAC specifies a present state of the switch (S603). When the switch is in the ON state, the distributed data processing server's model manager changes the state of SWN-i of real world model table MTB to a shopper arrival state as a real world model representing the state of a selling space to which the node SWN-i belongs (S604). The distributed data processing server's event action controller activates the timer for measuring a shopper's stay time so that measurement gets started (S605). After elapse of a predefined length of time, an action that notifies completion of the timer measurement is registered in the event action controller EAC of distributed data processing server DDS (S606), followed by returning to the event wait state (S601). If the switch state judgment result indicates OFF (S603), the state of SWN-i of the real world model table MTB is changed to a shopper absence state (S607); then, reset the timer for measuring a shopper's stay time (S608), followed by returning to the event wait state (S601). When the event action controller EAC of distributed data processing server DDS determines completion of the timer measurement (S609), let the state of SWN-i of real world model table MTB be changed to the shopper wait state (S610). The action controller of distributed data processing server chooses candidates of store stuffs in charge of visitor-care services in an order of suitability by using as decision criteria the real world model information, such as the present positions and states (working or on standby) of stuffs being registered and updated in the real world model table MTB, skills for merchandise articles, and their expected works in charge (S611). The criteria therefor and an action for selecting in the order of suitability are registered for later execution in the event action controller of distributed data processing server.

The individual store stuff's present position is specified by detection of his or her own mobile sensor node MSN using more than one locator node LCN installed within the store in accordance with the flow shown in FIG. 54. An example of the real world model list retaining stuff states or conditions is shown in FIG. 60. When issuing a request for concierge services for a visitor who comes to a selling space “A” for example, the request order or “priority” with respect to the selling space A is determined based on a present position being registered in the list and duty-work adaptability and also the skill level relative to commercial articles in the selling space A in compliance with each stuff's expected works and his or her present position plus skill level. In FIG. 60, settings are done in a way which follows: Mr. Sato is the highest in rank, who is expected to work at the selling space A and is presently at this space and whose skill level is five (5); Ms. Watanabe is ranked at the second, who is free from any particular affairs in charge and is also expected to work at the space A and whose skill level is four (4).

Then, at the command controller CMC-D of distributed data processing server DDS, a visitor-care service request command is issued. In accordance with the flow shown in FIG. 52, visitor-care service requesting is performed with respect to the mobile sensor node MSN owned by a selected stuff by use of the display function provided in MSN, and a reply indicating whether s/he is able to accept this request is received through the stuff's manual operation of an input device provided in the mobile sensor node MSN (S612). When the event action controller EAC receives a stuff's replay that is affirmative to the concierge service request (S613), this controller issues and send a visitor-care instruction to the selected stuff via the mobile sensor node MSN (S614) and then resets the timer (S608) and next returns to the event wait state (S601). The visitor-care instruction may be an instruction based on his or her present position which is given as “ten meters to the North” as an example or, alternatively, an instruction indicating a present location of the shopping visitor, such as “selling space A.” In case the event action controller receives from the stuff a reply negative against the request (S613), when there are other selected candidate stuffs at S611 (S615), the visitor-care requesting will be repeated either until the decision condition of S613 becomes “YES” or until the decision condition of S615 becomes “NO” (S612). Even when the concierge requesting is done to all the selected candidate stuffs, it sometimes happens that nobody can accept such request and there are no other visitor-serviceable stuff members (S615): if this is the case, execute visitor-serviceable stuff absence time processing, such as issuing an alert to a chief personnel responsible for the selling space or a store stuff around the shopper to thereby require explanations to this shopper (S617); then, reset the timer (S608), followed by returning to the event wait state (S601).

In the example of FIG. 60, the shopper-care service requesting is done first to Mr. Sato who is No. 1 in rank; unfortunately, he is in the process of taking care of a customer and thus returns a negative response saying that it is impossible to provide services to another visitor. Then, the request is passed to Ms. Watanabe who is No. 2 in rank. She is now on standby, so returns an affirmative reply so that the visitor-care service gets started.

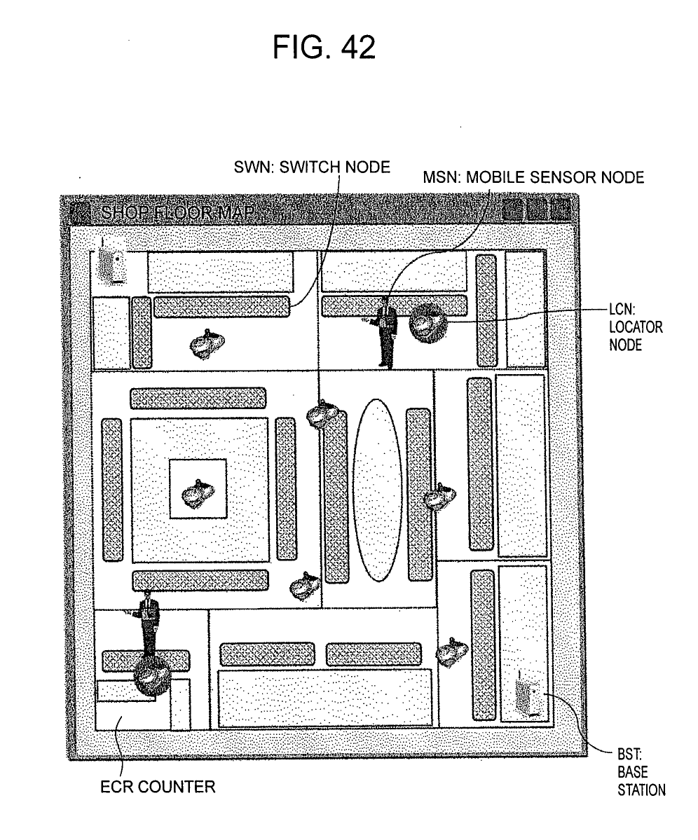

Display screen examples of this shopper-care assistance application are shown in FIGS. 42 to 46, which are for the store manager.

FIG. 42 shows a state that there are no shopping visitors within the store. The position of a mobile sensor node MSN is displayed as a person-like icon at its corresponding position in a store floor map. Other icons are displayed, which indicate locations of locator nodes LCN, switch nodes SWN and base stations BST. More than one locator node icon is displayed with visual emphasis applied thereto while the mobile sensor node MSN resides within its detection region. This on-screen display image indicates two store stuff members are waiting at lower left and upper right locations at present.

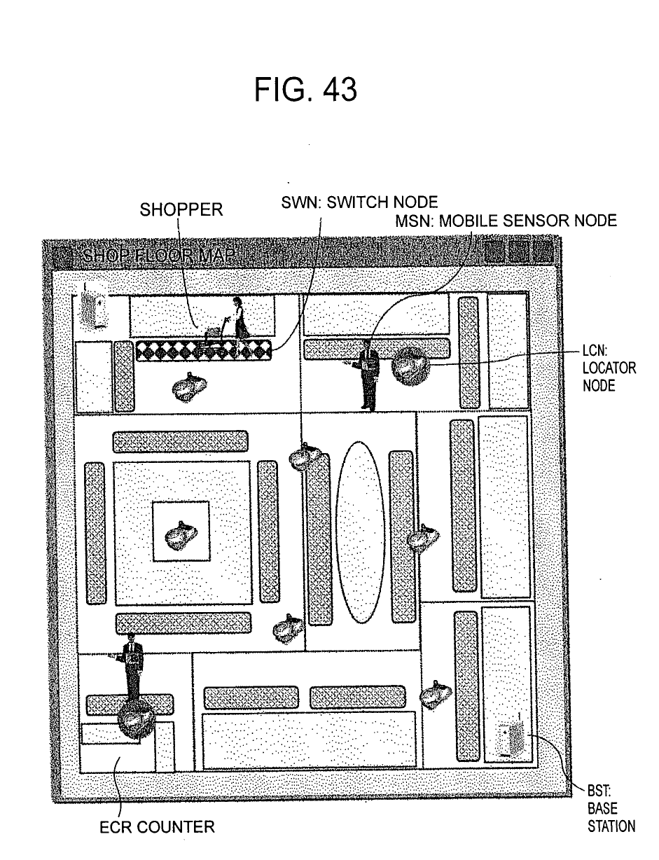

FIG. 43 shows an example wherein a shopping visitor comes to the store and stays in front of an upper left showcase. This is sensed by a switch node SWN, which generates a detection signal, in response to which an icon indicative of the visitor is displayed on the screen at the position of such switch node. At this time, the display of the icon of this switch node is changed to indicate that a person is detected (the process step as set forth in the paragraph (1)).

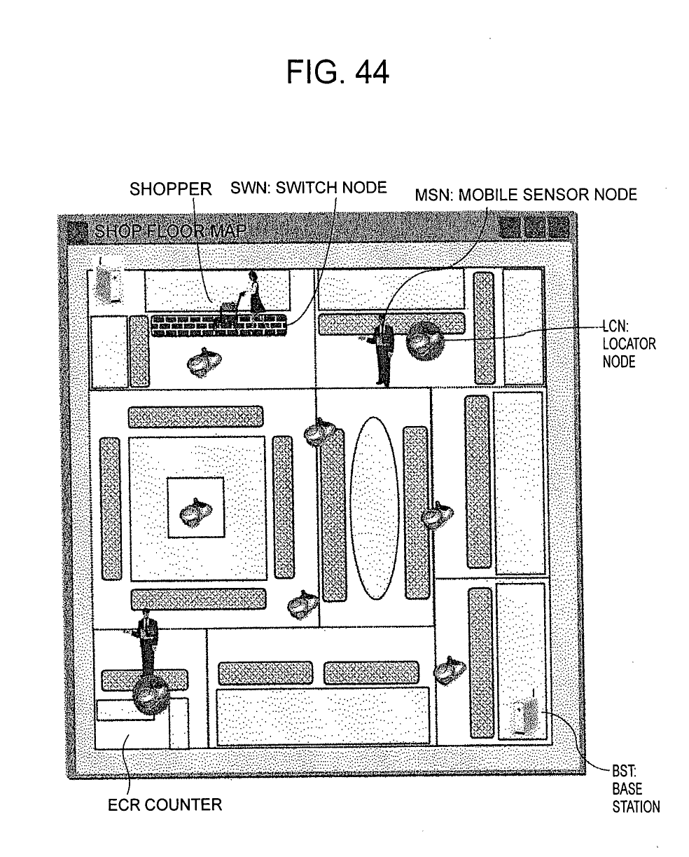

In the example of FIG. 44, the shopping visitor's stay time exceeds a preset length of time, and this is indicated by changing the display style of the icon of switch node SWN (refer to the paragraph (3)).

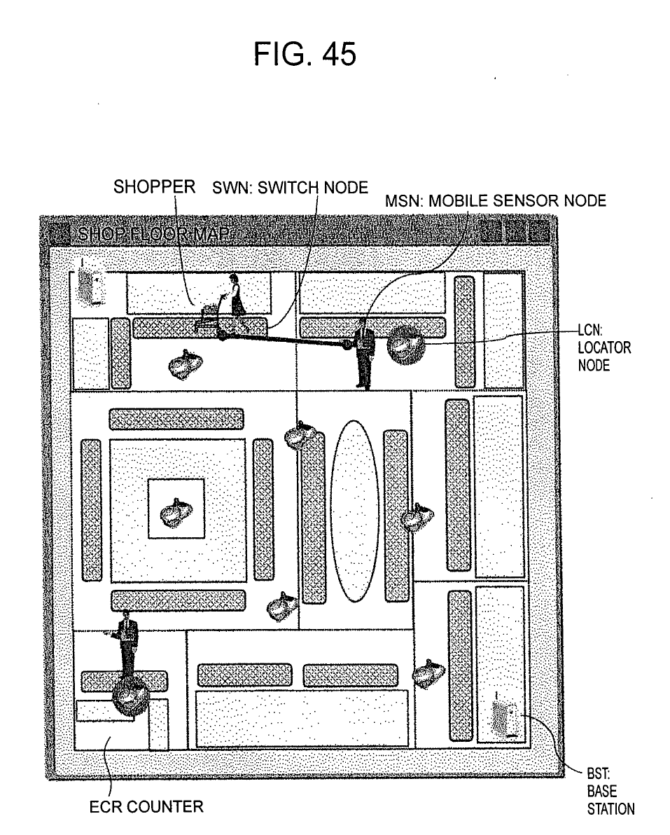

In FIG. 45, it is indicated by tying together using a line segment the icons of the visitor and a nearby stuff that the stuff is assigned to care servicing of the visitor as a result of the above-stated application operation (the above paragraph (5-2)).

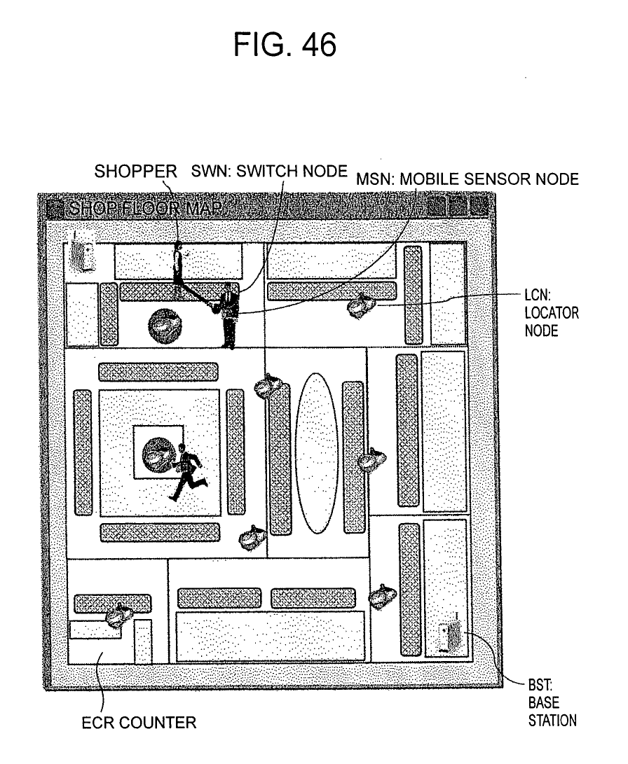

FIG. 46 shows an on-screen display image representing that the stuff assigned in FIG. 45 moves to the visitor and begins talking to this person. At this time, the locator node which specified this stuff is altered so that an upper left icon of locator is displayed with visual effects applied thereto. The fact that the stuff's state was changed from waiting to servicing is displayed by modifying the shape of the icon corresponding to the stuff. Regarding the fact that the shopper's state was changed to the state of being serviced, this is displayed by changing the shape of its corresponding icon. Simultaneously indicated in the display image is a condition that another stuff was moved to still another locator node's position. The fact that this stuff was changed from waiting to working is displayed by varying the shape of an icon corresponding thereto. In this way, a present situation of the store floor is displayed by using appropriate icons in conformity to the information such as the positions and states of more than two sensor nodes simultaneously, thereby enabling the store manager to precisely grasp the circumstances of stuffs and shoppers on a real-time basis.

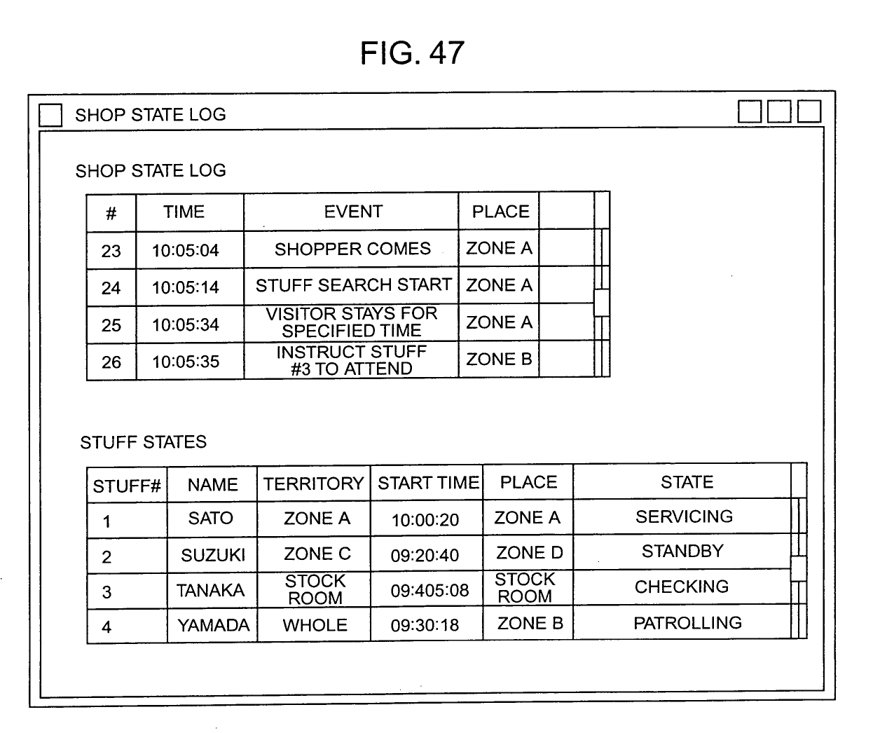

FIG. 47 is an example which displays in a list form the contents of events when the retail store changes in state along with information as to exactly when and where each event occurred. This list displayed also contains personal information, such as the names of store stuff members, affairs in change, etc., their present positions, states or conditions, and time data thereof. These information items are updated whenever an event occurs on a real-time basis. Looking this list permits the store manager to comprehend in detail a present condition of the shop and present states of the stuffs on a real-time basis.

<Sensor Network-Applied System for Attraction Facility>

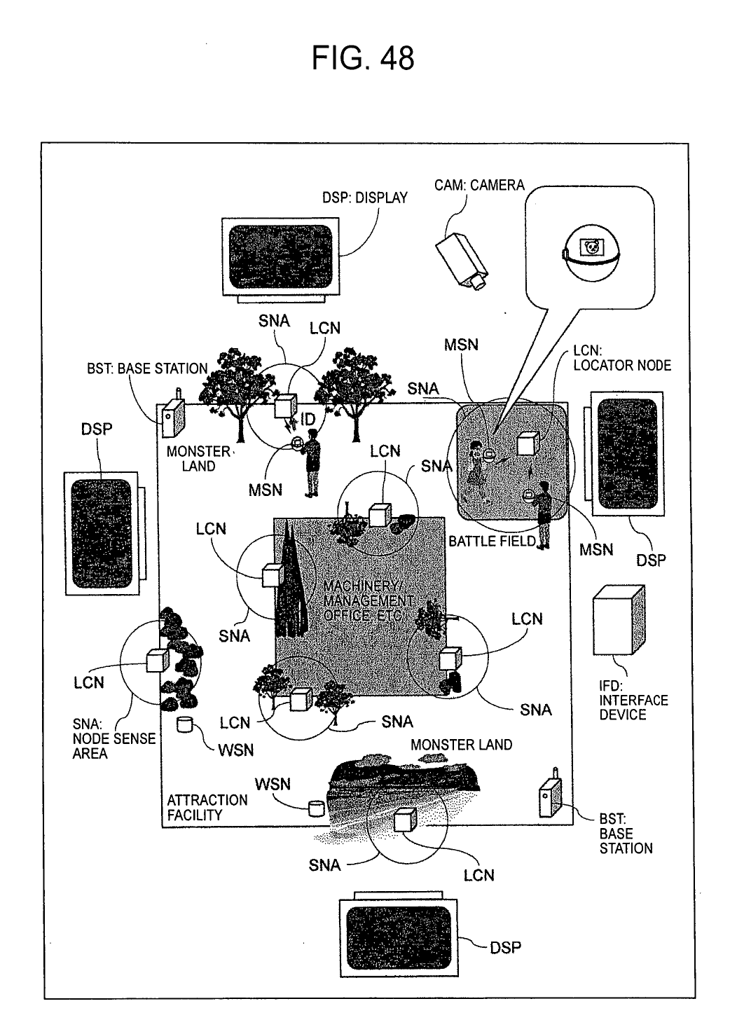

FIG. 48 depicts an overview of one embodiment of a sensor network-applied system installed in an observation field, e.g., an attraction facility providing playgames to children and others. In this embodiment, the attractions are supposed to be various kinds of roll-playing games which are provided at respective locations in the facility, such as a large-scale indoor amusement place, for allowing visitors or guests to enjoy by giving access thereto. Even within this type of facility, an administrator or manager is permitted to freely disposed locator nodes in tune with the facility's architectural structure and the layout of play zones. Thus it is possible to increase ticket sales and improve visitor-care serviceability by display and concealment effects.

In the observation field, visitors have mobile sensor nodes MSN and walks around or “migrate” within the facility freely or in a way that they are guided to act in obedience to an attraction scenario(s). At preselected locations in the observation field, locator nodes LCN are installed for specifying present positions of the mobile sensor nodes MSN. Each locator node has its node detection region, also known as the node sense area, which is adjustable in tune with the objectives attractions and topographic shapes. Also installed at chosen locations in the observation field are wireless sensor nodes WSN each having a sensor for detecting various states, such as temperature, humidity, brightness, etc. Further, base stations BST are situated which communicate, when necessary, with the mobile sensor nodes MSN, wireless sensor nodes WSN and locator nodes LCN. The base stations BST are linked via wired/wireless networks to the sensor network system SNS installed in a machinery house, although the system is not visible in FIG. 48.

Further installed are large-screen display units DSP for displaying attraction contents to visitors, an interface device IFD for performing interactive attractions with visitors, and surveillance cameras CAM which observe circumstances within the facility.

The wireless sensor nodes WSN owned by visitors are such that each communicates with its nearest one of the base stations BST at prespecified time intervals to transmit thereto ID information, sensing information and button-push information and receives from the base station BST display information, which is displayed on its built-in display device, such as an LCD display with a speaker(s).

When a mobile sensor node MSN enters into a locator nodes LCN's node detection region and then perform communication, the locator node detects this and transmits ID information of such mobile sensor node MSN and its own ID information to the sensor network system SNS via more than one base station BST. Regarding the wireless sensor nodes WSN, each observes physical quantities, such as temperature, humidity, brightness, etc., by using its built-in temperature sensor, humidity sensor, illuminance sensor, etc., and transmits over the air observation data to the sensor network system SNS via its linkable one of the base stations BST.

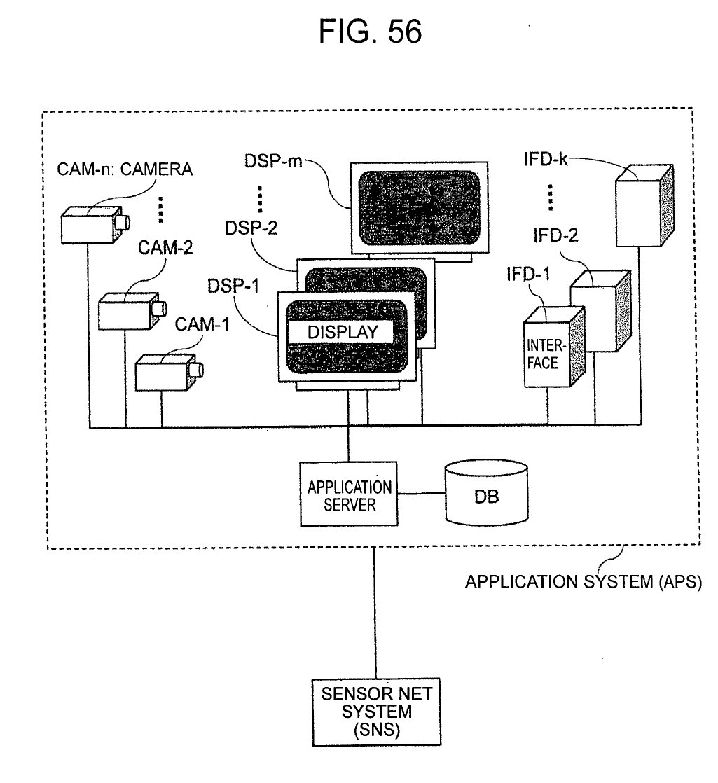

FIG. 56 shows an exemplary configuration of an application system APS of the attraction-oriented sensor network-applied system. The application system APS is generally made up of an application server which executes application software of the attractions while providing collaborative operation control by means of connection with the sensor network system SNS and input/output device control, a database BD storing therein history information or the like necessary for execution of the applications, cameras CAM-1, 2, . . . , m for obtaining scene images of the attraction facility, display units DSP-1, 2, . . . , m for presenting video images to visitors, display devices for displaying texts and images, an audio output device(s) for producing voices and sound effects, and an information selection/input device, such as a keyboard, buttons, touch panel, microphone, etc. The application system APS also includes interface devices IFD-1, 2, . . . , k for permitting facility visitors to execute interactive attractions.

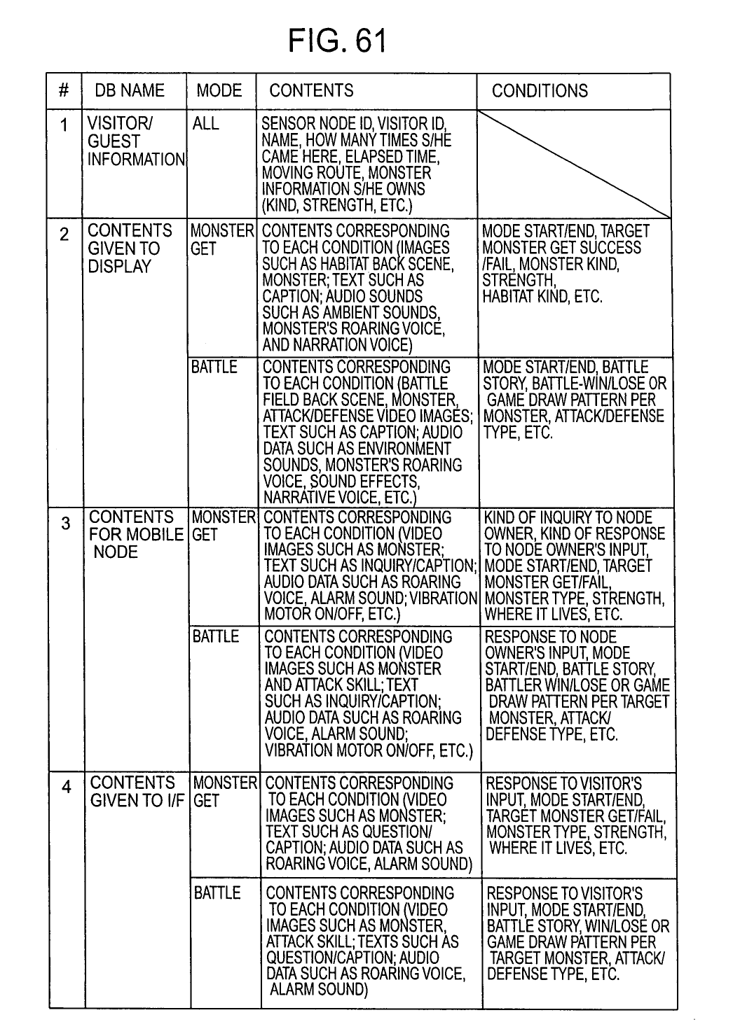

FIG. 61 shows examples of visitor information and presentation contents to be recorded in the database DB. As shown herein, the individual visitor's ID, name, visit number, elapsed time since facility entry, monster information the visitor has and others in a manner that these are correlated together. In addition, display DSP presentation contents, mobile sensor node MSN presentation contents, and interface device IFD presentation contents are prerecorded therein. For use as respective contents, those contents data corresponding to all available prespecified conditions in monster-get and battle modes are stored, from which a set of contents is selected and determined as a presentation object by conditional judgment based on the visitor's position(s) and input information or the like. An example of the stored contents data corresponding to the prespecified conditions in the monster-get mode as an example is an ensemble of video images and audio sounds plus texts at mode start-up and completion along with videos and audio sounds plus texts in success or failure of monster-get, as shown in FIG. 61. Additionally, the visitor IDs are recorded while being corresponded to IDs of the mobile sensor nodes the visitors hold so that the contents to be provided to each mobile sensor node are selectable and determinable by taking into consideration the visitor information also, i.e., the information added to the nodes.

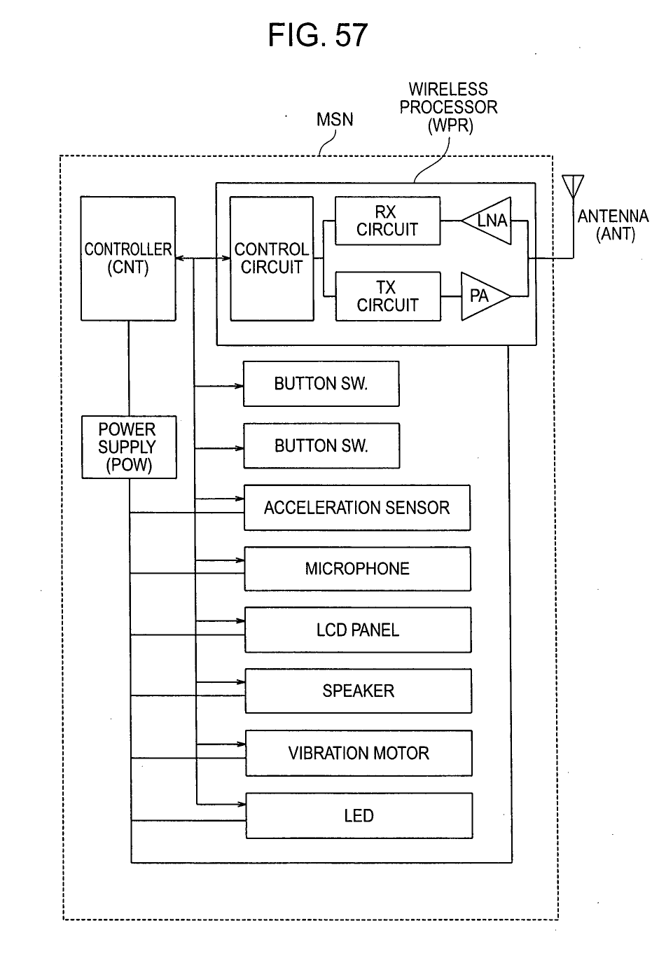

FIG. 57 shows an exemplary configuration of the mobile sensor node MSN for use in the sensor network-applied system for attraction facility. As shown, this node includes an acceleration sensor which is provided as the sensor SSR shown in FIG. 3 for sensing motions of MSN, a button switch which permits a user to perform selection and data entry, and a microphone which catches the user's voice and environmental sounds. The node also includes, as the actuator AAT, an LCD display unit for displaying user-recognizable texts, symbols and images, a speaker module for output of voices and sounds, a vibration motor, and an LED.

An explanation will be given of an attraction execution example below.

<Monster-Get Scenario>

(1) Play zones each named the “monster land” with the setting of a virtual situation that monsters live there are provided at selected locations in the observation field, in which locator nodes LCN and displays DSP are installed (see FIG. 48).

(2) In case a visitor approaches, when his or her own mobile sensor node MSN entered in the node detection region SNA of a locator node LCN and then performed communication with a base station, the locator node LCN detects this communication and wirelessly transmits ID information of the node MSN (FIG. 54).

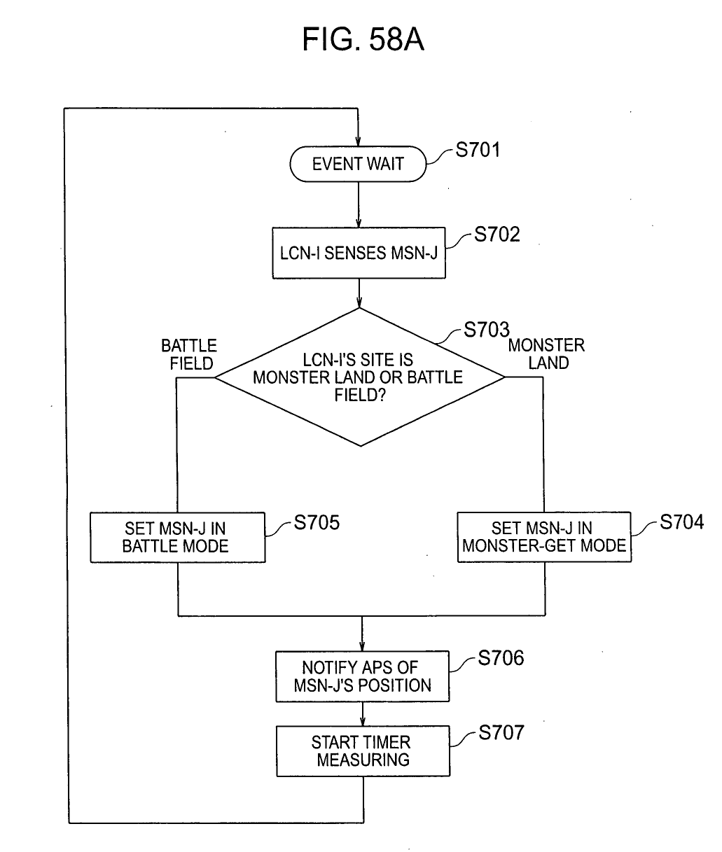

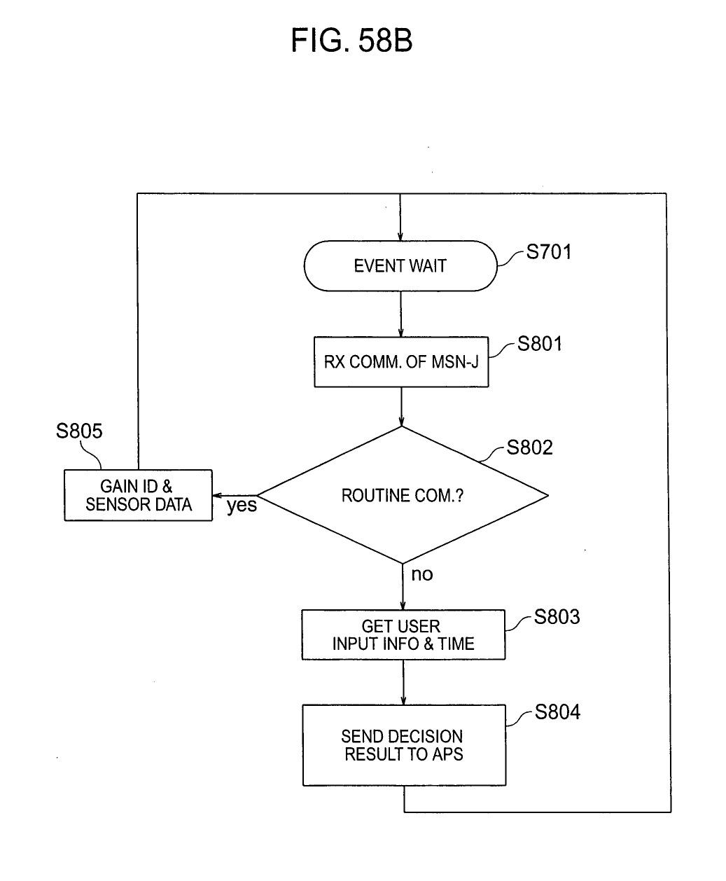

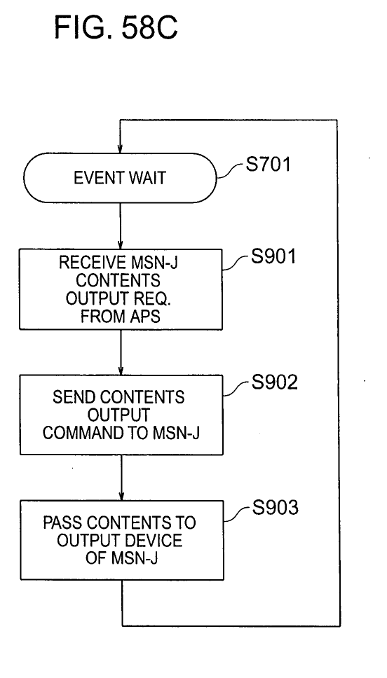

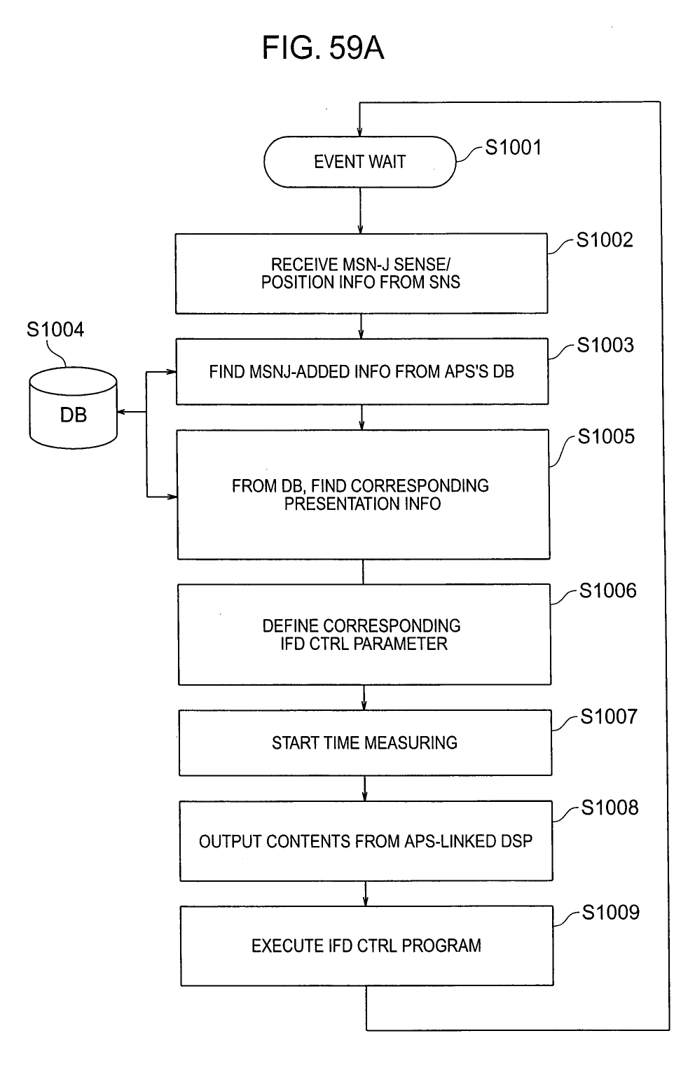

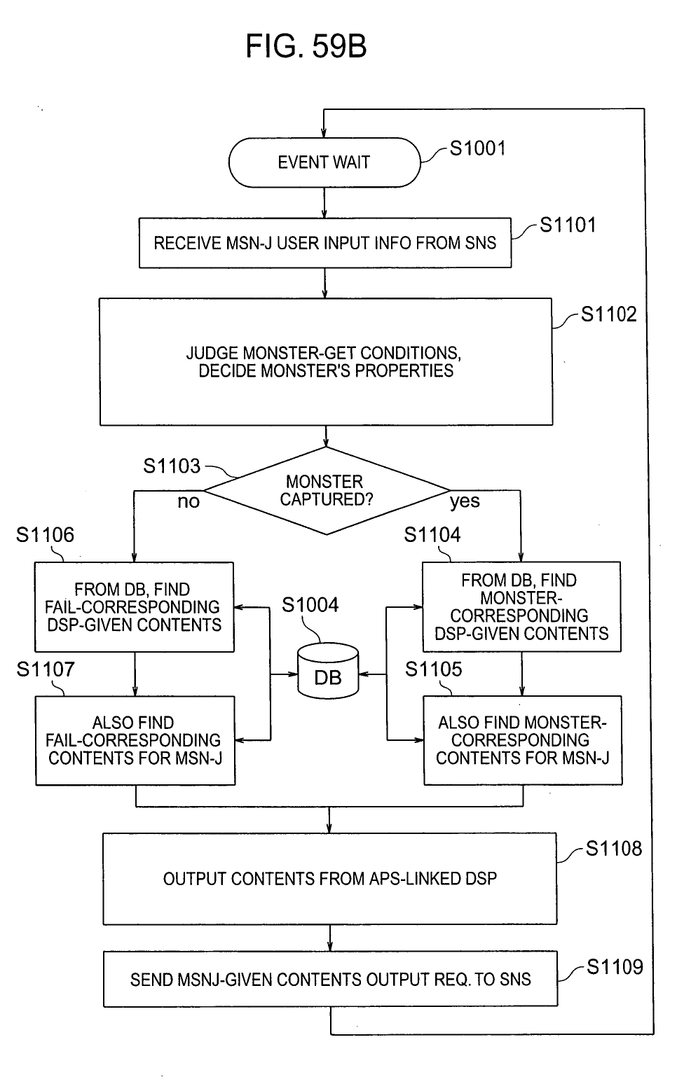

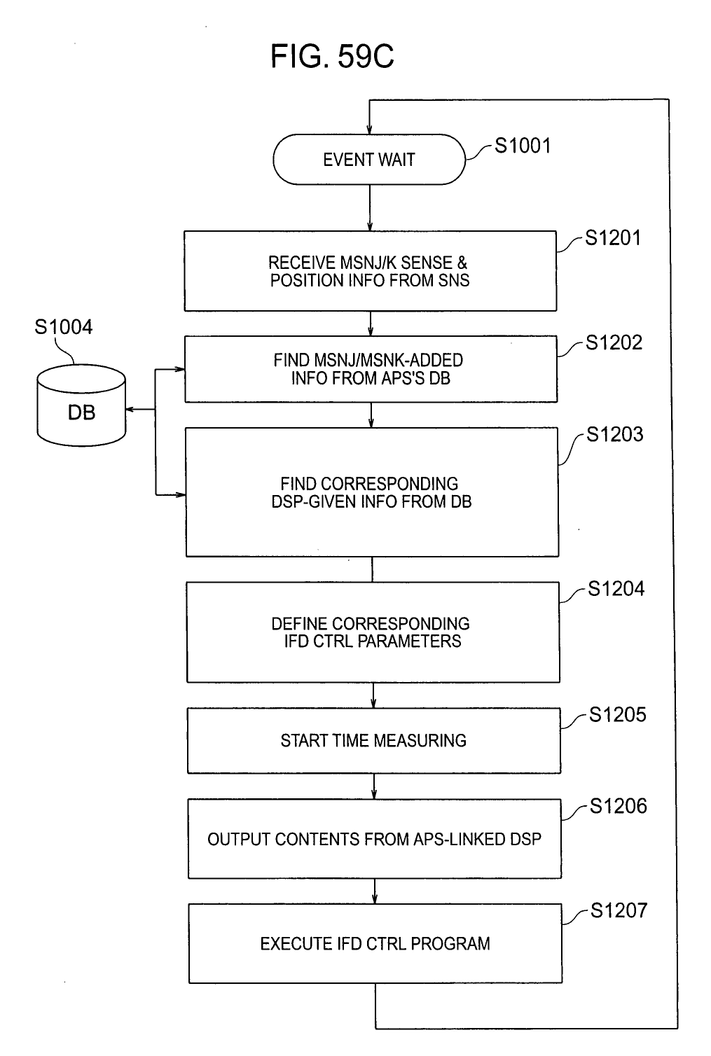

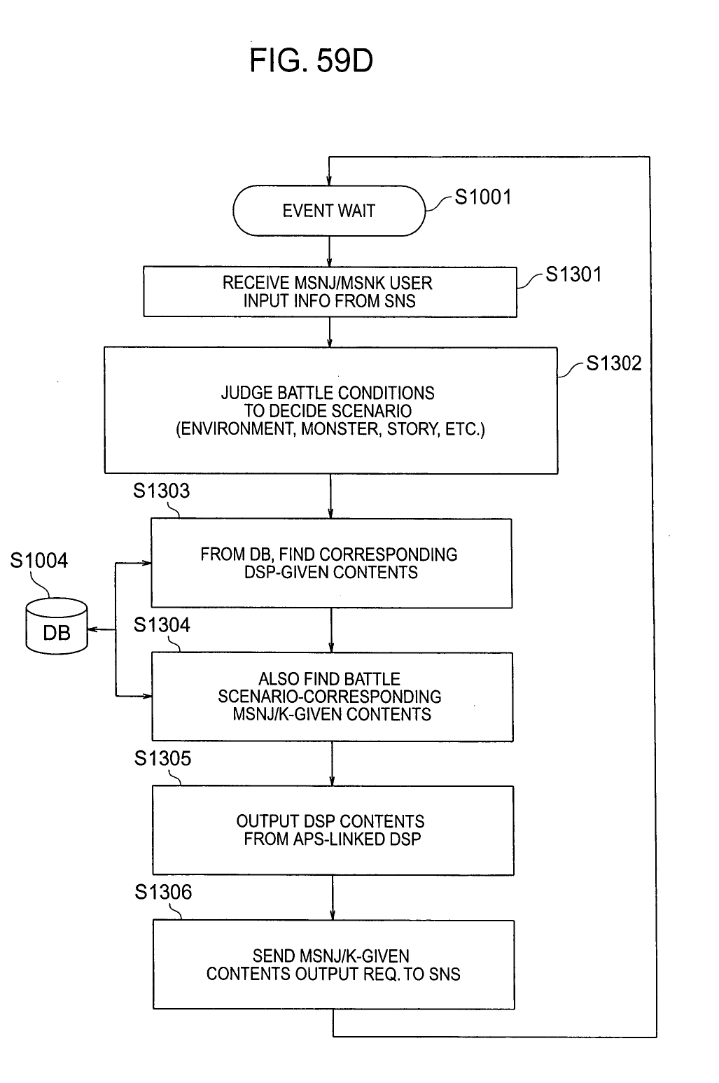

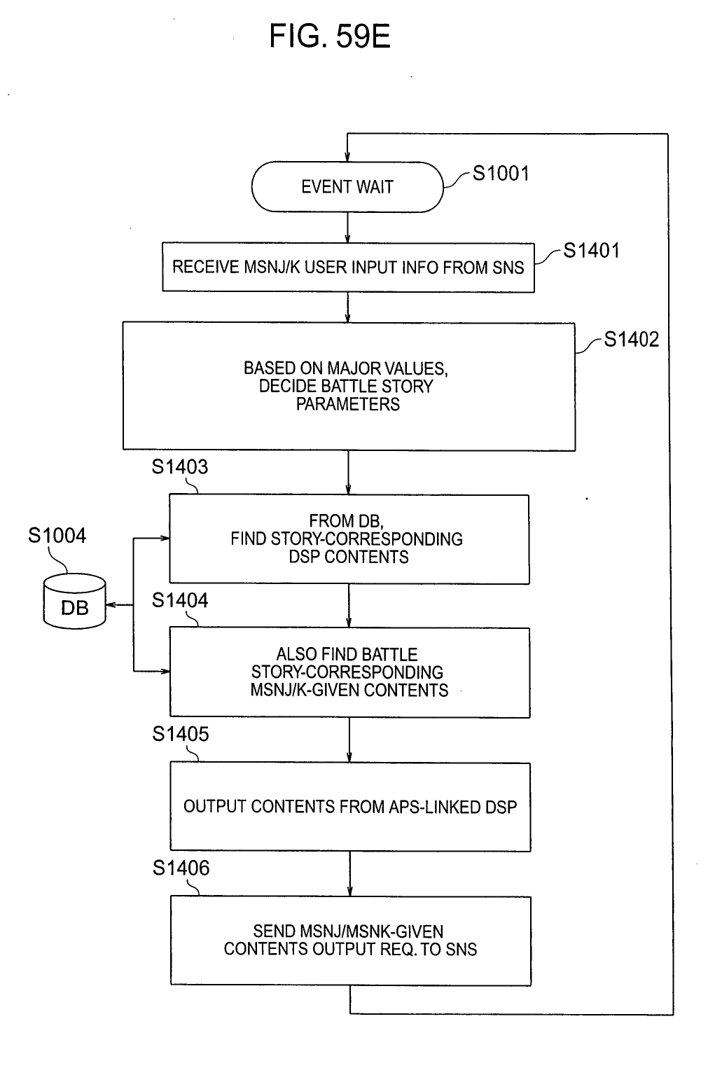

(3) The sensor network system SNS judges a visitor comes to the monster land and then notifies it to the application system APS. The application system APS forces a corresponding display DSP and its associated speakers to display a preset monster video image and produce audio sounds in deference to the visitor's approach condition in a way as will be later described using FIGS. 58A and 59A. At this time, realistic sensations are enhanceable by visually displaying the visitor per se and a background scene image taken by one of the cameras CAM in sync with the display DSP.

(4) The visitor watches the image to perform actions, such as swinging the mobile sensor node MSN in sync with motions of the image in a predetermined procedure or pushing a button(s) on the node MSN. This node has its built-in acceleration sensor or vibration sensor for detecting such visitor's motions, buttons and microphone (FIG. 58B).

(5) By comparing a time stamp of the image, an acquisition time point of the information set forth in the above paragraph (4) from the mobile sensor nodes MSN and analysis results of operation contents, if a comparison result matches prespecified criteria then it is assumed that the monster-get was completed in success; then, let the display DSP and its associated speaker(s) to display an image corresponding to the monster capture along with audio sounds. Simultaneously, the get-succeeded or “captured” monster's image is displayed on the display of mobile sensor node MSN while letting the speaker(s) produce audio sounds. Further, let the visitor be aware of it by driving the vibration motor equipped in MSN to vibrate or by driving LED to blink (FIGS. 59B and 58C).

(6) If the monster-get is failed, the display DSP and mobile sensor node MSN display specific information notifying the failure, such as a video image representing the monster running away, along with audio sounds in a similar way to that stated in paragraph (5) (see FIGS. 59B and 58C).

It is also possible to much enhance the attraction properties by having stored the visitor's traveling route within the facility based on a reception history of detection signals of locator nodes LCN and by changing a monster that becomes the visitor's target in a way depending on the travel route. The target monster may alternatively be changed based on environment information observed by using the wireless sensor node WSN.

<Battle Scenario>

(1) A Play zone that is set as a battle field is provided in the facility, with a locator node LCN and display DSP being installed therein (see FIG. 48).

(2) In case more than two visitors approach the battle zone and when their own mobile sensor nodes MSN enter into the node detection region of the locator node LCN and then establish communications respectively, the locator node LCN sequentially detects the communications and transmits ID information of respective nodes MSN (FIG. 54).

(3) The sensor network system SNS judges more than two visitors come to the battle field and notifies the application system APS of this fact whereby the display DSP connected to application system APS displays preset video images relating to the battle zone while letting its associated speaker(s) produce audio sounds (FIGS. 58A and 59C).

(4) In a case of three or more visitors, they may be divided into groups based on MSN IDs managed in the database DB, their travel route(s), prefetched personal data and like information, thereby to enhance amusementability.

(5) While those monsters that have already been captured by visitors and searched from the database are displayed on the display of each mobile sensor node MSN, a visitor selects one from among them as a target monster for battle and then transmits a selection result. The captured monster information may be held in an internal memory of mobile sensor node MSN. Triggering the transmission of the monster selected may be achieved by push-down of a button or the acceleration sensor's detection of a motion of throwing the mobile sensor node MSN (FIGS. 58C and 59D).

(6) Let the display DSP display a sequence of video images representing that the visitor's selected monsters are fighting together while causing its attached speakers to produce audio sounds (FIG. 59E). These video images and sounds may be selected from among a variety of versions of battle scenes that are prepared in advance for all possible combinations or, alternatively, may be newly created in tune with the progress of a battle story by computer graphics techniques. At this time, realistic sensations may be enhanced by displaying the visitor per se and a background scene image as taken by one of the cameras CAM in sync with the display DSP.

(7) To further enhance the interactive properties, it is permissible to send to the server the information as input by the visitor(s) using one or more of the buttons and acceleration sensor plus microphone equipped to the mobile sensor node MSN to thereby vary the to-be-displayed video images and audio sounds based on analysis results of the information. It is also possible to use input data to a nearby interface device and/or camera CAM image analysis results.

(8) An attempt is made to determine which side won the battle game based on any one or ones of the database-managed personal data, travel route, monster strength and input information or, alternatively, determine it at random (FIG. 59E). At this time, a certain application operation may be performed, such as shifting the property right of a monster that was selected and fought by a visitor who is the looser to the other visitor who is the winner, thereby improving the attraction capabilities.

The mobile sensor nodes MSN is modifiable so that each has the locator node functionality of detecting approaching of another mobile sensor node MSN whereby visitors may be subjected to grouping based on the information added to each MSN. The application software operation is designable so that upon detection of the fact that such visitor groups get near to each other in the battle field, a battle is performed between these groups; in this case, it becomes possible to further enhance attraction performances. The application operation may also be designed to use, as the monsters to be owned by visitors, pre-registered ones that are gettable by access from the outside of the facility to the application via the Internet, other than those captured within the attraction facility.

As previously stated in the context of the monster-get scenario and the battle scenario, this embodiment is such that the database DB is arranged to record, with correlation to respective node IDs, the personal data of visitors who hold the nodes, their walk-around routes within the facility, the information added to these nodes, such as those contents that have provided until a present time, the kinds and strength levels of those monsters being presently owned, experience value data, and elapsed time since entry to the facility. Further recorded therein are those contents corresponding to respective actions (e.g., monster-get, battle, etc.) to be displayed on the display DSP, interface device IFD or node display. In addition, according to this invention, the position of each mobile sensor node is specified while at the same time making correspondence in relationship between the node position and the information added to recorded nodes. By referring to this correlation, it becomes possible for the server to conduct a search and provide adequate contents corresponding to an action by taking account of not only the position but also the node-added information. This makes it possible to provide visitors or guests with effective services high in amusability.

The operation flow of the attraction using the above-stated sensor network-applied system for attraction facility will be described with reference to FIGS. 58A-58C and 59A-59E.

FIGS. 58A-58C are flowcharts each showing a routine procedure of the sensor network system SNS that is a constituent element of the sensor network-applied system. FIGS. 59A-E show operation flows of the application system APS that is an element of the sensor net-applied system. Additionally the contents to be presented in cases where the mobile sensor node of interest to be later explained is in either the monster-get mode or the battle mode are provided through execution of various software programs by an application server. Each program defines the scenario of a service being provided. In this embodiment, software programs, such as a monster-get mode program and battle mode program, are prepared in a way corresponding to respective modes. In short, a flow is predefined which includes branches of a story, with conditions at each branch being managed. This program is executed based on the node position information to be acquired and visitor information (information added to respective nodes) as shown in FIGS. 59A-E. These programs are stored in a storage device (not depicted) such as hard disk drive (HDD) as in ordinary computer systems and are loaded into a program memory (not shown) for execution by a CPU (not shown). These applications' functions are also achievable by use of one or some components of the sensor network system SNS. The sensor network system SNS and application system APS operate in collaboration with each other.

The sensor network system SNS waits for event receipt from a sensor node, a locator node and the application system APS (at step S701 in FIGS. 58A-C). When one locator node LCN-i of those installed in the attraction facility detects a mobile sensor nodes MSN-j held by a visitor (at step S702), if this locator node LCN-i is the one that is installed in a monster land (S703), the action controller of directory server changes the state of mobile sensor node MSN-j in the real world model of sensor network system SNS to the monster-get mode (S704). If LCN-i is the locator node in the battle field (S703) then change the state in the real world model of network system SNS of the visitor having node MSN-j to the battle mode (S705). Then, database controller DBC of distributed data processing server DDS determines the position of node MSN-j and notifies it to application system APS via session controller SES of distributed data processing server DDS (S706). Thereafter, event action controller EAC starts time measurement from an instant that the state of the visitor with node MSN-j goes into the monster-get mode or the battle mode (S707) and then returns to the event wait state (S701).

Meanwhile, the application system APS is waiting for event receipt from the sensor network system SNS (at step S1001 in FIGS. 59A-59C). In a case where the state in real world model of the visitor with the node MSN-j is in the monster-get mode, when receiving from the sensor network system SNS the detection information of the mobile sensor nodes MSN-j by locator node LCN-i along with the position information of node MSN-j in accordance with the flow of FIG. 58A (S1002), the application server of application system APS finds by search the information added to node MSN-j (such as personal data of the visitor with node MSN-j, walk-around route, data of the kind of a presently owned monster(s), elapsed time since facility entry, etc.) from the database DB (S1004, i.e., DB of FIG. 56) (at S1003) and also acquires by searching from database DB the contents to be displayed on display DSP based on the obtained information being added to node MSN-j and information of the detected position of node MSN-j.

The application server also determines a display DSP for output of the presentation contents to be, for example, the one nearest to the locator node LCN-i (S1005). In doing so, it determines from the node position detection information a specific one of the monster lands to which the node belongs and then conduct a search to find the contents fitted thereto. The DSP presentation contents at this time include an ensemble of video images and audio sounds indicating visitor's arrival at the monster land and a set of video images and sounds for prompting the visitor to do actions, such as selecting from the interface device IFD certain candidates of the visitor's gettable monsters or candidates of a monster that the visitor wants to get through monster-get actions using the input device of mobile sensor node.

The contents presented may include video images of visitors as taken by cameras CAM. The information added to node MSN-j and its detected position are used to determine setup parameters (e.g., display data, used-selected candidate information, etc.) of a software program for controlling interface devices IFD. An interface device IFD which is an execution destination of this control program is determined to be the one that is nearest to the locator node LCN-i, for example (S1006). Thereafter, the application server starts time measurement for making correspondence in relationship between the display time elapse of the presentation contents thus determined and acquisition time points of the user's input information by the mobile sensor node MSN-j and interface device IFD (S1007). At this time, in order to accurately synchronize together the time measurement in sensor network system SNS (S707) and that in the application system (S1007), let the sensor network system SNS and application system APS be matched in time to each other. Then, the DPS presentation contents are output to the display DPS that was determined as an output destination (S1008). Next, execute the control program of the presently selected interface device IFD in accordance with control parameters thereof (S1009). After that, return to the event wait state (S1001).

As shown in FIG. 58B, the sensor network system SNS operates in a way such that upon receipt of the communication of mobile sensor nodes MSN-j in the event wait state (S701), if the state of the real world model of the visitor having the node MSN-j in real world model table MTB is the monster-get mode (S802) then the database controller DBC acquires from the received data the user's input values, such as a button input value that was entered by the user while looking at the presentation contents to the display DSP, an audio value as input from the microphone, and a sensing value of the acceleration sensor (S803). Then, send to the application system APS a decision result of the user input information including but not limited to a selection value which was determined by button input, a selected value that was categorized based on the absolute value of a sound pressure level of input audio/voice sounds, and a selected value with categorization of a with-time change pattern of the sensing value of acceleration sensor, followed by returning to the event wait state (S701). If the state in the real world model of the visitor with node MSN-j is none of the monster-get and battle modes and is a regular mode of routinely transmitting ID information and sensing result (S802), acquire such ID information and sensed data (S805) and then return to the event wait state.

On the other hand, as shown in FIG. 59B, the application system APS receives from the sensor network system SNS the user input information by means of the node MSN-j in the event wait state (S1101).

The application server uses preset monster-get conditions to determine monster capture success/fail judgment and characteristics of a captured monster, such as the kind, experience value, strength, etc., by a preinstalled monster-get software program on the basis of a time stamp in each scene of the DSP presentation contents as output at step S1008 of FIG. 59A, a user input information acquisition time and its value of the mobile sensor node MSN-j, the information added to this node MSN-j as obtained at step S1003 (e.g., the kind or “species” of a monster that the visitor wants to get), and a time point of acquisition of the user input information to be obtained from the interface device IFD along with its value (S1002).

In case the visitor was able to get the monster (S1103), the application server searches and acquires DSP presentation contents corresponding to the captured monster from the database DB (S1104). It also searches database DB (S1004) to obtain therefrom MSN-j presentation contents corresponding to the captured monster (S1105). If the monster-getting was failed (S1103), search the database DB (S1004) to gain DSP presentation contents corresponding to the monster-get failure (S1106). Also obtained from the database DB (S1004) by search are MSN-j presentation contents corresponding to the monster-get failure (S1107).

The DSP presentation contents are output from a specified display connected to the application system APS (S1108). Then, send an MSN-j presentation contents output request to the sensor network system SNS (S1109). Thereafter, return to the event wait state (S1001).

In the event wait state (S701), upon receipt of the MSN-j presentation contents output request from application system APS in the event wait state (S901), the sensor network system SNS sends a presentation contents output command to the mobile sensor nodes MSN-j (S902) in accordance with the flow of FIG. 58C. This node MSN-j is responsive to the output command for outputting to output devices such as an LCD display and speakers those presentation contents designated by the command, such as an ensemble of data, video images and roaring voices of the captured monster or, alternatively, a set of data and images indicating the failure to get the monster.

A detailed explanation will next be given of the processing flows of the sensor network system SNS and application system APS in case the mobile sensor node is in the battle mode.

In case the state in the real world mode of the visitor having mobile sensor node MSN-j is the battle mode, when the application system APS that is presently in the event wait state (S1001) receives from the sensor network system SNS the user input information available from the mobile sensor node MSN-j and another mobile sensor node MSN-k (S1201) as shown in FIG. 59C, the application server searches information added to these nodes MSN-j and MSN-k (e.g., personal data of visitors having the nodes MSN-j and MSN-k, their travel routes, data such as the kinds of presently owned monsters, each elapsed time since entry, etc.) from the database DB (S1004) and acquires through searching the contents for presentation to a display(s) DSP based on the obtained information added to these nodes MSN-j and MSN-k along with information of detected positions of nodes MSN-j and MSN-k from database DB (S1004). In addition, determine the target display for output of the contents to be, for example, the one nearest to the locator node LCN-i (S1203).

In such case, judge the mobile sensor nodes MSN-j and MSN-k are in which one of the battle fields; then, search contents fitted thereto. The DSP presentation contents at this time are a set of video images and audio sounds indicating startup of the battle mode, monsters usable for a battle, visitors' operations for selecting a monster using their mobile sensor nodes, and a set of videos and audio sounds prompting them to do actions for battle story selection by use of interface device IFD. The presentation contents may contain video images of visitors taken by surveillance cameras CAM. In addition, the one that is expected to execute an interface device control program is determined as the interface device IFD nearest to the locator node LCN-i (at step S1204), which determines setup parameters (e.g., display information, candidates for users' selection, etc.) of the control program from the acquired information added to nodes MSN-j and MSN-k and the detected positions of these nodes MSN-j and MSN-k.

Thereafter, the application server starts time measurement for establishing correspondence in relationship between the display time elapse of the determined DSP presentation contents and acquisition time of the users' input information from mobile sensor nodes MSN and interface device IFD (at step S1205). At this time, in order to accurately perform synchronization of the time measurement (S707) in the sensor network system SNS and the time measurement (S1205) in application system APS, these systems SNS and APS are tuned to be identical in time. Then, output the DSP presentation contents to the display device DSP thus determined to be the output destination (S1206). Next, the selected interface device IFD executes the control program in accordance with the IFD control parameters (S1207). After that, return to the event wait state (S1001).

When the sensor network system SNS sends to the application system APS the user input information of nodes MSN-j and MSN-k in the battle mode which were acquired using the flow of FIG. 58B, the application system APS that is in the event wait state (S1001) receives such information from sensor network system SNS (S1301) as shown in FIG. 59D. It determines at step S1302 a battle scenario (e.g., virtual battle location such as a mountain or river or else, on-screen display images and roaring voices of a monster to be used, battle progressing procedure, etc.) by using preset battle conditions by means of a preinstalled battle program in the application system APS on the basis of a time stamp in each scene of DSP presentation contents as output at S1206 of FIG. 59C, the user input information of nodes MSN-j and MSN-k and its values (e.g., ID of a monster used for the battle), the information added to these nodes MSN-j and MSN-k as obtained at S1202, and the acquisition time and value of the user input information from interface device IFD (e.g., a selection value of the selected battle story). In addition, for the battle scenario determination, there are also reflected the characteristics—such as the kind, experience value, strength, etc.—of monsters that respective visitors with nodes MSN-j and MSN-k want to use for the battle. Then, at step S1303, acquire by searching the DSP presentation contents corresponding to the determined battle scenario from the database DB (S1004). At step S1304, conduct a search to acquire from the database DB (S1004) contents corresponding to the battle scenario determined (e.g., information as to the strength of an adversary monster of each visitor) to be presented to nodes MSN-j and MSN-k.

The acquired DSP presentation contents are output from a certain display DSP linked to the application system APS (at S1305). The DSP presentation contents at this time are video images and audio sounds indicating an execution situation of the battle based on the battle story determined. The contents also include video images and sounds prompting visitors to take actions for selection and instruction of attack or defense against the monster using their mobile sensor nodes during battle execution and/or for selecting an attack technique or the like.

A request for output of the contents being presented to nodes MSN-j and MSN-k (e.g., selected attack/defense technique, selected attack skill, etc.) is transmitted to the sensor network system SNS (S1306). Thereafter, return to the event wait state (S1001). The sensor network system SNS outputs the application system APS's output-requested mobile sensor node presentation contents from the output devices of mobile sensor nodes MSN-j and MSN-k in accordance with the flow of FIG. 58C in a way similar to the monster-get mode.

FIG. 59E is an operation flow in the case of the battle progress conditions being changed in deference to the instruction from a visitor during execution of the battle. While the application system APS is in the event wait state (S1001), when it receives the user input information (the selected value of attack or defense or else, the selected value of an attack skill, etc.) from the mobile sensor nodes MSN-j and MSN-k (S1401), the application server determines (S1402) a battle progress parameter selection value (e.g., a game-rolling pattern for letting a monster A attack a monster B) in a selected point, such as a branch of the battle story, based on a time stamp in each scene of DSP presentation contents as output at step S1305 of FIG. 59D, a user input information acquisition time of mobile sensor node MSN-j or MSN-k with its value (e.g., selected value of attack or defense or else, selected value of an attack skill, etc.), and the information added to nodes MSN-j and MSN-k as obtained at step S1202. Then, perform searching to acquire DSP presentation contents corresponding to the determined battle story from the database DB (S1004). Also obtained from the database DB (S1004) are those contents corresponding to the determined battle story to be presented to node MSN-j or MSN-k (e.g., determined values of selected attack/defense skill and/or determined value of selected attack skill) at step S1404.

Then, the DSP presentation contents obtained are output from the display DSP connected to the application system APS (S1405). The DSP presentation contents at this time are video images and audio sounds indicating execution situations of the battle that was determined based on the battle progress parameter(s) as set at the battle story branch point. The contents also include video images and sounds prompting visitors to take actions for selection and instruction of the next attack and defense against the monster using their mobile sensor nodes during battle execution and/or for selecting a combat skill used for the next attack in a similar way to the DSP presentation contents at step S1305 of FIG. 59D. A request for output of the presentation contents to the nodes MSN-j and MSN-k is sent to the sensor network system SNS (S1406). Thereafter, return to the event wait state (S1001).

The sensor network system SNS outputs from the output device of mobile sensor node MSN-j or MSN-k the presentation contents given to the mobile sensor node under output request from application system APS in accordance with the flow of FIG. 58C in a similar way to that in the monster-get mode.

Although the invention has been disclosed and illustrated with reference to particular embodiments, the principles involved are susceptible for use in numerous other embodiments, modification and alterations in appropriate combinations on a case-by-case basis as will be apparent to persons skilled in the art to which the invention pertains.

As apparent from the foregoing description, according to this invention, it becomes possible to specify a present position of a moving body, such as a person, in the commercial distribution process of a retail shop or store or else, thereby making it possible to increase the efficiency of visitor/customer-care works to be done by salesclerks in the shop while improving the serviceability for shoppers. In addition, owing to the ability to specify a present position of a walking or running person in attraction facility, it becomes possible to provide amusability-enhanced attractions based on positions of attraction participants.

It should be further understood by those skilled in the art that although the foregoing description has been made on embodiments of the invention, the invention is not limited thereto and various changes and modifications may be made without departing from the spirit of the invention and the scope of the appended claims.

1. A sensor network system comprising:
a node having a display unit, a sensor for acquiring sensing data, a first controller for generating first transmission data including the sensing data and node identification (ID) information, and a first wireless processing unit for sending the first transmission data to a base station;
a locator node having a second wireless processing unit for catching the transmission data of from the node to the base station when the node exists in a detection region of the locator node and a second controller for extracting the node ID information from the transmission data and for generating second transmission data including the extracted node ID information and locator node ID information;
a base station having a node communication processing unit for receiving the first and second transmission data from the node and the locator node and for extracting the first node ID information, second node ID information and the locator node ID information and a node management unit for sending the extracted ID information to a server; and
a server having an event action control unit for receiving the ID information, a recorder unit for recording a locator node position table which causes the locator node ID information and the locator node position to correspond in relationship to each other, a database control unit for using the received ID information and the locator node position table to specify a position of the node, and a command control unit for sending information to be determined by the event action control unit based on the position of said node toward the position-specified node via the base station, wherein
said position-specified node has its display unit operative to display the information determined by said event action control unit.

2. A sensor network system according to claim 1, wherein the information is inquiry information to a person having said position-specified node, wherein said node further has an input unit, wherein when a response to the inquiry information is input through the input unit, the first wireless processing unit sends the response to said event action control unit via said base station, and wherein said event action control unit determines based on the response whether transmission of the information to a node different from said node is necessary or not.

3. A sensor network system according to claim 1, wherein said recorder unit records a node position table which causes ID information of the node of a stationary type and a position thereof to correspond in relationship to each other, wherein said database control unit is responsive to receipt of the sensing data and ID information of the node of the stationary type for using the node position table to specify a position of the node of the stationary type, and wherein said event action control unit performs judgment of a state of the stationary type node from the sensing data and, when a result of the judgment satisfies prespecified conditions, determines the information based on the position of said stationary type node.

4. A sensor network system according to claim 1, wherein said event action control unit causes the specified node position and information of the person having said node to correspond together and selects a single node based on the information of the person having the node thus correlated, and wherein said command control unit sends said information to the selected node via said base station.

5. A sensor network system according to claim 3, wherein said event action control unit selects a node nearest to the position at which said stationary type node exists.

6. A sensor network system according to claim 1, wherein said sensor network system is connected to a display device for displaying a land map including at least a position at which said locator node exists and for displaying the position-specified node at a corresponding position of the map.

7. A sensor network system according to claim 6, wherein said display device further displays on the map the stationary type node to thereby indicate completion of correlation of said position-specified node and said stationary type node.

8. A sensor network system according to claim 1, wherein said sensor network system is connected to an application system having an information output unit and an application server for control of the information output unit, and wherein said application server determines at least any one of contents including images, texts and audio sounds based on the position of said node to be received from said server and causes said information output unit to output the contents.

9. A sensor network system according to claim 8, wherein said application server further includes a recording device for recording the position of said node and at least any one of prefetched information of the person having said node, a movement track record of said node and contents owned by said node while making a correlation therebetween, and wherein said application server determines, based on data being recorded in said recording device, contents to be output by said information output unit.

10. A sensor network system according to claim 8, wherein said node further has an input unit, and wherein when a response to the contents being output to said information output unit is input via any one of said input unit and said information output unit, said application server performs comparison of the input information to be input and an input time relative to predefined conditions concerning the contents to be displayed at said information output unit to thereby determine the contents being displayed at said information output unit based on a result of the comparison.

11. A sensor network system according to claim 10, wherein said application server sends to said node an instruction for displaying the contents determined based on the comparison result at the display unit of said node, and wherein the display unit of said node is responsive to receipt of the instruction for displaying the contents determined.

12. A sensor network system according to claim 11, wherein said application server performs the comparison by use of input information to be input from input units of a plurality of nodes and input time points thereof and determines contents based on a result of the comparison, and
wherein the display units of said plurality of nodes display the contents determined.

13. A sensor network position specifying method comprising the steps of:
causing a node to acquire sensing data and generate first transmission data including the sensing data and node ID information and then send the first transmission data to a base station;
causing a locator node to catch the transmission data of from the node to the base station when the node exists in a detection region of said locator node, extract node ID information from the transmission data, and generate second transmission data containing therein the extracted node ID information and locator node ID information;
causing the base station to receive the first and second transmission data from said node and said locator node, extract therefrom first node ID information and second node ID information plus the locator ID information, and send the extracted ID information to a server;
causing the server to receive the ID information, record a locator node position table which correlates the locator node ID information and a position of the locator node, specify a position of said node by use of the received ID information and the locator node position table, and send information to be determined based on the position of said node toward the node with its position specified via said base station; and
causing the position-specified node to display the information.

14. A sensor network position specifying method according to claim 13, wherein said server records a node position table for correlation of ID information of the node of a stationary type and its position, said method further comprising the steps of:
upon receipt of the ID information of the stationary type node and the sensing data, specifying a position of the stationary type node by use of the node position table;
performing judgment of a state of said stationary type node from the sensing data; and
when a result of the judgment satisfies prespecified conditions, determining the information based on the position of said stationary type node.

15. A sensor network position specifying method according to claim 13, wherein said server correlates the specified node position and information of a person having said node, selects a single node based on the information of the person having the node thus correlated, and then sends said information to the selected node via said base station.

16. A sensor network position specifying method according to claim 14, wherein said server selects a node nearest to a position at which said stationary type node exists.

17. A sensor network position specifying method according to claim 13, wherein a sensor network system comprising the node, the locator node, the base station and the server is connected to a display device operative to display a land map indicating a location at which said locator node is disposed and displays the position-specified node at a corresponding position of the map.

18. A sensor network position specifying method according to claim 17, wherein said display device further displays on the map the stationary type node to thereby indicate completion of correlation of said position-specified node and said stationary type node.

19. A sensor network position specifying method according to claim 13, wherein a sensor network system comprising the node, the locator node, the base station and the server is connected to an application system operative to determine contents of at least any one of images, texts and audio/voice sounds based on the position of said node to be received from said server and then output the contents determined.

20. A sensor network position specifying method according to claim 19, wherein said application system further records the position of said node and at least any one of prefetched information of the person having said node, a movement history of said node and contents owned by said node while making a correlation therebetween, and determines the contents to be output based on the data recorded.
